(19) United States
(12) Patent Application Publication
(10) Pub. No.: US 2013/0018685 A1
(43) Pub. Date: Jan. 17, 2013

(54) System and Method for Tasking Based Upon Social Influence

(71) Applicants: Tracey J. Parnaby, Vienna, VA (US); Nicholas Parnaby, Vienna, VA (US); Rafeek Kottai, Hoffman Estates, IL (US)

(72) Inventors: Tracey J. Parnaby, Vienna, VA (US); Nicholas Parnaby, Vienna, VA (US); Rafeek Kottai, Hoffman Estates, IL (US)

(21) Appl. No.: 13/530,292

(22) Filed: Jun. 22, 2012

Related U.S. Application Data
(60) Provisional application No. 61/507,853, filed on Jul. 14, 2011.
(60) Provisional application No. 61/638,564, filed on Apr. 26, 2012.

(51) Int. Cl. G06Q 10/06

(52) U.S. Cl. 705/7.13

(57) ABSTRACT

The present invention provides a structured sentiment expression and management system and method. The present invention can receive sentiment content from at least two contributing users, wherein the received content is structured according to a specific human emotion, gesture or feeling and a level of intensity of the specific human emotion, gesture or feeling. The present invention further displays the received content in a pre-defined and user-selected sentiment category related to the specific human emotion, gesture or feeling. In one embodiment, the present invention can initiate a contest requiring sentiment content in order to evaluate the winner. In one embodiment, the present invention can receive a request from a requester for a crowdsourcing task and, based upon determined social influence ratings, assign the task to a user.

### REFERENCE TO RELATED APPLICATIONS

This application claims the benefit of U.S. provisional application Ser. No. 61/507,853, filed Jul. 14, 2011 and entitled “System and Method for Comprehensive Collection, Management and Dissemination of Sentiment Data”, and further claims the benefit of U.S. provisional application Ser. No. 61/638,564, filed Apr. 26, 2011 and entitled “System and Method for Comprehensive Collection, Management and Dissemination of Sentiment Data”, the disclosures of which are incorporated herein by reference.

### FIELD OF THE INVENTION

The present invention relates to online marketing and data processing, and more particularly to a system and method for electronically collecting, managing and disseminating structured sentiment information.

### BACKGROUND

Social media refers to media for social interaction, particularly the use of web-based and mobile technologies to turn communication into interactive dialogue. There are several major social media sites today, including Facebook™, Twitter™ and LinkedIn™, for example. While these sites provide social interaction, they have many drawbacks, one of which relates to “social listening.”

Social listening allows the listener to collect information about their audience in an effort to better understand their wants and needs. Social listening also enables the listener to discern what is being said about the listener and/or its products, services and competition. Companies have an interest in learning how consumers feel about a product or a brand and also about their experiences, aspirations, and interactions in everyday life. Traditional ratings systems such as five-star rating scales and other similar systems fail to capture the emotion or sentiment tied to consumer reviews. While many web sites permit user comments, these can be tedious to read, and they are not readily categorized into manageable information. For example, a web blog may have entries related to children's toys, with one entry detailing the need for better safety features on tricycles, another entry claiming that Company ABC's tricycles are exceptionally safe, and another entry comparing Company XYZ's tricycles to Company ABC's. If Company ABC or XYZ is “listening” to this blog, they may learn information to help them adapt their product or message to better suit their customers' wants and needs.

Given the vast number of web blogs in existence, as well as their text-oriented nature, it can become highly unwieldy for a company to actively monitor, filter and address all relevant comments to provide business value. It can also be extremely difficult to accurately capture sentiment information. Further, while many individuals are more willing to reveal their sentiments in popular social media sites, such information is not always accessible. For example, Facebook™ allows users to “Like” their friends' photographs, user comments, etc. However, only other users marked as allowed “friends” on Facebook™ can view what another user has marked with “Like” or “Recommended.” Facebook™ has the added drawback of not enabling its users to “Dislike” things and share this sentiment with their social networks, so the information that can be gleaned from Facebook™ (provided the user is happy to enable access to anyone outside their friends network) is not immediately useful to a marketing, customer service or market research oriented business. Twitter™ allows more than just friends to view user posts, but the volume of information and the unstructured format in which it is captured and presented makes Twitter™ hard to decipher without making mistakes and incorrect assumptions relating to consumer sentiment around a particular topic or topics.

Some have tried using automated web tools (frequently referred to as “Sentiment Monitoring”, “Sentiment Analysis”, or “Sentiment Analytics”) in an effort to decipher, parse or analyze sentiment. However, such tools frequently process or analyze sentiment incorrectly. In fact, studies show that these automated tools may typically be only about 7 to 30% accurate at interpreting if a statement was neutral, positive or negative. In fact, studies show that these automated tools are typically only about 7 to 30% accurate at deciding if a statement was positive or negative. For example, if Lady Gaga's record label was trying to gather sentiment data about Lady Gaga as an artist, a search on Twitter™ would likely return many references to her song titled “Bad Romance”. The resulting frequency of the term “bad” used in connection to Lady Gaga would potentially construe the user feedback as negative when it very well could be positive feedback that simply references the song title. Another example is the difficulty that “Sentiment Analysis” tools have in deciphering comments made by consumers that contain sarcasm, or both a positive and a negative connotation, such as, for example, “I'm loving the way that Oil companies can make such huge profits, but I have to pay more for my fuel! Not!” For any brand looking to use social media monitoring to help them interact with and respond to positive or negative comments, this inability to gather explicit positive and negative structured sentiment can be disastrous. Furthermore, current social networks are often limited to a certain demographic, which limits the availability of available sentiment data from those who do not wish to participate, or are only passively participating, in social networks today.

In light of the problems associated with gathering and managing sentiment data, there is a need for a system and method to facilitate the general public's ability to accurately and succinctly express how they feel about any topic, particularly on impulse as users feel and experience the objects around them. There is further a need to enable the consumer to simply express their sentiments in a structured manner, thereby negating the need for machine-interpreted positive, negative, neutral or other types of sentiment.

### SUMMARY OF ASPECTS OF THE PRESENT INVENTION

Disclosed are various embodiments of systems and methods for managing online structured sentiment content in accordance with the present invention. The present invention provides a sentiment expression community (in one embodiment, called “Jabfab™”) that allows individuals (also referred to as “contributing users”) to tell the world about things they dislike (in one embodiment, called a “jab”) and things they like (in one embodiment, called a “fab”). In one embodiment, the system of the present invention is capable of receiving sentiment content from one or more contributing users, storing at least a portion of the content in a data storage device, and displaying, via a browser program, the aggregated sentiment content wherein the displayed sentiment content can be restricted to a structured sentiment representation. The structured sentiment content can be structured according to a specific human emotion, gesture or feeling as well as an intensity level of the specific human emotion, gesture or feeling.

In one aspect, the present invention provides a publicly available website where consumers can anonymously post explicit positive and negative sentiments about products, brands, or any topic they can imagine. In one embodiment, users can create personalized user accounts (also referred to as a user profile), allowing the user to post structured sentiments routinely and amplify sentiments across the user's “social graph,” i.e., the user's individualized social network. For example, a user may “jab” a new movie, and post the Jab as an icon on his or her Facebook™ page for his or her friends to see. The user's friends are then empowered to jab or fab the movie through the user's Facebook™ page. Any additional jabs or fabs are automatically recorded and posted on the central website, regardless of whether the new individuals who jab or fab are registered with the system of the present invention. In one embodiment of the present invention, a user is first provided with a binary choice to categorize the sentiment as either positive (e.g., a fab) or negative (e.g., a jab), and then sub-categories are provided as options for further explicit sentiment capture. For example, a user who “jabs” may be provided with a “very angry” sub-option, and a user who “fabs” may be provided with a “lovin' it” sub-option for expressing emotion.

Using the present invention, a user can create topics (also referred to as “tags”, “subjects” and/or “sentiment topics”) for any type of situation or feeling—life, likes, dislikes, sports teams, politicians, cars, restaurants, hotels, opinions, celebrities, movies, mobile applications, games, consumer products, charities, causes, etc. The present invention is specifically designed for consumers to share explicit structured sentiments about anything, in addition to a method for describing the intensity of the feeling, i.e. “Very angry”, versus “mildly irritated”, or “Ecstatic” versus “pleased”. In addition, it is simple enough for a person of any age to use. However, in one embodiment, the system of the present invention can be available only to users who are qualify based upon age, location and any other determinant as may be required. The present invention further provides a system and method for actionable social monitoring and listening, where, for example, businesses can monitor how customers feel about a company and its products, services and competitors, among other things, or an entity, person or general feeling on any topic. The present invention can further be used by businesses to create tags of products, brands, SKUs, staff, properties, locations, services and other commercial items where sentiment tracking is desirable. By employing social listening aspects of the present invention, the business can follow its own topics or even the tags of competitors, in order to ‘democratize’ access to consumer sentiment. The sentiment data provided for a followed tag can be accessed in batch or in real-time feeds, for example. Furthermore, individual tags can be clustered so that the tags can be contrasted and/or compared. Basic sentiment analysis can be viewed directly from the central website and expert sentiment analysis can be exported for further analysis.

By learning consumer emotions and sentiments using the present invention, companies can discern very quickly what is working and not working about a particular product or service, or even what is working or not working about a marketing campaign tied to a product or service. In this way, businesses can gain a heretofore unavailable advantage in rapidly adapting a commercial offering to better suit consumer demand, or offering a real-time customer service capability, that can listen to concerns as they happen and provide the user of this sentiment data the opportunity to provide reparations to “make it right” or address customer satisfaction issues that might arise in the course of providing a service (e.g. a hotel chain or restaurant). Unlike traditional social media, the present invention provides instant structured feedback that can be used immediately to grow profits and grow customer loyalty. The feedback can be used in operations, customer service or sales, for example.

In one embodiment, the present invention further provides various loyalty elements that track and reward user activity, such as, for example, (1) social influence (a.k.a., charisma) scores derived from various collected statistics that can ascertain and rate a person's level of influence, (2) loyalty (a.k.a., Karma or Kudos) points earned based upon participation and/or other factors and (3) internal games that, for example, reward a user with a revealed icon or image on a personalized “walk of fame” or “wall of fame”.

### BRIEF DESCRIPTION OF THE DRAWINGS

FIG. 1 is a schematic diagram illustrating different components of one embodiment of the system of the present invention.

FIGS. 2-50 and 57-81 are example user interfaces illustrating aspects of the present invention.

FIGS. 51-55 are example fuzzy membership function diagrams in accordance with one aspect of the present invention.

FIG. 56 is an example set of social influence rating rules for use in accordance with one aspect of the present invention.

### DESCRIPTION OF THE PREFERRED EMBODIMENTS

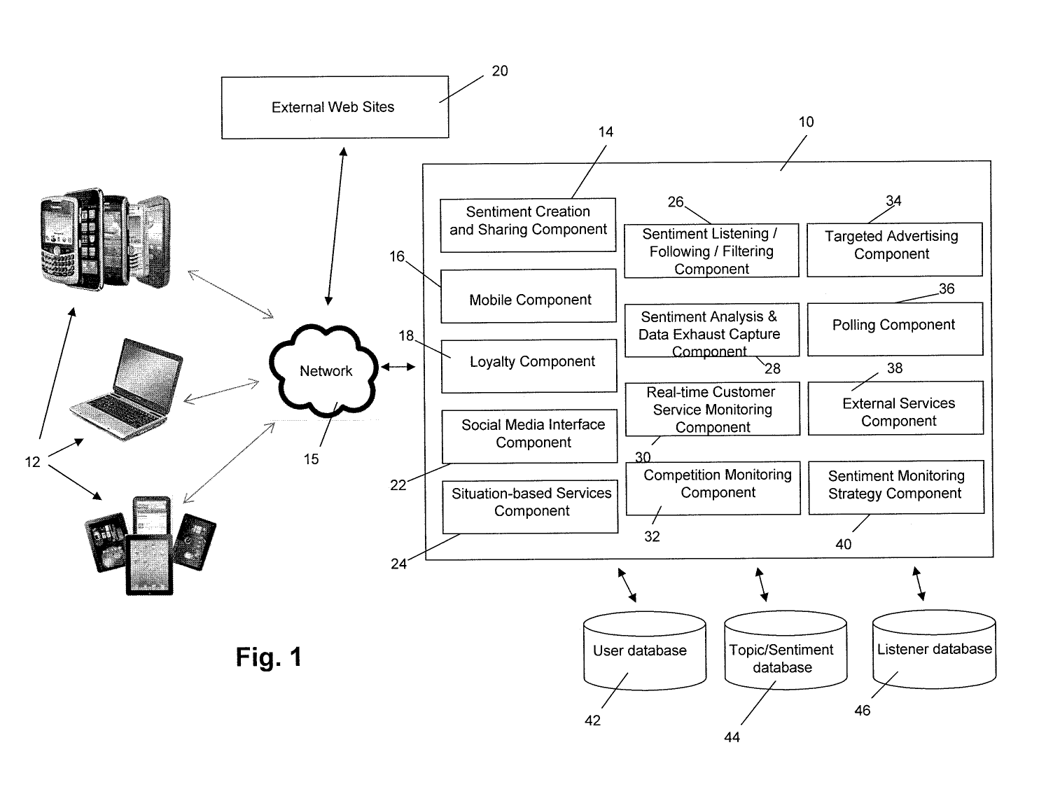

As shown in FIG. 1, the system 10 of the present invention can comprise various components capable of specific functions. The system is a computer-based system, where the components can be implemented in hardware, software, firmware, or combinations thereof. FIG. 1 also illustrates an exemplary high-level network 15 with exemplary users and/or external computer systems that can interact with the system 10 of the present invention. The users can access the system of the present invention using client computing devices 12, such as desktop computers, laptop computers, mobile communications devices (MCDs) and smart television appliances, for example. It will be appreciated that the system of the present invention can incorporate necessary processing power and memory for storing data and programming that can be employed by the processor to carry out the functions and communications necessary to facilitate the processes and functionalities described herein. Each of the client computing devices is configured to communicate with an application server (not shown) of the system engine. Appropriate encryption and other security methodologies can also be employed by the system of the present invention, as will be understood to one of ordinary skill in the art.

Unless otherwise stated, devices or components of the present invention that are in communication with each other do not need to be in continuous communication with each other. Further, devices or components in communication with other devices or components can communicate directly or indirectly through one or more intermediate devices, components or other intermediaries. Further, descriptions of embodiments of the present invention herein wherein several devices and/or components are described as being in communication with one another does not imply that all such components are required, or that each of the disclosed components must communicate with every other component. In addition, while algorithms, process steps and/or method steps may be described in a sequential order, such approaches can be configured to work in different orders. In other words, any ordering of steps described herein does not, standing alone, dictate that the steps be performed in that order. The steps associated with methods and/or processes as described herein can be performed in any order practical. Additionally, some steps can be performed simultaneously or substantially simultaneously despite being described or implied as occurring non-simultaneously.

It will be appreciated that algorithms, method steps and process steps described herein can be implemented by appropriately programmed general purpose computers and computing devices, for example. In this regard, a processor (e.g., a microprocessor or controller device) receives instructions from a memory or like storage device that contains and/or stores the instructions, and the processor executes those instructions, thereby performing a process defined by those instructions. Further, programs that implement such methods and algorithms can be stored and transmitted using a variety of known media.

Common forms of computer-readable media that may be used in the performance of the present invention include, but are not limited to, floppy disks, flexible disks, hard disks, magnetic tape, any other magnetic medium, CD-ROMs, DVDs, any other optical medium, punch cards, paper tape, any other physical medium with patterns of holes, RAM, PROM, EPROM, FLASH-EEPROM, any other memory chip or cartridge, or any other medium from which a computer can read. The term “computer-readable medium” when used in the present disclosure can refer to any medium that participates in providing data (e.g., instructions) that may be read by a computer, a processor or a like device. Such a medium can exist in many forms, including, for example, non-volatile media, volatile media, and transmission media. Non-volatile media include, for example, optical or magnetic disks and other persistent memory. Volatile media can include dynamic random access memory (DRAM), which typically constitutes the main memory. Transmission media may include coaxial cables, copper wire and fiber optics, including the wires or other pathways that comprise a system bus coupled to the processor. Transmission media may include or convey acoustic waves, light waves and electromagnetic emissions, such as those generated during radio frequency (RF) and infrared (IR) data communications.

Various forms of computer readable media may be involved in carrying sequences of instructions to a processor. For example, sequences of instruction can be delivered from RAM to a processor, carried over a wireless transmission medium, and/or formatted according to numerous formats, standards or protocols, such as Transmission Control Protocol/Internet Protocol (TCP/IP), Wi-Fi, Bluetooth, GSM, CDMA, EDGE and EVDO.

Where databases are described in the present disclosure, it will be appreciated that alternative database structures to those described, as well as other memory structures besides databases may be readily employed. The drawing figure representations and accompanying descriptions of any exemplary databases presented herein are illustrative and not restrictive arrangements for stored representations of data. Further, any exemplary entries of tables and parameter data represent example information only, and, despite any depiction of the databases as tables, other formats (including relational databases, object-based models and/or distributed databases) can be used to store, process and otherwise manipulate the data types described herein. Electronic storage can be local or remote storage, as will be understood to those skilled in the art.

As shown in FIG. 1, the system 10 includes a Sentiment Creation and Sharing Component 14 which performs the functions described herein with respect to topic creation, storage and related sentiment input. As described above and below, a user can access the system 10 of the present invention and its Sentiment Creation and Sharing Component 14 to anonymously post explicitly positive and explicitly negative statements (i.e., structured sentiment information) about a particular topic. If the topic has not been established yet, the user can create a topic for any type of situation or feeling, for example, including for life issues, general likes and dislikes, sports teams, politicians, cars, travel, restaurants, vacation locations, hotels, celebrities, movies, mobile applications, games, websites, consumer products, charities and causes, and so forth. The user can further access the Loyalty Component 18 to create a user profile and thereby qualify for enhanced services, rewards and other loyalty features. The user can further utilize the Social Media Interface Component 22 of the present invention to post his or her structured sentiments to outside web sites 20 via the network, thereby amplifying his or her sentiments across his or her social graph. The Social Media Interface Component 22 works to not only export the user's sentiments to other social media websites (e.g., Facebook™), but to act as an interface for other users' negative sentiment expressions (i.e., jabs) and positive sentiment expressions (i.e., fabs) coming back to the system of the present invention through such sites. For example, if user A proliferates a jab of the Star Wars™ movie to his Facebook™ page, and users B, C and D see the jab and disagree, then users B, C and D can decide to “fab” the movie, which can be communicated back to the system of the present invention, added to the postings for the topic via Sentiment Creation and Sharing Component and stored in the Topic Database. Further, users B, C and D can be stored as anonymous users in the User Database, and given the opportunity to become registered users of the system of the present invention via the Loyalty Component 18.

If the user is using a mobile communications device (MCD), the system can employ the Mobile Component 16 to adapt for limited screen space and provide customized services as described herein. The system of the present invention can further provide customized situation-based services using Situation-based Services Component 24, which include providing location-based services, to adapt to particular situations being experienced by a user in real-time. For example, the Situation-based Services Component 24 can assist a user in finding a nearby restaurant, finding the location of a nightclub where live music is being played (and even being fabbed according to the present invention), researching jabs and fabs for a consumer product prior to purchase, and so forth.

As further shown in FIG. 1 and described herein, the system of the present invention can also include various listener-based components, including Sentiment Listening/Following/Filtering Component 26, by which a user such as a business can track jabs and fabs for the products in its product line, for example. If its products are not yet available as topics, the business can create topics according to the methods described herein. Other topics of business interest can be created beyond products, including services, individual personnel associated with products or services, real estate properties, a fleet of trucks, transportation vehicles, food quality and other such topics, for example. Instead of requesting that drivers comment about their truck drivers' driving through telephone calls, the present invention can permit drivers to comment through jabbing or fabbing using the system of the present invention, for example. The business listener can further use this component to “listen” to their tags in real-time or batch mode, as described above and below, as the system of the present invention can be customized to relay this information to the business user. The business listener can further use the Sentiment Analysis and Data Exhaust Capture Component 28 of the system of the present invention to better understand topical jabs and fabs that may affect its business. For example, if the present invention provides jab and fab data across all users as it may relate to tricycles, a manufacturer, distributor or retailer of such products can gain valuable insight on the market for tricycles, including such detailed information as where, globally, the most favorable customers are, what elements can be improved, what factors are most important in the buying decision, and so forth, all using the components of the system of the present invention.

The business listener using the system of the present invention can further use the Real-Time Customer Service Monitoring Component 30 of the present invention to monitor user sentiment of relevant topics in real-time, and potentially initiate remedial or award reactions accordingly as described herein. A contributing user can be presented with one or more structured options for contributing sentiment content on a specified topic. In one embodiment, a first level of sentiment is expressed in binary fashion, as a “jab” or “fab” for example, and a second level of sentiment is expressed as an intensity level for the first level of sentiment. In these embodiments, a contributing user can be presented with structured and pre-established sentiment selection options. Using the system of the present invention, a tracking user (e.g, a restaurant, corporation, etc.) can take action based upon contributing user sentiment and one other tracking variable (e.g, contributing user location, contributing user status, etc.). For example, a user dining at a restaurant who jabs the chocolate cake dessert selection while dining may receive a coupon for a complimentary dinner from the restaurant upon departing, because the restaurant had been monitoring the jab in real-time, or has been using an auto-reply approach. Appropriate mechanisms can be incorporated into this component of the present invention to avoid fraudulent jabs intended to derive free products and services by unscrupulous users. Such mechanisms can include, for example, tagging users who may have a reputation for jabbing an inordinate number of such products or services. In an embodiment, a tracking variable can include the geo-location of a contributing user(s) and/or the geo-location of the tracking user. In an embodiment of the system of the present invention, the tracking user and the commercial entity that provides the product or service are two separate entities (e.g., the tracking user can be an agent, etc.). In another embodiment, a tracking user is able to track its competitors and present contributing users with commercial offers based upon sentiment content related to the tracked competitor topics.

The business listener using the system of the present invention can further use the Competition Monitoring Component 32 of the present invention to better understand what users are saying about their competition, by company name, product or topic category, for example.

The business listener using the system of the present invention can further use the Targeted Advertising Component 34 of the present invention to provide advertisements to users based upon their interaction with the present invention. For example, the listener who is a provider of mobile computing devices who notices that a user has jabbed the Apple iPad™ may instruct this component to react to this explicitly negative sentiment by sending an advertising promotion for the Samsung Galaxy™ device.

The business listener using the system of the present invention can further use the Polling Component 36 of the present invention to conduct surveys of relevant users for various purposes. For example, the listener may be interested to know if users believe that a certain product appearance (e.g., trade dress) is appealing, prior to investing in the manufacturing processes required to roll out such a product with that appearance. As alternative examples, the listener can poll the relevant audience of users for movie idea screenings, song screenings, advertising campaign screenings, political candidate polling and the like. This component can further be used for market testing of products in certain geographic areas if desired. The present invention can further provide a Sentiment Strategy Monitoring Component 38 to assist a listener in forming and adapting a listening strategy to best suit its needs. The present invention can further provide an External Services Component 40 to bring other services to bear for listeners, including, for example, forecasting sentiments based on proprietary and historical sentiment data, facilitating job placement, facilitating dating matches and/or the matching of groups for recreational outings or charitable events.

The system of the present invention further operates using one or more databases to store information and programming instructions for operating the present invention as described herein. In the embodiment of the system 10 of the present invention shown in FIG. 1, the present invention includes user database 42, topic database 44 and listener database 46.

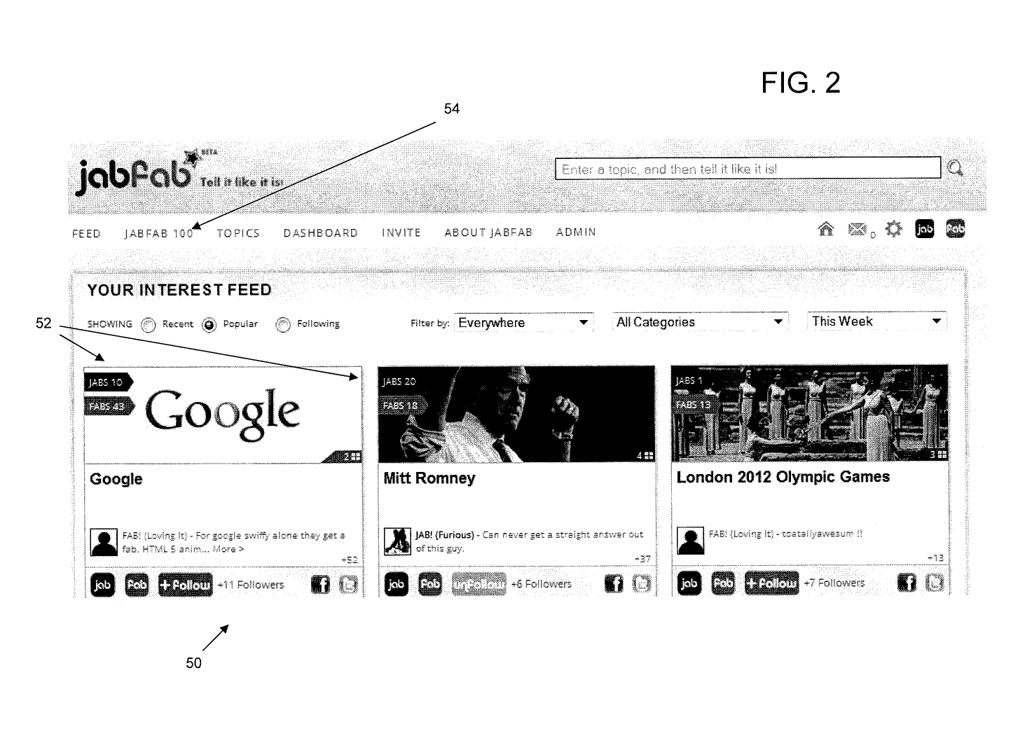

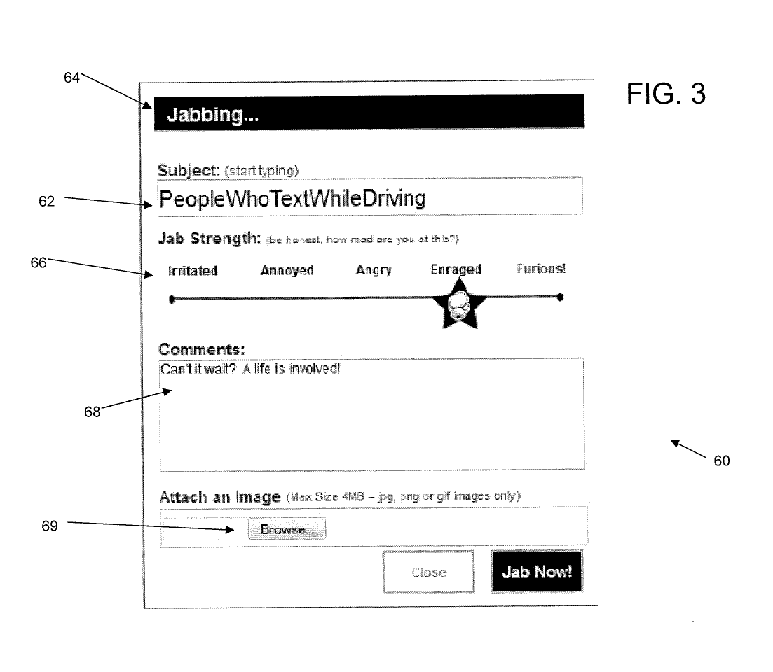

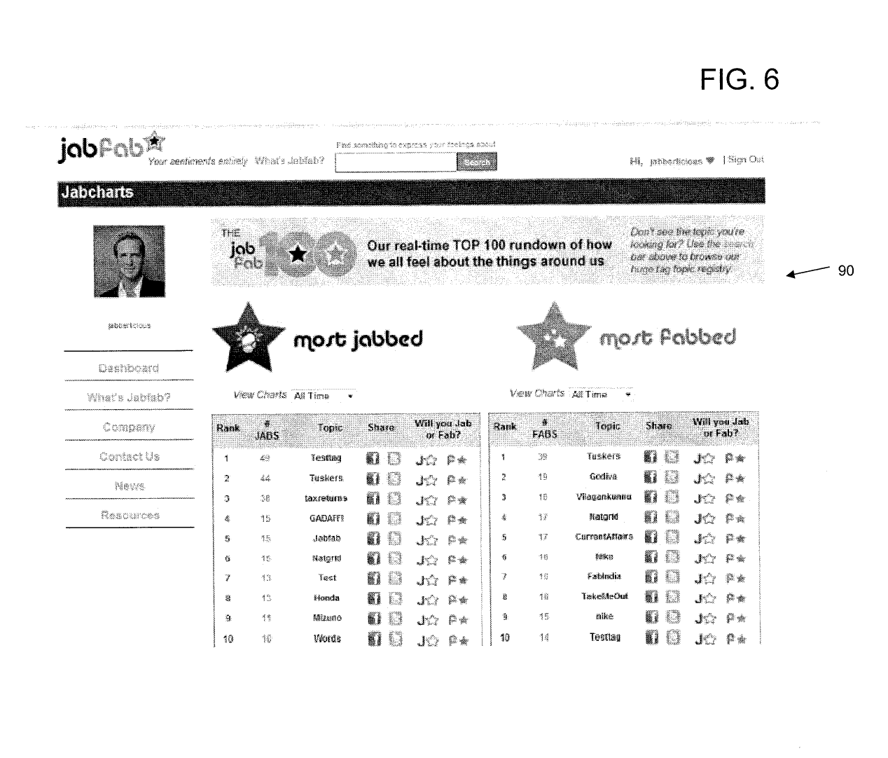

FIGS. 2-50 and 57-81 illustrate various visual display representations of different aspects of the present invention as described herein. FIG. 2 shows interface 50 that presents a potential contributing user with a binary option to electronically jab (convey negative sentiments) or fab (convey positive sentiments) a topic of their choice, and convey that sentiment to others using the central computer system (e.g., as implemented using a website) of the present invention as well as other social media computer systems and/or websites. FIG. 2 also shows areas of the interface where popular topics can be summarized or displayed as a feed as at 52, a link can be provided for a “Top 100” list as at 54, and where recent posts can be presented depending upon the user's preference, for example. A sample interface 90 displaying the Top 100 most fabbed and most jabbed topics is shown in FIG. 6. FIG. 3 illustrates an interface 60 whereby a user is “jabbing” the topic of people who send text messages while driving. As shown in the interface 60, the topic is identified at 62, the type of sentiment content is identified as at 64, the range of intensity of sentiments is provided as at 66, and areas for comments 68 and image uploads 69 is provided.

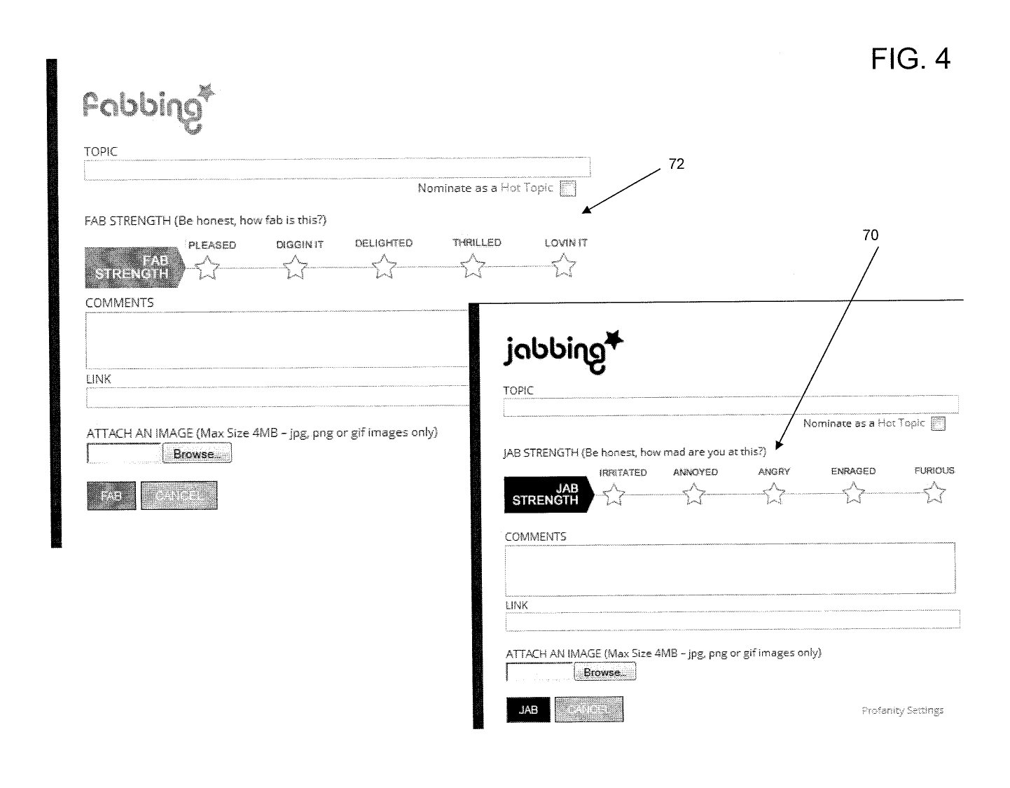

With regard to topic creation, it will be appreciated that the topics are not limited to pre-existing topics created by businesses and brands. Rather, a user is able to create his or her own topics based on anything the user wishes. Additionally, a user is able to indicate how strongly he or she feels about a specific topic as shown in interface 60 of FIG. 3. Thus, the user can provide structured sentiment content in the form of a positive or negative sentiment, along with an intensity level of the positive or negative sentiment. For example, the present invention permits a user to associate different intensity levels with a jab (negative sentiment) or a fab (positive sentiment). In one embodiment of the present invention, as shown in the interface 70 of FIG. 4, the jab intensity levels increase from less upset to more upset as follows: Irritated, Annoyed, Angry, Enraged, Furious. The fab intensity levels can increase from less pleased to more pleased as the follow examples illustrate with reference to interface 72 in FIG. 4: Pleased, Diggin' It, Thrilled, Delighted, Loving It! By capturing the relative strength of a jab or fab, the system of the present invention obtains more valuable sentiment data. In one embodiment, the present invention captures the intensity level by having the user select a strength rating using their browser and a mouse, function key or touch-interactive screen, for example, as well as the basic delineation between jab and fab. This strength depiction captures how strongly the user feels—positively or negatively towards a given topic. It will be appreciated that, unless otherwise noted, obtaining user input can be accomplished through traditional user input mechanisms, such as a keyboard, function key, touch-screen interface, mouse movement, microphone and/or other known input mechanisms (virtual or physical), and through traditional graphical user interface (GUI) facilitators, such as text boxes, drop-down menus, mouse-over clicks, etc.

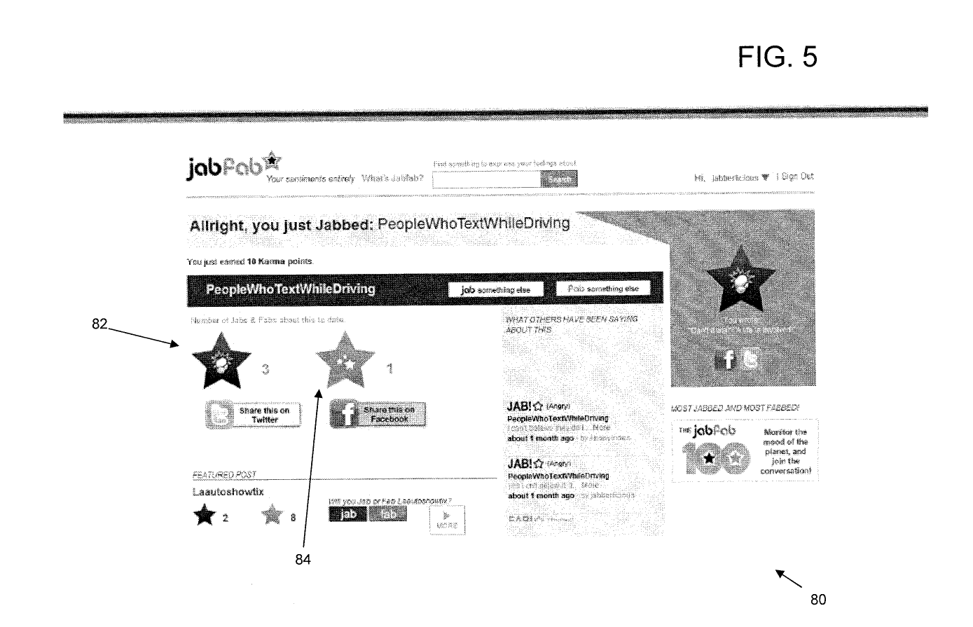

Once a topic has been created, additional users can share their own positive and/or negative sentiments on the stored topic. After presenting a contributing user with one or more structured options for contributing sentiment content, the system is capable of aggregating the shared sentiment data from the contributing user(s) and displaying the aggregated sentiment content via a browser program associated with a user's device. As shown in the user interface 80 of FIG. 5, one can then track the number of jabs as at 82 and the number of fabs as at 84 once the topic has been created. In addition, users can follow other user sentiment content by stating agreement or disagreement with another user's expressed sentiment. Thus, for example, a first user that expresses positive sentiment about a topic, can be followed by a second user that states “I agree” or “I disagree” with the first user's expressed sentiment. Agreements from other users can help support a user's social influence score, as described in more detail below.

In one embodiment, the present invention permits users to un jab or un-fab a topic, if a consumer has decided to amend their original sentiments. For example, if a business has listened to the consumer and addressed the consumer's concern in some tangible manner, the user may take advantage of the ability of the present invention to retract a previous sentiment expression. The present invention can further provide offer commercial information as a secondary data source, and league table, of businesses and entities that have proven to be responsive and consumer oriented in the “Customer 2.0” social media economy.

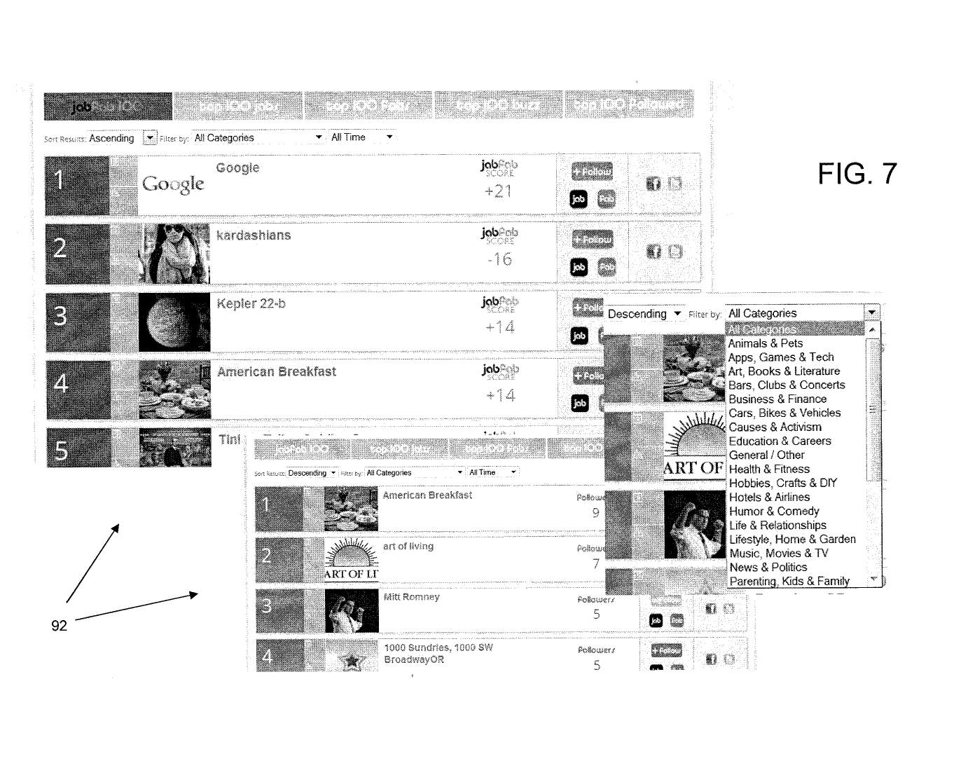

In another embodiment, as shown in FIGS. 6 and 7, the present invention provides interfaces 90, 92 with one or more real-time superlative lists, such as a list of top 100 jabs and fabs, for example. Such lists can be organized by category and time period, for example, as shown at 92. Such lists allow users to discover how the world feels and can be created by the Sentiment Creation and Sharing Component described in connection with FIG. 1. The present invention can aggregate the topics that have been created, and presents the results in interesting ways that are compelling to the user. In one embodiment of the present invention, the top jabbed and fabbed lists provide the following capabilities to a user, for example: (1) the ability to browse the real-time chart of the top 100 most jabbed (topics that have attracted the most negative sentiment) topics on the planet; (2) the ability to browse the real-time chart of the top 100 most fabbed (topics that have attracted the most negative sentiment) topics on the planet; (3) the ability to browse the topics that have the most ‘Buzz’—i.e., combination of the jabs and fabs they have received (total jabs plus fabs); (4) the ability to browse the topics that have attracted the most followers—i.e., people who are actively tracking and following the topic via the service of the present invention; and (5) the ability to browse the top 100 topics that have the highest Jabfab™ score (i.e. fabs minus jabs). The “Jabfab™ score” can be considered “the truth” about a topic. It is a calculation of fabs minus jabs to provide a positive score or a negative score. For example, Madonna's halftime show at the Superbowl may have attracted 4 million fabs, but also 1 million jabs. The net Jabfab™ score is therefore +3 million. The charts presented in the Jabfab™ 100 can be sortable by time period, by category of topic and location/distance/proximity to the user. Using the system of the present invention, users are able to browse sentiment topics, follow or unfollow them, share them via email or via third party social networks and/or add them to groups or collections (i.e., “stacks”) they are following of one or more topics.

Users of the system of the present invention can also police the editing of top-rated topics and ensure that other users cannot edit hot topics themselves unless they are the topic creator/founder. In one embodiment of the present invention, a topic that has already attracted sentiments (i.e., jabs and/or fabs) may not be deleted.

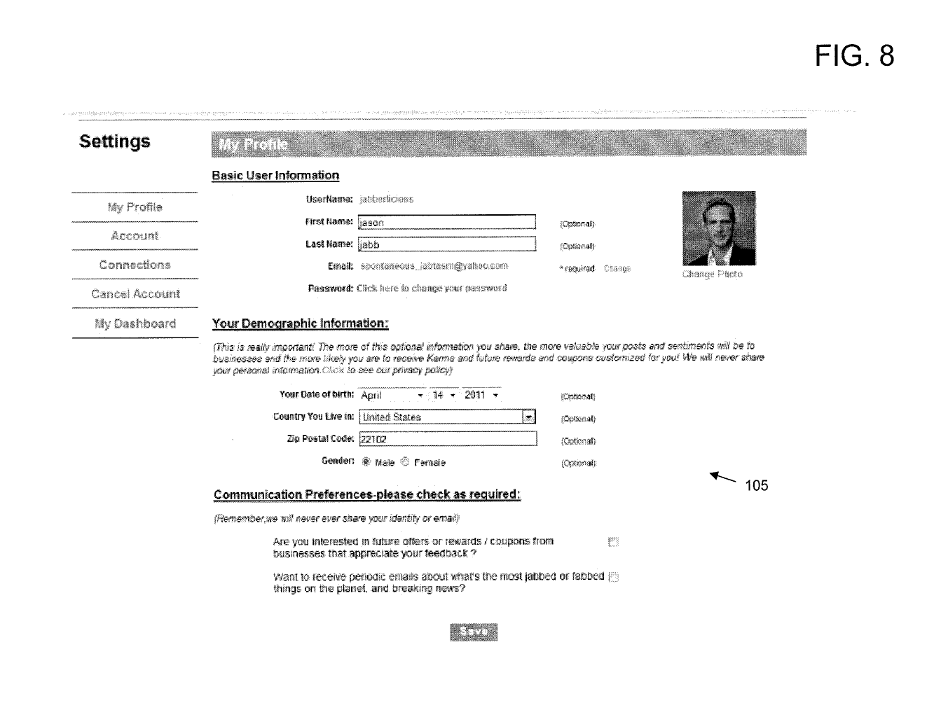

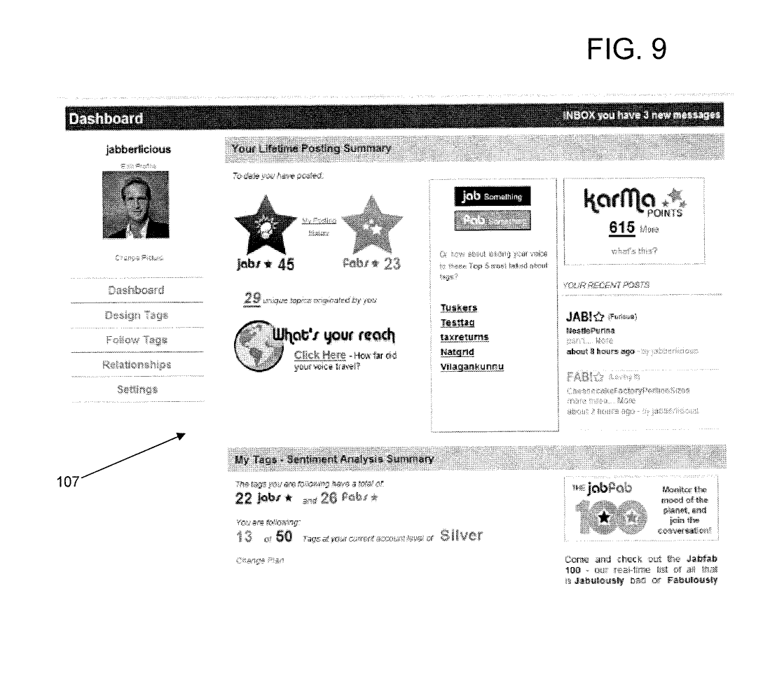

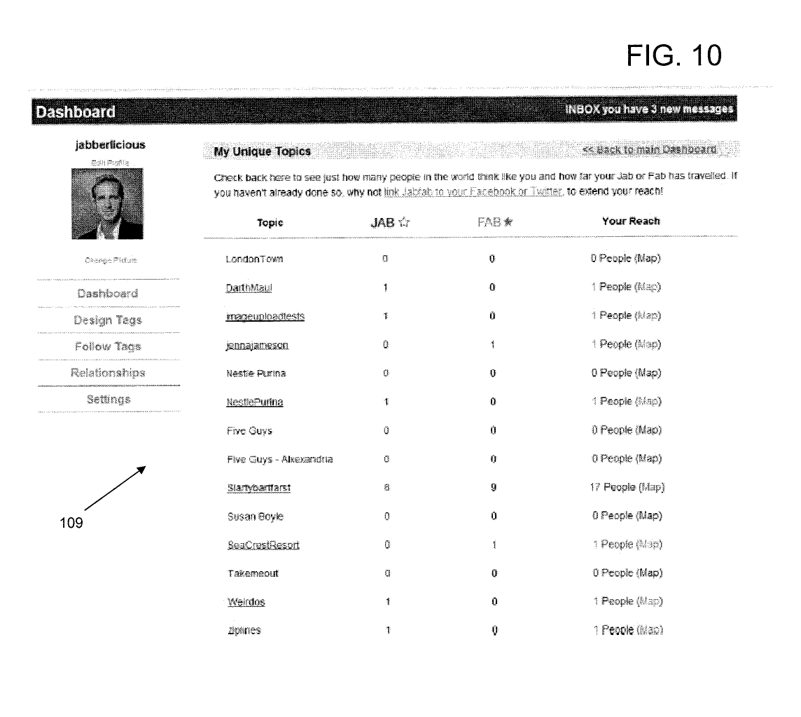

Once a user accesses the system of the present invention, the user may be invited to join as a member. While registration is not required, a registered user will typically register his or her profile as exemplified in interface 105 in FIG. 8. The user can also access user-specific information such as lifetime posts and sentiment analysis shown in interface 107 of FIG. 9 and uniquely created topics shown in interface 109 of FIG. 10.

The present invention can also include, for example, a real-time news feed so that a user can see what topics are currently being jabbed or fabbed. This can be combined with category, temporal, or geographic location information. For example, a user can view the real-time jabs or fabs within a 1 mile radius, within a 5 mile radius, in categories such as Causes & Activism, This Week, etc.

In addition to jabbing or fabbing, the present invention can permit a user to express other human emotions, feelings or gestures. For example, the present invention can provide the user with the option of expressing structured sentiment as a “Hug”, “Slap”, “Kiss”, “Curse” or other such form of expressive human emotion or sentiment that fits the topic or subject of the post. Further, the present invention can provide for the display of both positive and negative categories even if only one type of sentiment content has been received. For instance, if thirty users contribute sentiment content pertaining to Disney World™ and all thirty sentiment content expressions are positive, the present invention still displays the negative sentiment icon or category, albeit without any entries and a zero count. More specifically, Disney World™ may appear as a topic displayed by the present invention with thirty “fabs” and zero “jabs” in this example.

Users of the system of the present invention can thus follow and get feedback on individual topics as well as groups or collections of topics. In one embodiment, the present invention defines a group or collection of topics as a “Topic Stack” (as opposed to an individual topic). For example, an individual consumer user can pull together related or unrelated topics into an array or album in order to compare and contrast them and look at the positive and negative sentiment statistics of the stacked topics. The individual might do this of their own volition as a private topic stack that only they can see, but might also decide to make the topic stack visible to others in the topic registry and then share the entire stack with friends in order to get feedback on these topics as a unit. For example, an individual consumer user with an affinity for blogging can create an interest group around a stack, because the user has created a very interesting group of topics that others find appealing. The present invention can also provide such a user with editorial control over the stack, with other user “curators” who may be designated by the stack creator or voted in, for example, to become champions and stewards of topic collections, either for an individual's stack(s) or within the system of the present invention in general.

Stacks, in accordance with the present invention, provide the ability for users to organize the sentiment topics they are following into collections or groups of topics that may be related or unrelated so that the stack can be reviewed and individual topics compared. For example, a user can assemble individual topics about a football or baseball team (e.g., each player as a topic) into a group that represents the team. Or, a user can organize a group of topics such as the American Idol™ top 10 contestants, or the U.S. presidential election candidates into a topic collection or group. In one embodiment of the present invention, the collection is established using the Sentiment Creation and Sharing Component (described below), and can assemble the sentiment topics into a group view where they can be manipulated. Sentiment data already collected about these topics individually can be presented or also aggregated to provide the user with insights and information about the stack as a whole. Stacks can be shared with other users, other users can follow them, and they can be shared inside the system of the present invention or via third party social networks or via email (for display or to solicit sentiment feedback about the stack or the individual topics). The stack can be edited and accompanying descriptive information or editorial content can be associated with the stack. The underlying raw data concerning the sentiments, which can be anonymized by the system of the present invention, is presented on these topic pages and can also be purchased by businesses that are looking to analyze the data using third party Sentiment Analysis tools, such as Salesforce.com™ (Radian 6™) or Nielsen™ for example. In another embodiment of this raw data exchange of structured sentiment data, the present invention can provide an Application Programming Interface (API) that enables a business that is using an enterprise level Sentiment Monitoring or Sentiment Analysis tool to automatically pull data from the system of the present invention into these tools Importantly, the extracted data from the system of the present invention is already structured from initial user input and therefore requires no or little further processing in order to provide the business with actionable intelligence.

Through the use of stacks as provided by the present invention, business users can pull all of the topics around their product, operations, business locations and other business affairs into a private stack, so they don't have to follow their own topics individually. For example, a business user might be a restaurant that can use the present invention to create individual topics for their brand name and overall location name; their staff/service waiters and each food item on their menu, for example. This type of business user can even put QR codes on their menus or staff clothing, for example. By creating a topic stack, the manager of the restaurant can get a holistic view of the sentiment feedback coming in for the individual topics. The manager can also use the present invention to pull in topics from a local competing restaurant into the same or a separate stack, and be able to compare and monitor sentiment towards his competition.

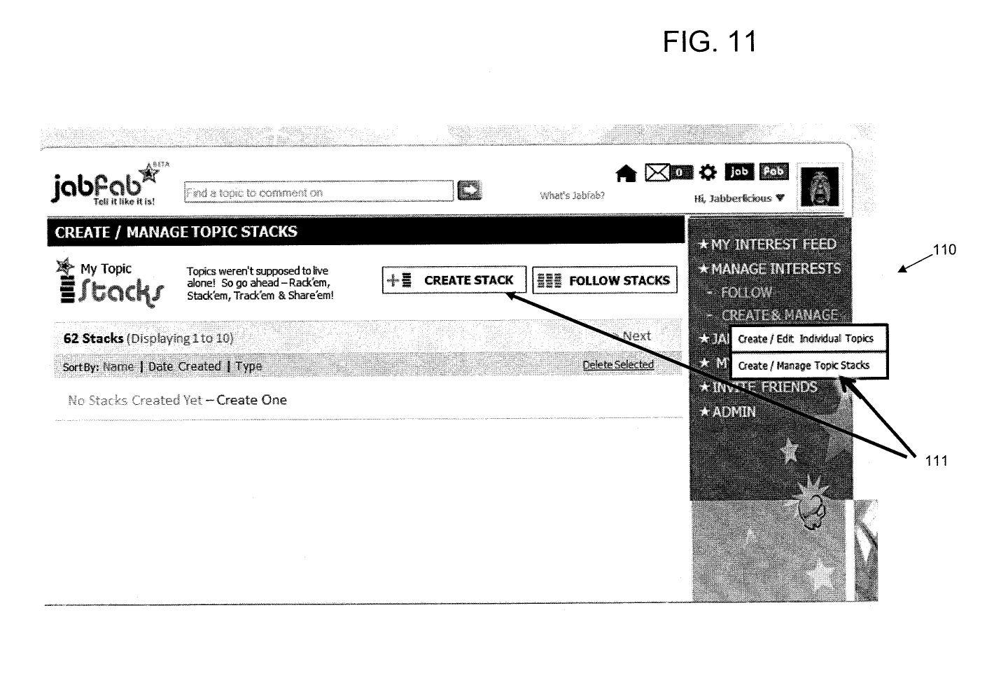

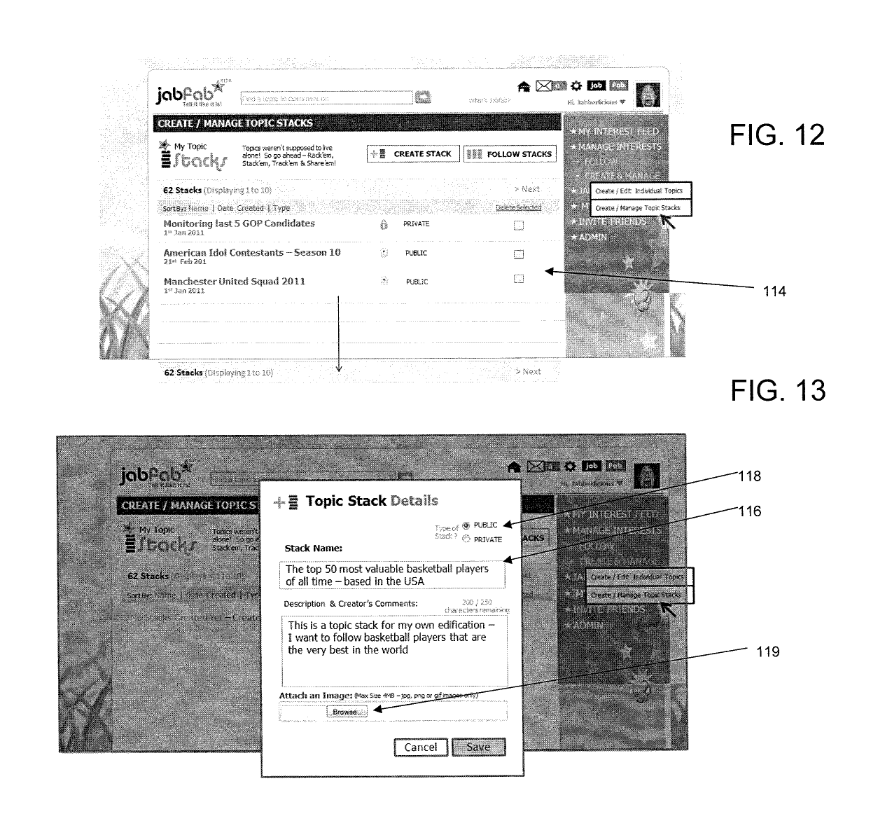

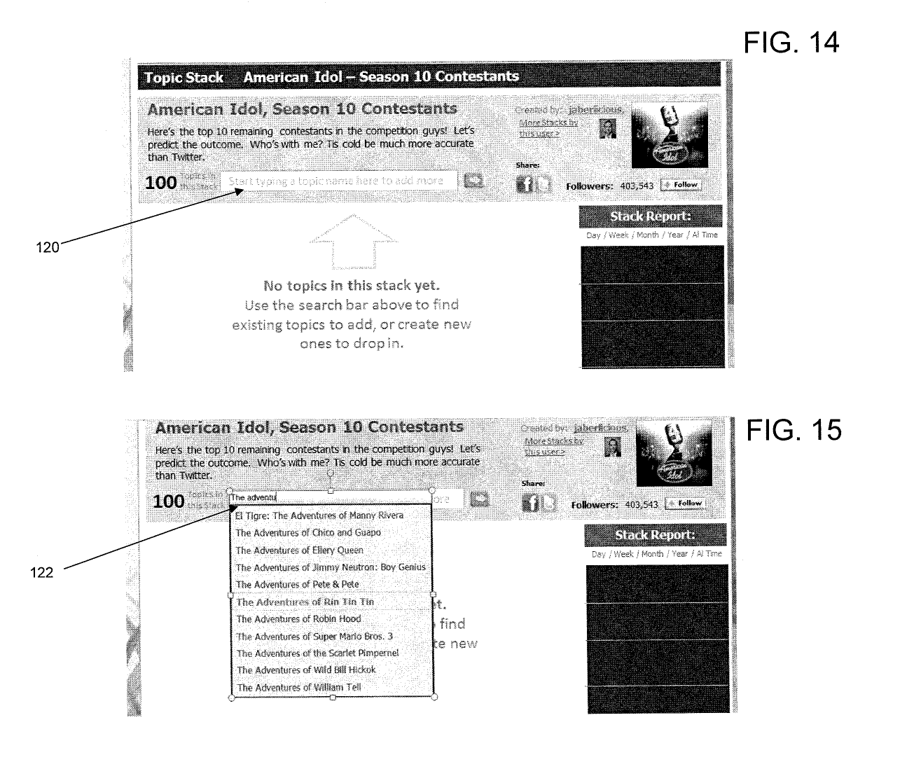

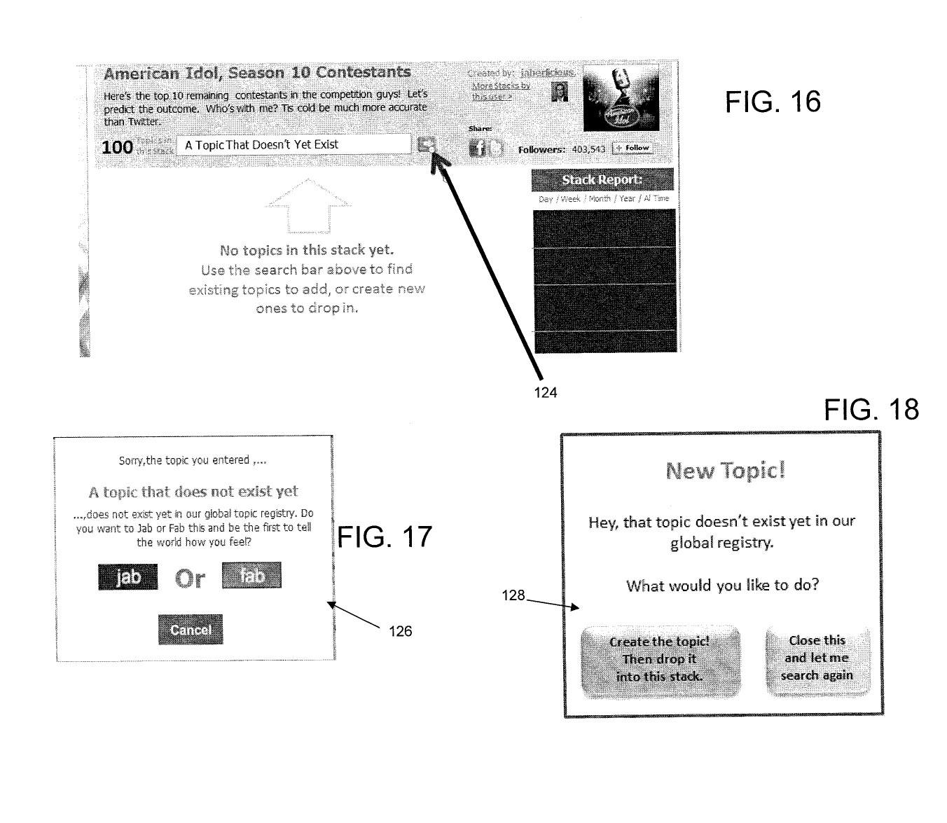

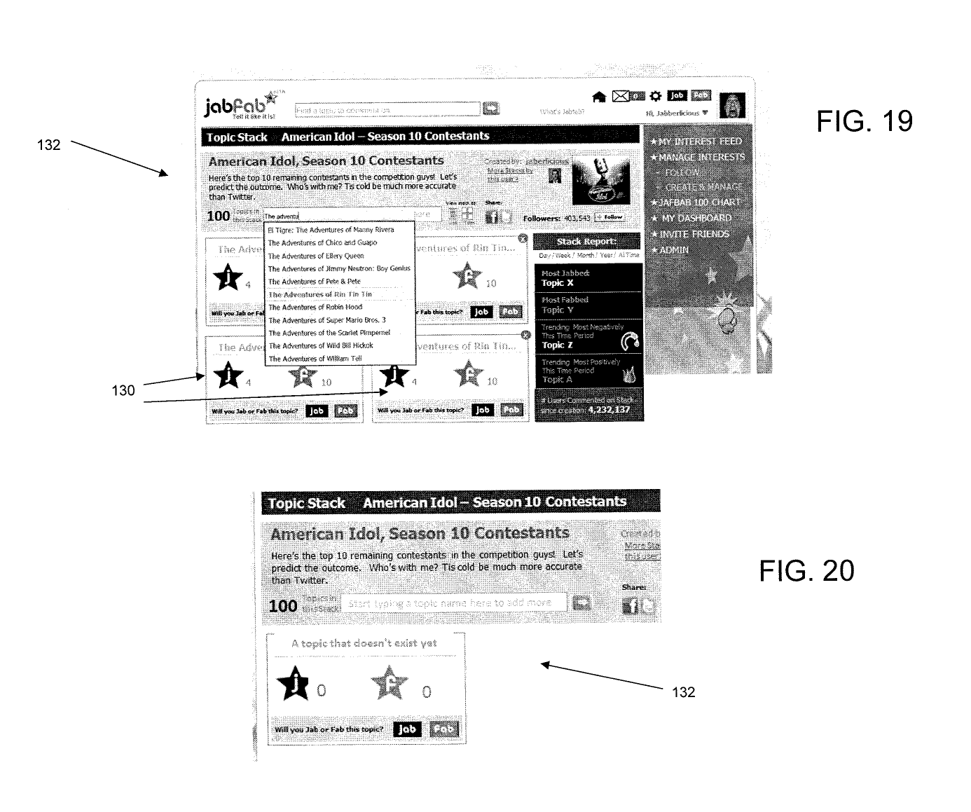

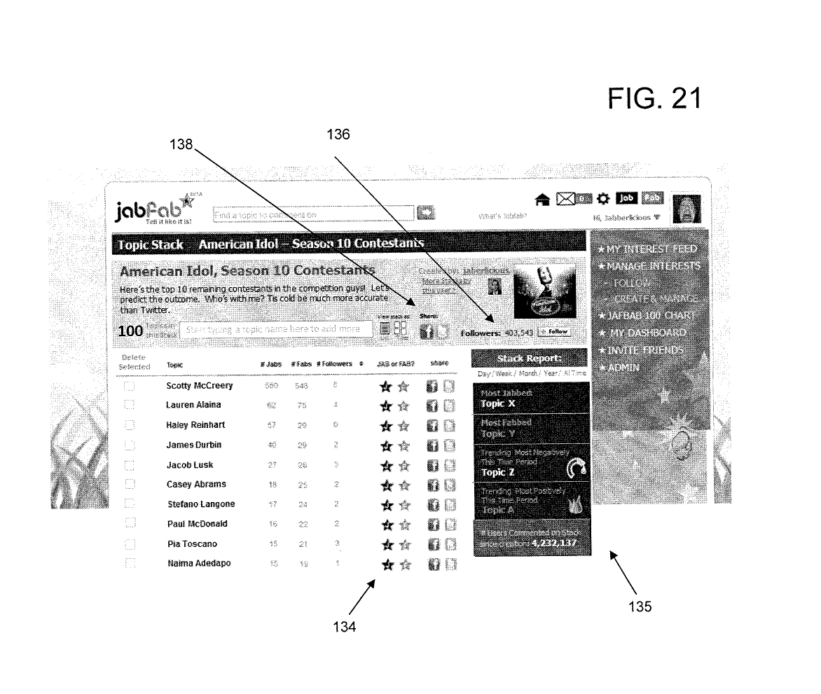

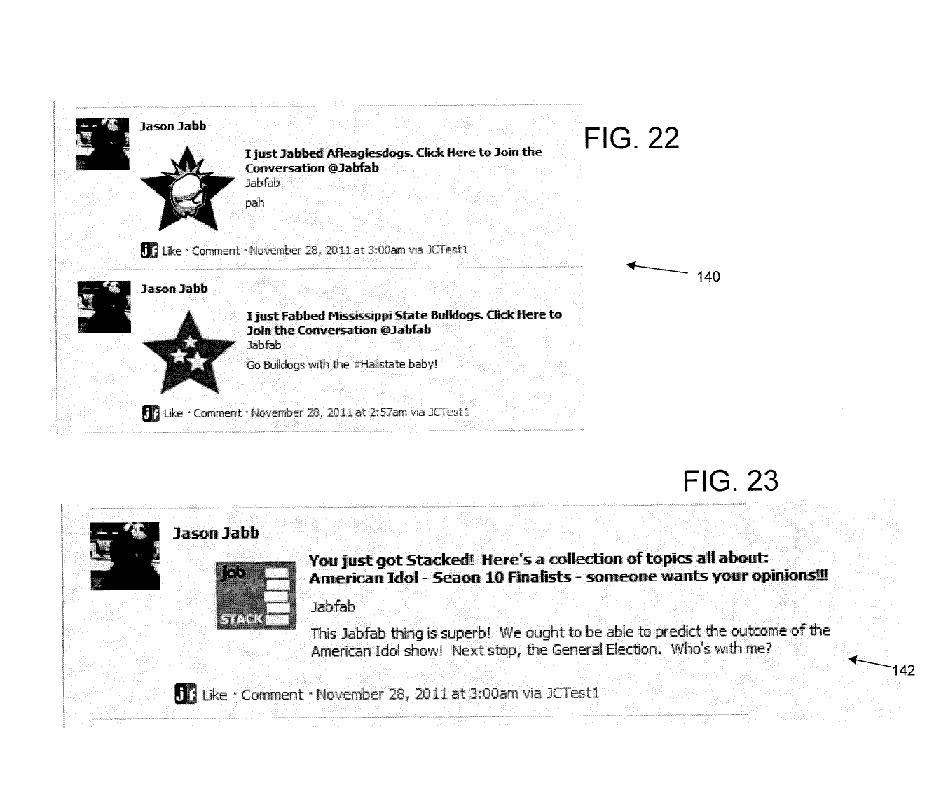

In various embodiments of the present invention, any user can create a topic stack, any user can create as many topic stacks as they like, topic stacks can appear in a topic registry alongside topics and can be followed as interests in the same way that topics are followed, and users have the ability to decide upon creation or development of a stack if they want the stack to be private (visible to only them) or public (visible for others to follow in the topic registry and shareable via social networks). As shown in interface 110 of FIG. 11, the present invention can provide a menu from which a user can select a stack creation function. FIG. 12 illustrates an exemplary interface 112 showing several created stacks, and FIG. 13 illustrates an exemplary interface 114 showing details pertaining to a single stack. In one embodiment of the present invention, a stack can comprise the following main components: (1) a creation routine permitting the user to define the topic stack name, such as shown in 116 in FIG. 13, the owner (“stack founder”) username auto generated from the profile of the person creating it, and the private versus public flag such as shown at 118 in FIG. 13; (2) the ability to add one or more topics into the stack, such as shown at 120 in FIG. 14, at 122 in FIG. 15 wherein topic name options may be auto-generated after typing in one or more characters, at 124 in FIG. 16, at 126 in FIG. 17 and at 128 in FIG. 18, and wherein limits can be set on the number of stacks that users may develop at certain levels of membership or loyalty points, for example; (3) a summary display area on the user's interface into the system of the present invention, wherein the summary display is updated with information from the positive and negative sentiment feedback on the topics within the user's stack(s), such as shown at 130 in FIG. 19, at 132 in FIG. 20 and at 134 and 135 in FIG. 21; (4) an editorial area for a description about the stack and any announcements or updates, such as at 132 in FIG. 20; (5) a place to add image content such as a photo to describe the stack, such as shown at 119 in FIG. 13; (6) the ability to add/remove topics from the stack whenever user wants; (7) the ability to reshuffle the order of the stack if possible using “Ajax style” sorting, such as having the order of a stack changed based upon a user's click on a table header, for example; (8) the ability to see how many people follow the stack, such as at 136 in FIG. 21; (9) the ability to share the stack with friends on Facebook™, Twitter™ and other sites, such as at 138 in FIG. 21, and at interfaces 140 in FIGS. 22 and 142 in FIG. 23, which show how a third party website might appear to illustrate what another user may see when a first user has identified a stack on the third party site; (10) the ability to keep the association of topics (assuming that the stack was a public stack) system-wide, such that other users see the topics as being associated, and the system of the present invention recognizes which topics are related to each other so that later it can present related topics to users; (11) a dedicated and personalized page that can be the main page a user uses after logging into the system and that essentially acts as the user's “Interest Feed” of everything going on in the world related to the topics they follow. The personalized page can include links to stacks that the user manages or follows and the related topics to their interests. It will be appreciated that users separately have the ability to follow other users such as those, for example, whom they respect as providers of positive and/or negative sentiment content; and (12) the ability for a user to invite a defined list of other users to see a private stack (“Invite Only Stack”). For example, assume a human resources manager at work wants to send some ideas to employees and creates a stack to do this and to get ratings on the ideas. The stack is private, but the HR manager can add or upload the email addresses of the people who should have access to see it. When those users sign up with the identified email address and have a verified account, such users would be able to see the stack.

FIG. 11 illustrates an exemplary user interface 110 that may be provided by the system of the present invention allowing a user to select the option 111 to create/manage topic stacks. For a first time user, the page has no topic stacks identified yet. After stacks have been added, the interface can build out as desired by the user. The user can save such actions and move to the next step, or cancel and close out. After the user saves the entries, the present invention can present one or more interfaces such as those shown in FIGS. 14-18 for the individual topic stack.

If the user starts typing in the box in interface 122 as shown in FIG. 15, the present invention can behave similar to when topics are created, and there are only topics that can be found (not stacks). If the user creates a topic that does not exist, the interface can appear as shown in FIGS. 17 and 18, for example. If the user elects to have the system create the topic, it does so, adds the topic to the registry, and then adds that topic as the first topic in the stack (if this is the first topic to be added) or subsequent topic if others have already been added. If the user closes the window, then they can search again. The search tool of the present invention enables users to set out topics that are attracting polarized negative or positive sentiments, for example, using a text search bar and accessing the topic/sentiment database, then returns a list of topics that exist so the user can select a topic, browse the sentiment content, and perform actions such as sentiment expression or sharing the sentiment topic with others via email or social networks.

In any number of embodiments of the present invention, the engine for sentiment discovery of the present invention can be personalized. The system can track all sentiments expressed (positive, negative, comments, location etc.) and then relate topics to each other and present related topics that may be of interest to the user. For example, because a user jabbed A, B and C, the user may be interested in seeing D. Or, because they fabbed A, B and C, the user may be interested in seeing D. Or, because they fabbed A but jabbed B (or vice versa), then they may have an interest in C. Or, because they jabbed A and were at X location, perhaps they might be interested in topic B. Dynamic assignment of “featured topics”, “related topics”, etc., drives personalization in accordance with one embodiment of the present invention. If the present invention determines that the user's activity and jab or fab behavior exhibits any type of pattern, the system of the present invention can then intelligently match topics of interest or related topics to present to the user. In one embodiment, a pattern of multiple instances of user behavior is not required, and the system of the present invention can, for example, present other topics or information to the user based upon a single interaction with the system. For example, if the user jabs the New York Yankees, the system of the present invention can present the user's interface with other professional baseball topics.

The real time “Stack Report” shown at 135 in FIG. 21 can be sortable by the user according to time and other factors. For example, a user can elect to see stack details for the current day, month, year or all time by selecting the appropriate link. In one embodiment of the present invention, the stack report area can further show top topic(s) that are trending, such as in list format or a space-saving ticker cycling through the top topics using a suitable refresh rate, for example. Different numbers of top topics may be shown or cycled depending on space and/or user preferences. The stack report area can further show the number of people who have responded and/or commented. Further, the stack report area can show a grid of the profile pictures of the most recent people who commented on or viewed the topics in a given stack.

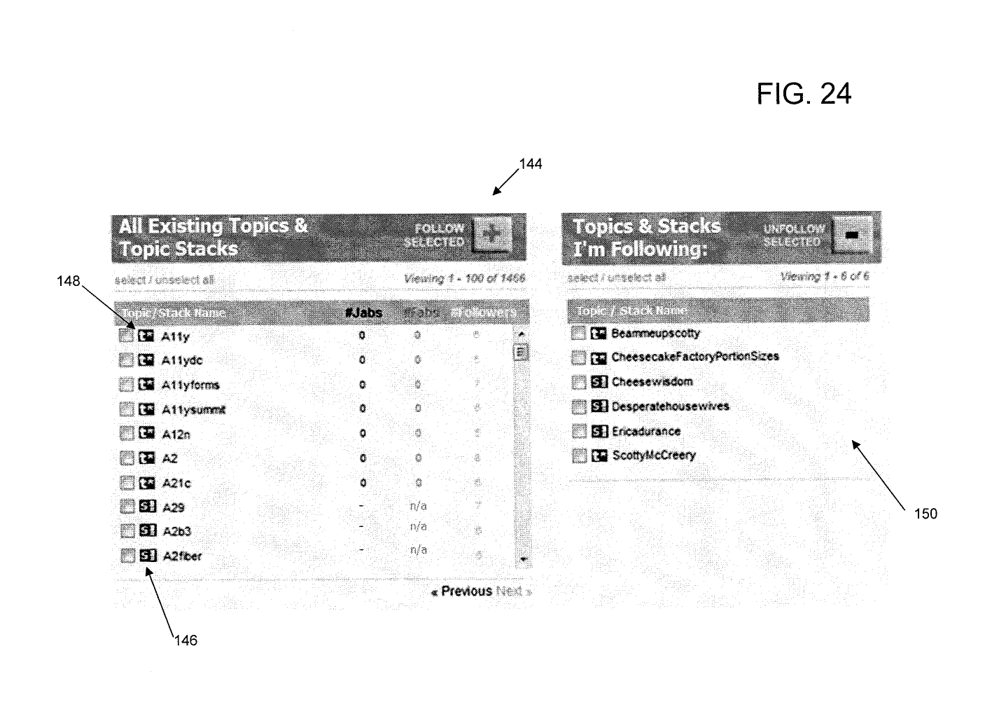

In one embodiment of the present invention, if the user created a stack, then they can edit it and see an “Edit Stack” option. The same Stack Details window permits edits. If the user has determined to allow others to see their public stacks, then there may be a link under the user creator name that says “More Stacks by this user” and links to a list of their stacks. A user can follow stacks just like topics by clicking the “Follow” button on the stack, for example, as illustrated at 144 in FIG. 24. Stacks and topics can be listed together with a clear, distinguishing icon so the user can easily differentiate what is a stack (e.g., 146 in FIG. 24) and what is a topic (e.g., 148 in FIG. 24).

In one embodiment of the present invention, if a user follows a stack, as indicated at 150 in FIG. 24, then the user is, by default, following all of the topics under that stack and therefore does not need to follow each topic individually. The system of the present invention can include, in one embodiment, a feature allowing the user to sort the list by topics and stacks or to display a mixed list.

It will be appreciated that topics can be removed from stacks through user selection. It will further be appreciated that public stacks can be copied by other users and modified as desired. Additionally, users can move topics around in a given stack and reorder them. In one embodiment of the present invention, the user who created a stack is the only one who sees an edit link to edit that particular stack, while other users who may wish to edit the stack may only do so by copying the stack and creating their own personalized stack. It will further be appreciated that a user can decide to turn a stack private after being public, or vice versa. Additionally, stacks can be added to top 100 lists and other superlative lists in accordance with the present invention. Further, in one embodiment of the present invention, items in the stack can be made interactive, such as with hyperlinks, such that when clicked, the system can take the user to the stack page for that stack.

When a user desires to share a stack with his or her social graph via Facebook™ or Twitter™, for example, the present invention can provide interface options in accordance with one embodiment of the present invention. First, the user should have a completed public stack that is available for viewing by others. Next, the user can select the preferred social media outlet such as by using icons illustrated at 138 in FIG. 21. Upon receiving a user selection, such as the Facebook™ icon, for example, the present invention follows similar processing for posting to a social media site as it does for sharing a topic, using a suitable application programming interface (API). In one embodiment of the present invention, the Facebook™ wall may appear as shown at 140 in FIG. 22 for a topic share, and as shown at 142 in FIG. 23 for a stack share.

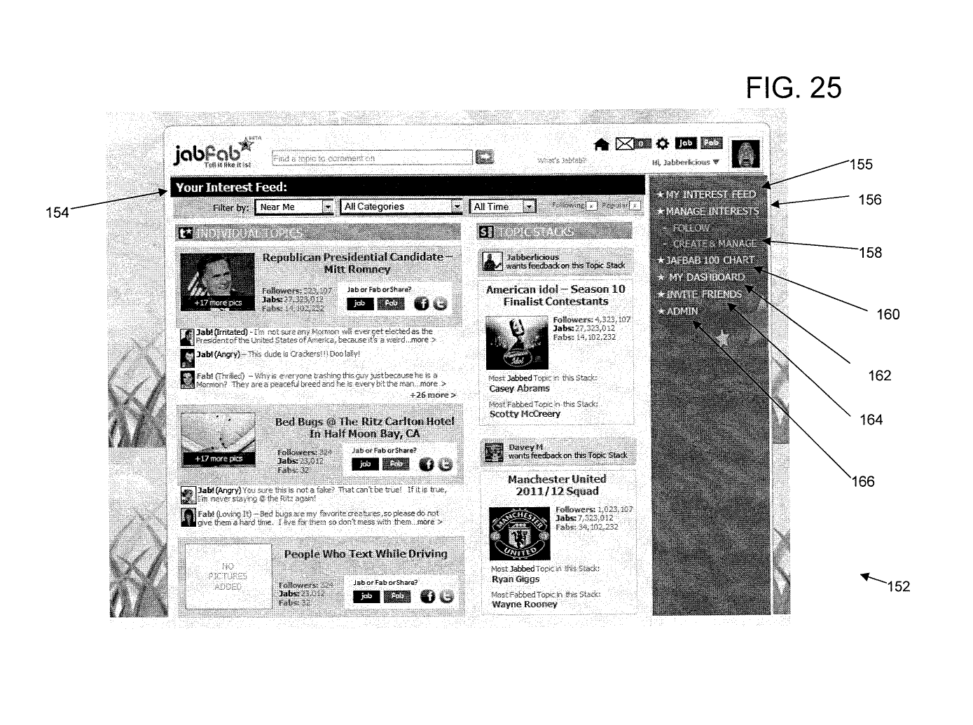

An exemplary user interface 152 for permitting a user to create an interest feed, individual topics and/or topic stacks is shown in FIG. 25. As shown in FIG. 25, the user can select to see his or her own “Interest Feed” page 154 by selecting icon 155, or the user can select to manage interests as at 156 to follow topics, stacks and/or users and to create and manage individual topics as well as topic stacks. If the user selects the “create and manage” selection 158, the user can then be given an opportunity to create/edit individual topics or to create/edit topic stacks as described above. If the user selects My Interest Feed 155, the present invention provides a page as shown at 152 whereby a feed of all the topics and stacks a user follows and related interests can be provided using the system of the present invention. Other selections available in accordance with the exemplary interface 152 of FIG. 25 include a top 100 chart 160, a personalized user dashboard selection 162, an “invite friends” selection 164, whereby the user can arrange to have notices sent, such as by e-mail, to known others who may wish to use the present invention, and an administration selection 166 to permit the user to conduct administrative operations.

The interest feed can be the page that users of the present invention may prefer to use as their home page associated with the system of the present invention. In one embodiment of the present invention, the interest feed page is a real time stream/feed of the topics of interest to the user, including, for example, the negative (i.e., jabs) and positive (i.e., fabs) feedback coming in, topics or stacks that are popular that day, topics or stacks that are interesting based on the user's previously expressed sentiments, and the Stacks and topics they are following and related topics to the ones they follow. It will be appreciated that the term “based on” means “based at least on” in the present disclosure, unless expressly specified otherwise.

As noted above, the interest feed page can be the first page a user sees when signed in to the system of the present invention. In one embodiment of the present invention, a user-configurable choice for what page they are taken to after sign in is provided. When the user first arrives to the page, the page can prompt the user to find some topics or stacks to follow and to decide upon a configuration. The user can see some content immediately without having to follow any topics or stack, because the user can simply select “Popular items” to immediately begin seeing them the most popular topics according to the various filters that can be employed in accordance with the present invention. The filters can include: (1) a proximity filter which filters content based on geography; (2) a category filter, such as the categories used for topics described above; (3) a time period filter, which filters the interest feed by a designated time frame established by the user; (4) a “following” filter that provides content based on what topics and/or stacks the user is following; and (5) a popular filter, which may be a default selection that provides a user with content that is deemed popular based on total number of comments, total number of followers or another metric.

With regard to the proximity filter, the present invention can use the user's profile settings to provide content that has been posted by other users who have originated topics and or stacks from the same area near that user. This function filter can use, for example, the user's zip/postal code from the user's profile, and display content that originates from users with the same city, state, country and/or other meaningful geographic limiter based on the user's profile. The proximity filter can be specifically set by the user to geographic regions unrelated to the user's own established location (as determined by geofiltering or by user-inputted content). For example, a user may want to receive content pertaining to an area where the user intends to travel in the future. Further, the user can elect not to limit content based on proximity, such that topics are available from anywhere.

In one embodiment of the present invention, and in order to make the interest feed interesting, the present invention can alternate feed sources. For example, if the user is following some topics and stacks based upon their being popular or because the user has elected to follow them, the present invention can operate so as to show one topic that is from the user's “follow” list and one stack that is from the user's “follow” list. The system can then operate to alternate with a topic that was selected because it is popular, and a stack that is popular and so on. In this way, the present invention can mix up the content and then get the user to follow more topics because there are certain things that they are not following and which the system and/or other users may want the user to follow, for example.

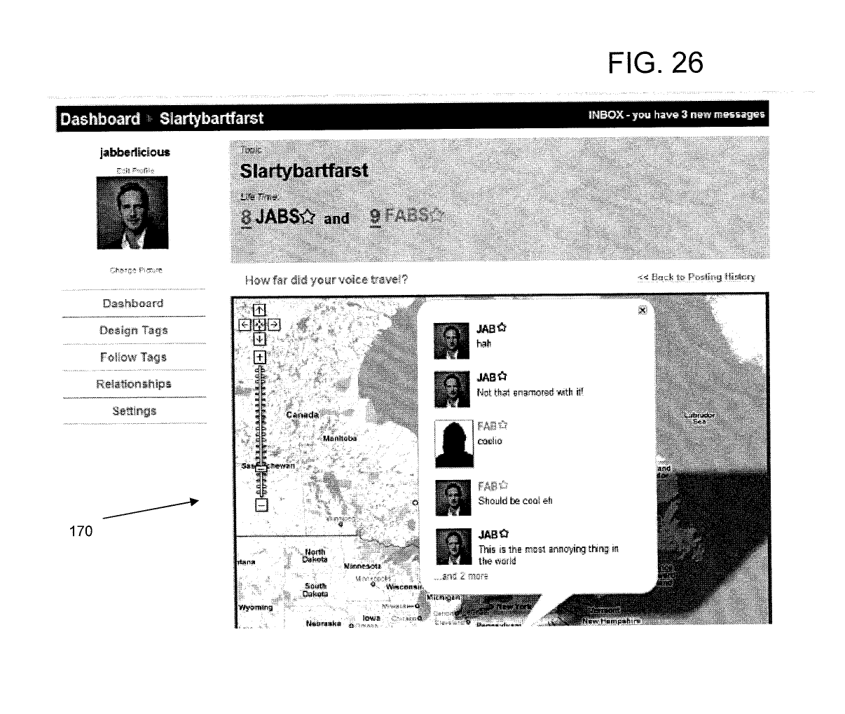

The present invention permits users to jab and fab topics regardless of whether the user is registered with the system of the present invention. In one embodiment of the present invention, a user is able to register by creating a user profile, as shown in FIG. 8 at 105, which can provide the user with access to more functionality and the ability to earn loyalty points, for example. In turn, marketers using the system of the present invention can be provided with access to anonymized demographic information and the user's sentiment postings. As shown in FIGS. 9-10 and 26-28, the present invention can provide a “Dashboard” for users who create a user profile. Such users can use their individual dashboard to view their posting history, enter basic user information that will not be shared with anyone else (e.g., name, email address), enter their own demographic information, follow tags, view geographical information, and view their individual consumer loyalty points balance. As shown in interface 170 of FIG. 26, a user can determine what his or her geographical “reach” is with regard to topics, as the system of the present invention can display a map with icons and/or images representing locations and individuals who are following a topic created by the user or who have jabbed or fabbed a topic created by the user. Geographical reach is discussed further elsewhere in the present disclosure.

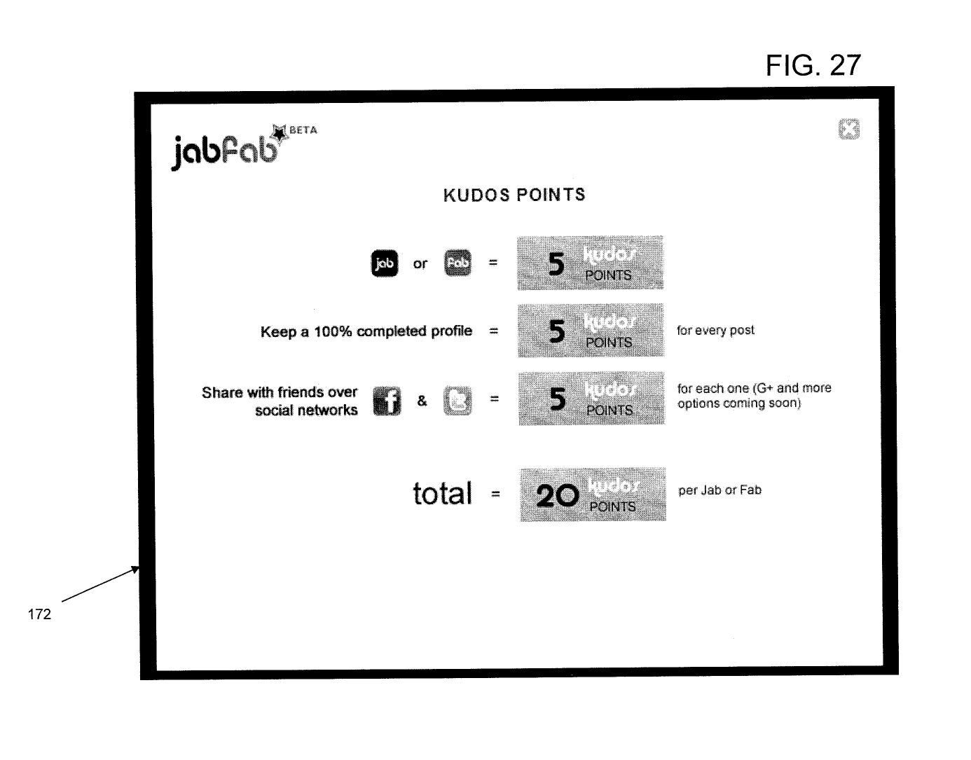

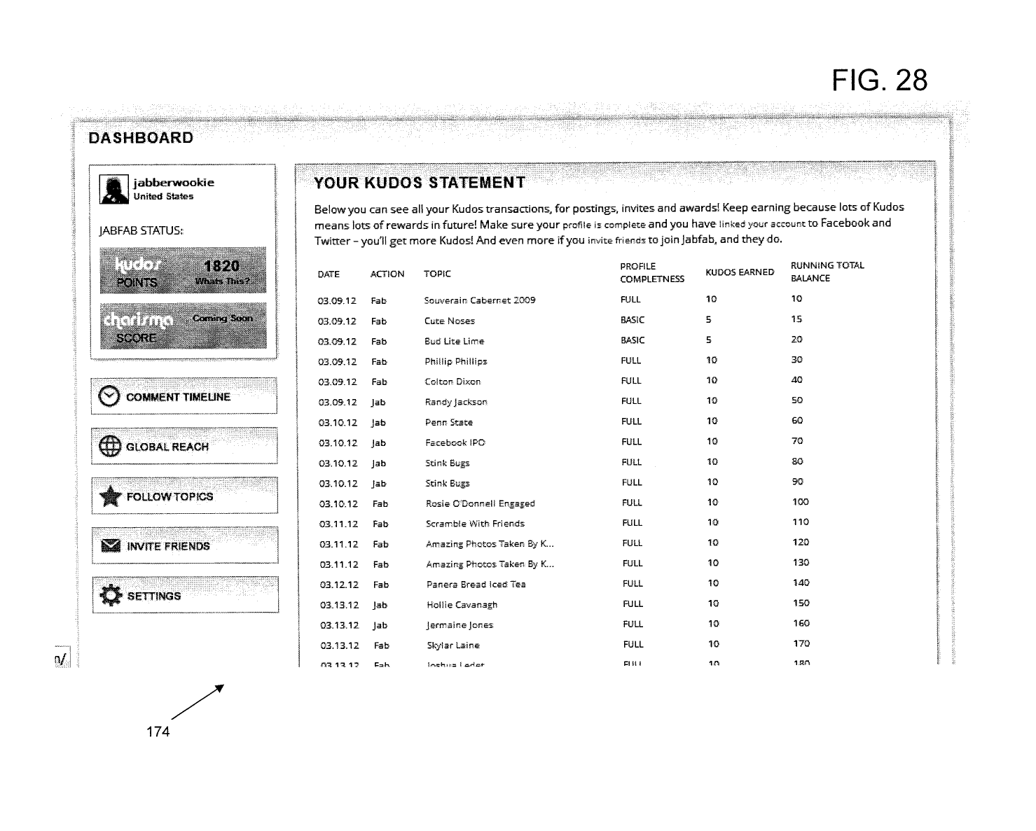

As shown in FIGS. 27-28, one embodiment of the present invention incorporates loyalty and/or bonus points (also referred to as Jabfab points, Kudos Points or Karma Points in exemplary embodiments) that can be earned when a user records structured sentiment for a topic, for example. In one embodiment, a user must have a user account to gain Kudos points; therefore, Kudos points encourage users to set up a profile and enrich it with their demographic information, or amplify the sentiments via their networks of friends to gain maximum points. For example, if a user links their account to Facebook™ or Twitter™, the present invention can provide the user with the opportunity to double or triple the Kudos points earned for jabbing or fabbing a topic by posting the jab/fab to the user's Facebook™ and/or Twitter™ account. Accumulated Kudos points can be redeemed for prizes, third party marketing partner offerings and deals, or exchanged for services, such as a Jabfab™ Listen Subscription as described herein, for example. Different amounts of Kudos points can equate to different levels of Jabfab™ Listen subscriptions. Another embodiment of the present invention contemplates issuing bonus loyalty (e.g., “Kudos”) points to a user in exchange for inviting friends to join the system of the present invention. FIG. 27 illustrates an interface 172 for describing aspects of the present invention's loyalty component, and FIG. 28 illustrates an interface 174 for revealing individual loyalty point accruing activities and a loyalty point statement.

The system-branded Kudos Points provide a mechanism to gather social capital attained by users that are sharing their sentiments via self-expression. The degree of sharing is up to the user and can be controlled in a settings/profile aspect of the present invention. In one embodiment, the present invention provides rewards to users for this expanded sharing by issuing larger amounts of Kudos points. For example, a user may gain 5 points for a jab or fab, 5 more points if their profile contains demographic data, and 5 more points for each social network or third party site they share their sentiments with. The Kudos Points balance can be stored in the system in the user's profile and can be displayed on the user's dashboard. Over time, a user may attain a system-defined status based upon the number of Kudos points. The user can also be awarded special badges, medals, ribbons, etc. based on accumulation of Kudos points or meeting other thresholds according to the system of the present invention. The present invention can also provide the user with the ability to participate in deals, rewards and/or offers that are presented via third party marketing affiliates, brands and/or businesses that are commercially joined with the system of the present invention.

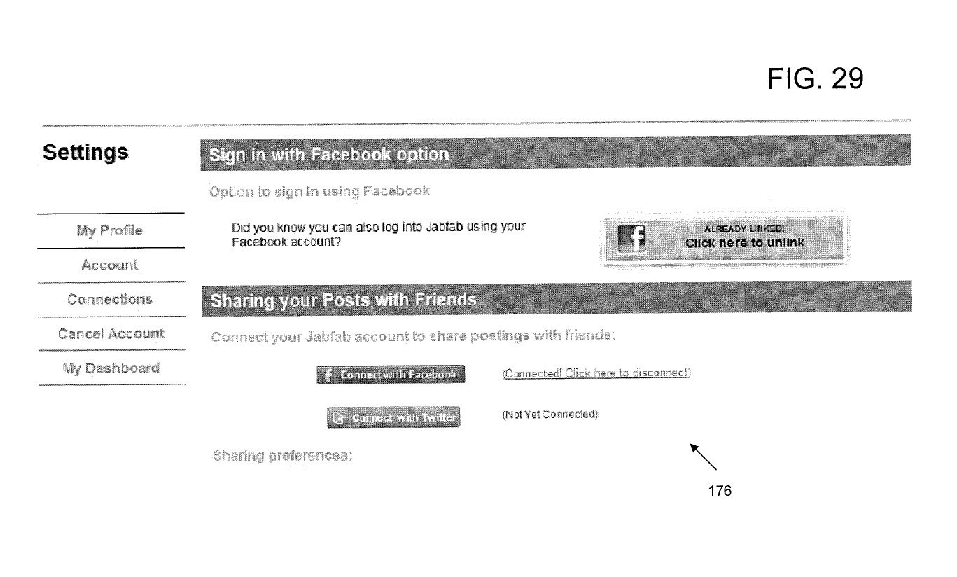

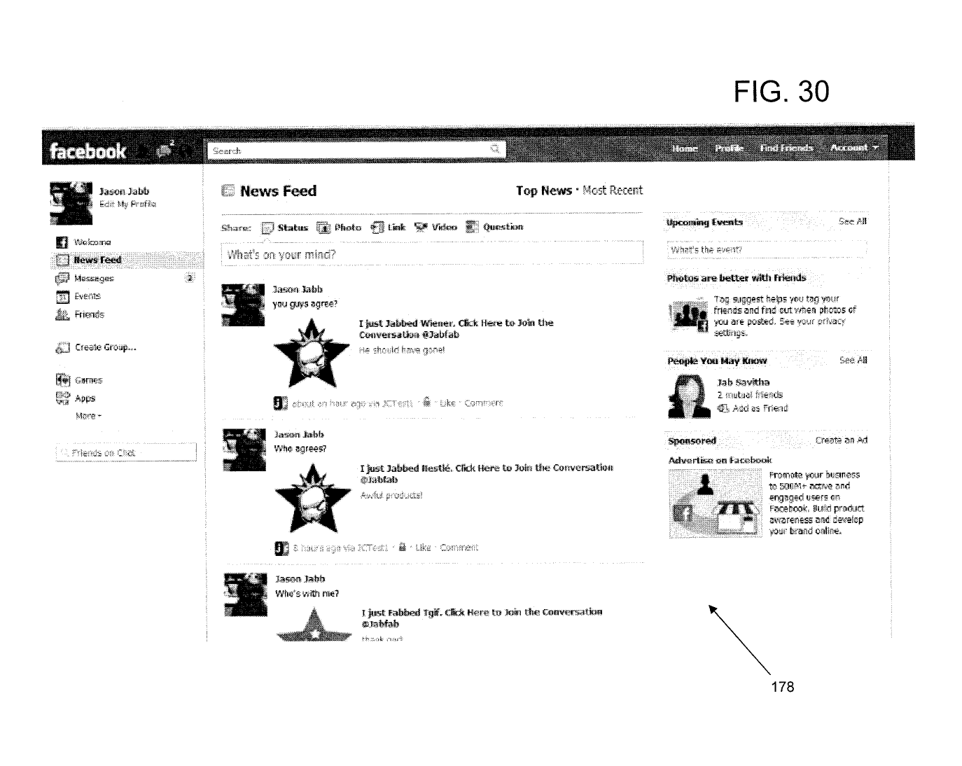

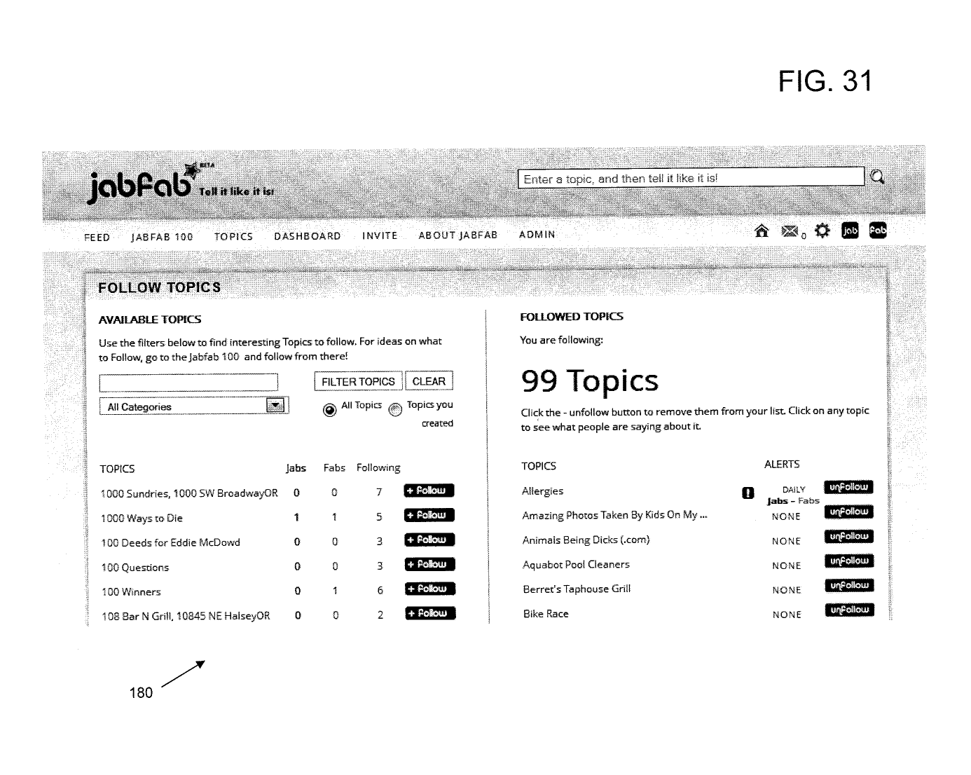

In one embodiment, registered users are permitted by the system of the present invention to link an account associated with the present invention (e.g., a “Jabfab™ account”) to third party service accounts, such as Facebook™ or Twitter™ accounts, for example, and thereby share sentiments with friends. Interface 176 in FIG. 29 illustrates this option, whereby a user can sign in using a third party service, and further whereby the user can share posts with friends via third party services. FIG. 30 shows an exemplary interface 178 of a news feed page on Facebook™ whereby the user has posted his or her positive and/or negative sentiment content. In one embodiment of the present invention, as shown in FIGS. 31-33, registered users are permitted by the system of the present invention to access sentiment analysis data for a topic (also referred to as a tag or subject) created by another. For example, a basic user profile might enable the user to follow up to ten (10) tags. As shown in the exemplary interface 180 of FIG. 31, a user can type in a topic to follow, or can select topics from a topic registry. Following (also referred to as “tracking”) a tag can allow the tracking user to, for example, view average intensity data for jabs and fabs of the tag, view a sentiments graph for the tag which displays the number of jabs and fabs on a periodic basis (e.g., each month) for the tag, see the most commonly used key words or phrases associated with the tag (as pulled from the comments section of the individual jabs and fabs), and view age and gender breakdown associated with jabs and fabs for a tag. In one aspect of the present invention, the age and gender graphs can be made available to different users according to their membership level, for example. In one embodiment of the present invention, the age gender graphs pull data from profiles containing age and gender information. The chart can also be colored, such as blue for boys and pink for girls, for example.

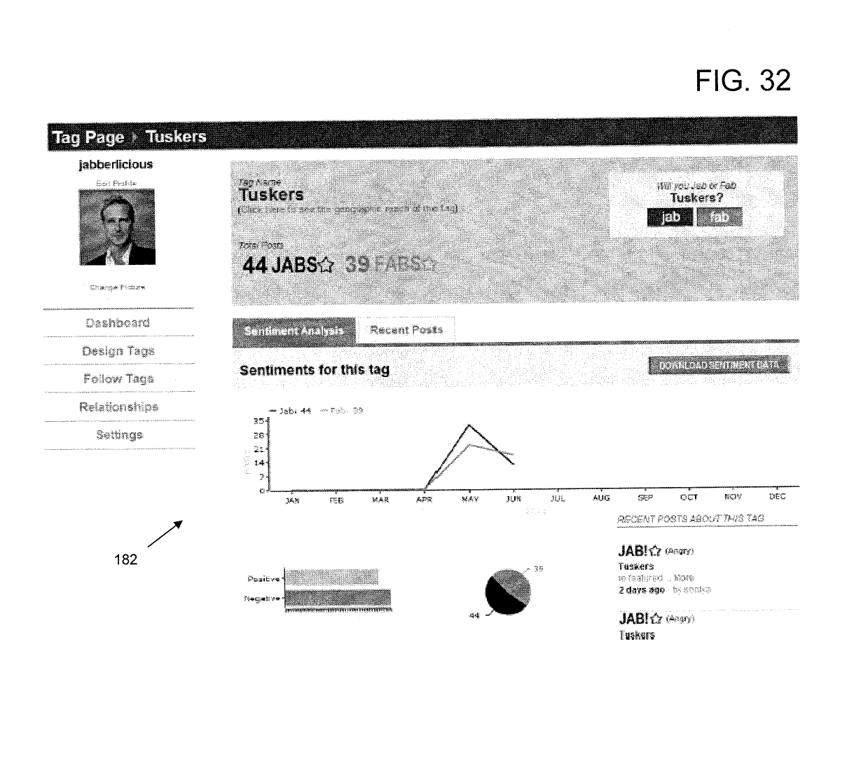

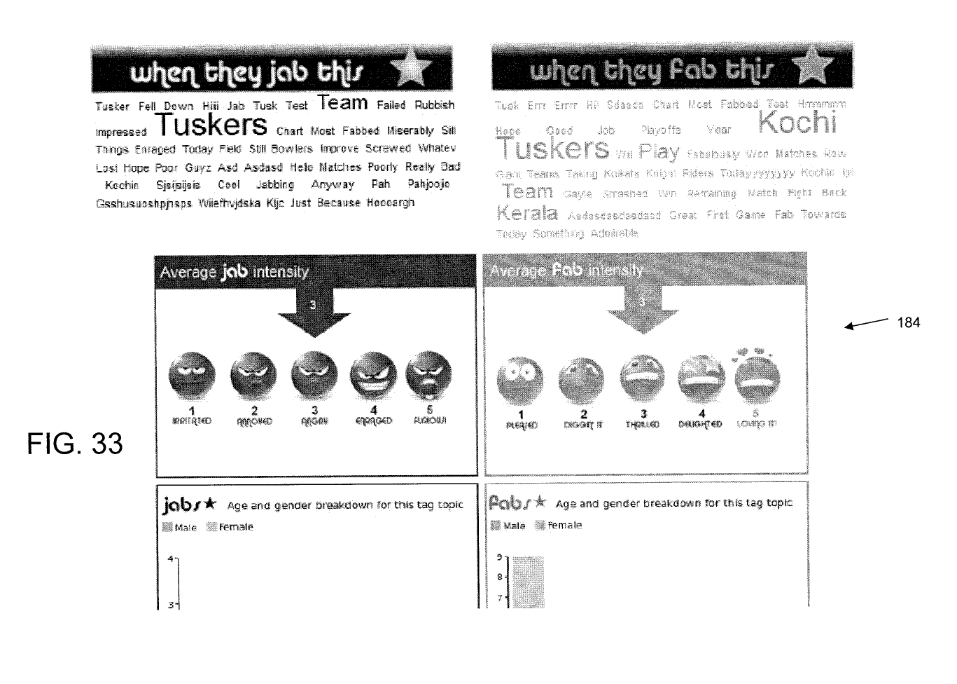

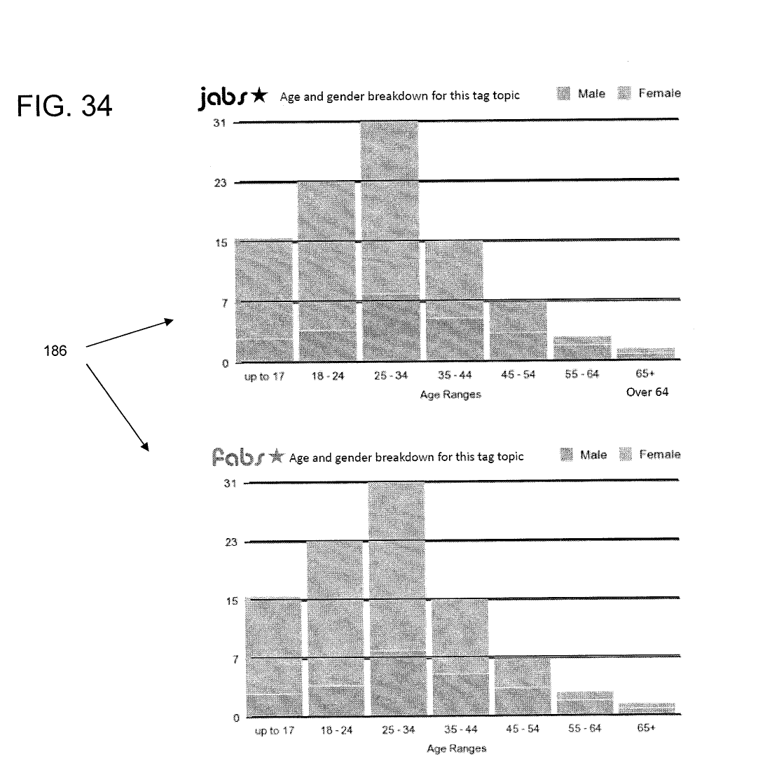

An exemplary interface for viewing jabs and fabs about a topic, viewing sentiment graphs and statistics as well as recent posts and comments is shown at 182 in FIG. 32. An exemplary interface for viewing average jab intensity for a topic is shown at 184 in FIG. 33. Exemplary interfaces for viewing age and gender breakdown for positive and negative sentiments for a topic is shown at 186 in FIG. 34. Users can switch the tags they are following at any time; however, the present invention can limit switching depending upon the level of the user's membership in one embodiment of the present invention. Further, the data for a followed tag can date back to all historic posts on that tag topic, in one embodiment of the present invention.

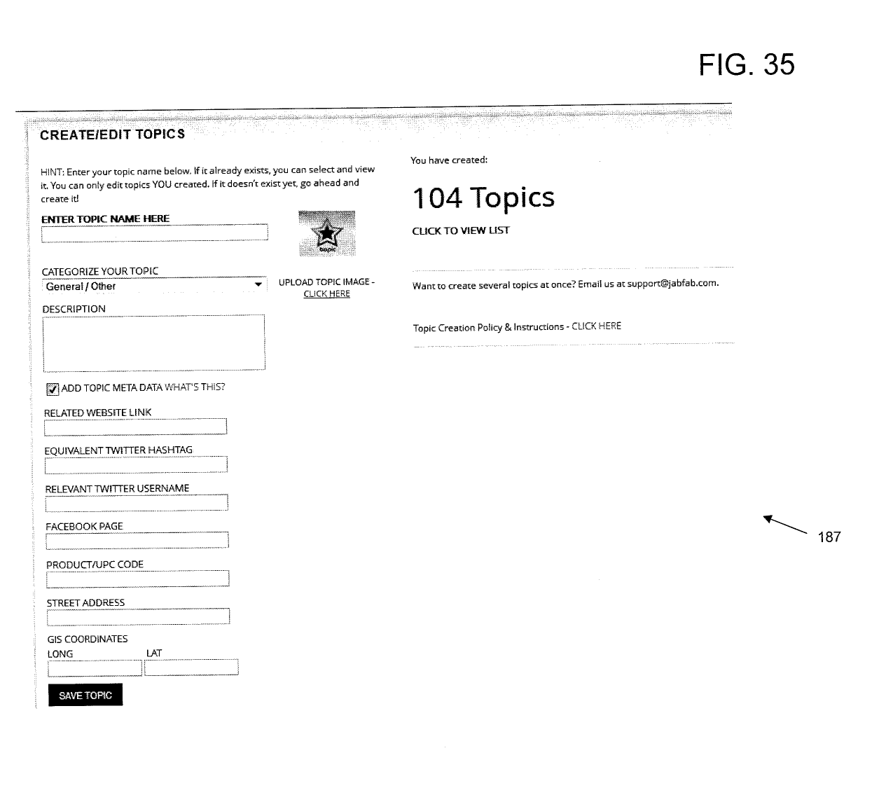

As described above and further shown in FIG. 35, a user is not only able to jab and/or fab about any topic they can imagine (including, but not limited to topics created by other contributing users), but the user can also associate a primary category with the topic, such as by using a drop down list as shown in exemplary interface 187. The present invention can permit a single topic/tag to belong to multiple categories, although it is not mandatory that a topic belong to any categories at all. Categorization of topics can affect how the topic is viewed. For example, the “top 100” jabs and fabs may be sorted by category and time period in one embodiment of the present invention. Examples of categories include, but are not limited to: Animals & Pets; Apps, Games & Technology; Art, Books & Literature; Bars & Clubs; Concerts; Business & Finance; Cars, Bikes & Vehicles; Causes & Activism; Education & Careers; Health & Fitness; Hobbies, Crafts & DIY; Hotels & Airlines; Humor & Comedy; Life & Relationships; Lifestyle; Home & Garden; Music; Movies & TV; News & Politics; Parenting, Kids & Family; People, Celebs & Showbiz; Places, Travel & Tourism; Products & Brands; Religion & Philosophy; Restaurants, Food & Drink; Retail & Shopping; Sports; Style, Fashion & Beauty; Weather; Website & Blogs; Weird & Wonderful; General/Other; etc. The default value can be, for example, “In All Categories.” Users can search for topics within a category and contribute sentiment data for a selected topic. Beyond categories, superlative lists such as a top 100 jabs and fabs can also be filtered by time using the system of the present invention. For example, a user can search the top 100 jabbed tags over the last month, or the user can search the top 100 jabbed tags over all time. In another embodiment, the present invention uses crowd sourcing techniques to have the community add categorization to the tags or enrich the tags with more information, such as multi-media information and Internet links, for example.

In one embodiment of the present invention, sentiment content from at least one contributing user can be collected and categorized into a topic based on the geo-location of the contributing user. As discussed herein, the geo-location of a contributing user can be determined using a GPS system on a mobile device or an IP address associated with a computer, for example. The geo-location can be automatically determined by the computer or mobile communications device (MCD), or the geo-location can be determined by querying the contributing user(s). Aggregated sentiment content can be categorized into a topic based on the geo-location of contributing users. In addition, the aggregated sentiment content can be categorized into one or more sub-topics based upon input from at least one contributing user. For example, if the lead topic is Wolf Trap Farm Park in Vienna, Va., a known entertainment venue, the sub-topic might be “music,” “wild crowd scene,” “food,” or anything associated with the venue at that time. In one embodiment, the system of the present invention can create a new topic that compares the aggregated sentiment content associated with one of the one or more sub-topics with a second set of aggregated sentiment content associated with a similar sub-topic, wherein the second set of aggregated sentiment content is determined to be associated with a geo-location that is different from the determined geo-location of the first contributing user(s). For example, the system of the present invention can set up contests for “best band,” “worst suit,” “best hair,” etc. on a worldwide basis.

Specifically with regard to contests, the system of the present invention can generate or initiate contests on its own, or can be prompted by a user to initiate a contest. For instance, if a user wishes to initiate a contest for best concert within a twenty-four hour period, the user can request that the system of the present invention create a topic for the contest, and users of the system can generate “contestants” similar to the way in which a topic is initially created. Once generated, the contest can receive sentiment content for each contestant in the same way that a topic receives sentiment content. The contestants can be aggregated into a contest in similar fashion to how topics are aggregated into stacks. However, the present invention can provide for evaluating the results of the contest by setting time limits and establishing criteria for judging winners. It will be appreciated that contests can be time-based, geographically based and/or evaluated based on restricted users (who may be restricted by demographics or social influence score, or who may be required to exchange loyalty points in order to vote), for example. In this way, the present invention can provide for local or even worldwide contests for things such as best filet mignon, most spectacular sunset photograph, prettiest rose bush and others.

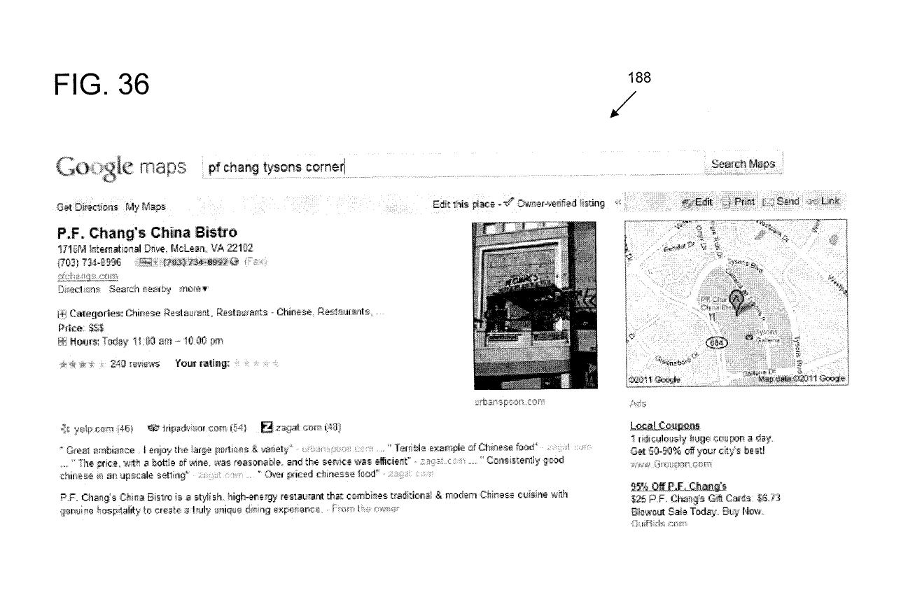

In another embodiment, businesses and brands can also create topics in order to promote different products and/or brands. For example, an “Advanced” tag creator associated with the present invention can permit the business or brand to add more metadata to a tag, such as a web address, a link to an e-commerce site or a mapping site, a related Twitter™ hashtag, a Facebook™ page, and so forth. FIG. 36 illustrates an exemplary interface 188 showing a linked mapping site page. The amount of “metadata” or additional information that can be combined with the creation of a topic can include optional fields such as location; a product code or UPC symbol; a physical address; a link to a related Facebook™ or Twitter™ page; or an image or file. This metadata enriches the topic for subsequent analysis and review by both the consumers and businesses that are following these topics. Additionally, this metadata can enable third parties, such as e-commerce websites like Amazon.com™ or Overstock.com™ to pull sentiment information from the present invention into a product description for an item sold on their website—offering consumers additional information upon which to make a purchasing decision. In another embodiment of this, a media company owning a publication such as People™ or U.S. Weekly™ might use this topic metadata to ‘tag’ a person or celebrity that appears in photographic form on their website(s) and enable a user/reader to click on that person to find out how the world feels about the individual.

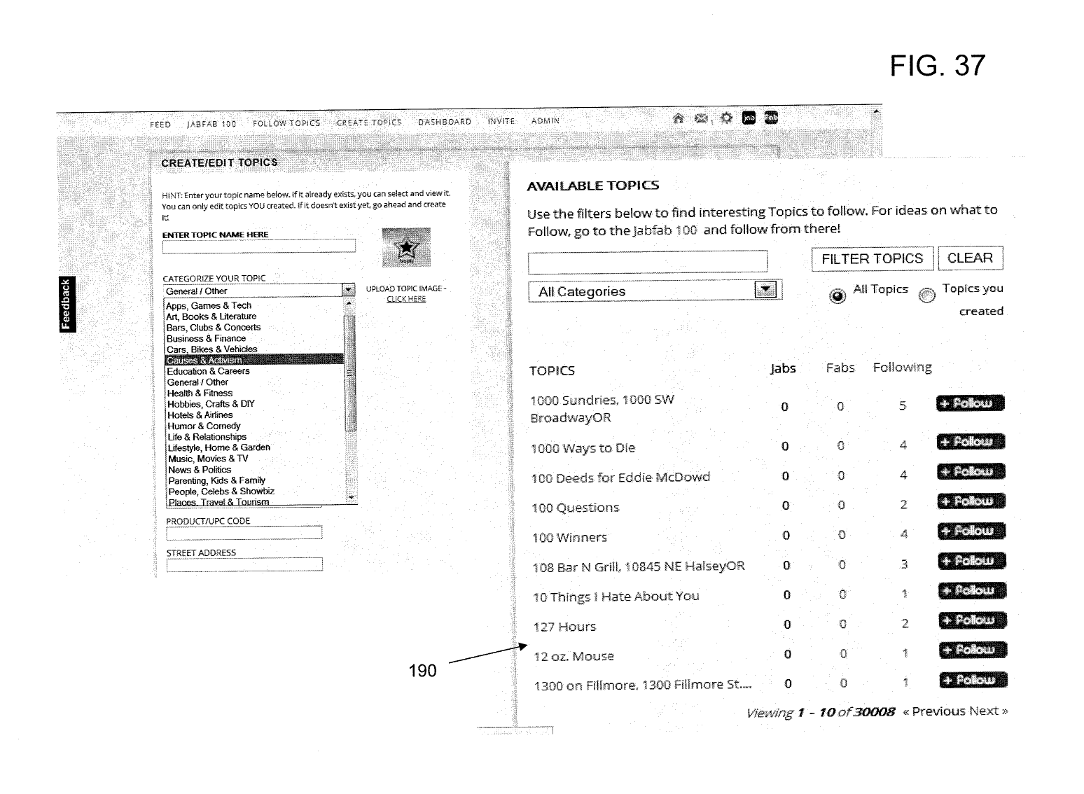

In any number of embodiments, as shown in FIG. 37, the present invention system can include a Sentiment Topic Registry 190. It will be appreciated that the registry is dynamic and ever-growing with the addition of more topics. Users can search for sentiment topics that already exist on the registry and assign new sentiment expression comments against these topics. Alternatively, users can create new topics on the registry that are unique in their own right, and assign positive and negative sentiment comments, content and metadata to these topics. The system controls uniqueness of the sentiment topic and can enable access via the Internet, mobile applications, browser, using a back end API interface, for example. Registry topics can be cached in memory for fast retrieval in a topic search. The topic registry can also be organized by category, as described above.

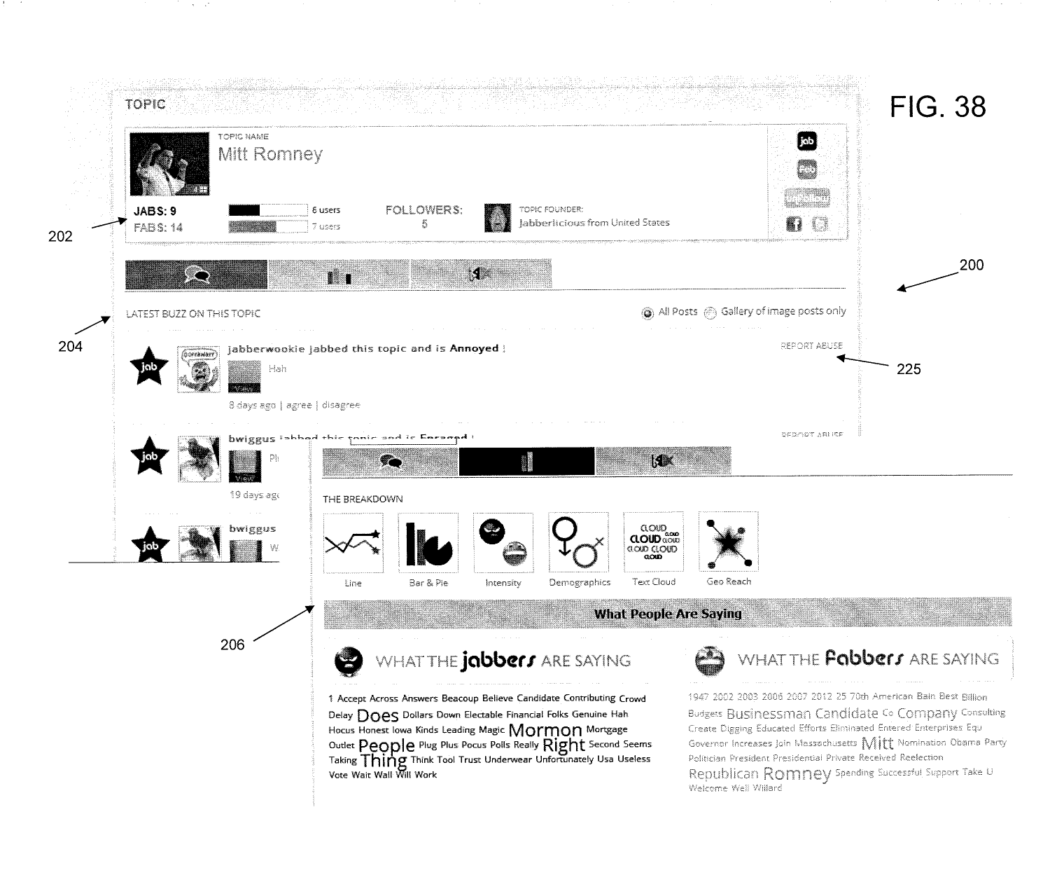

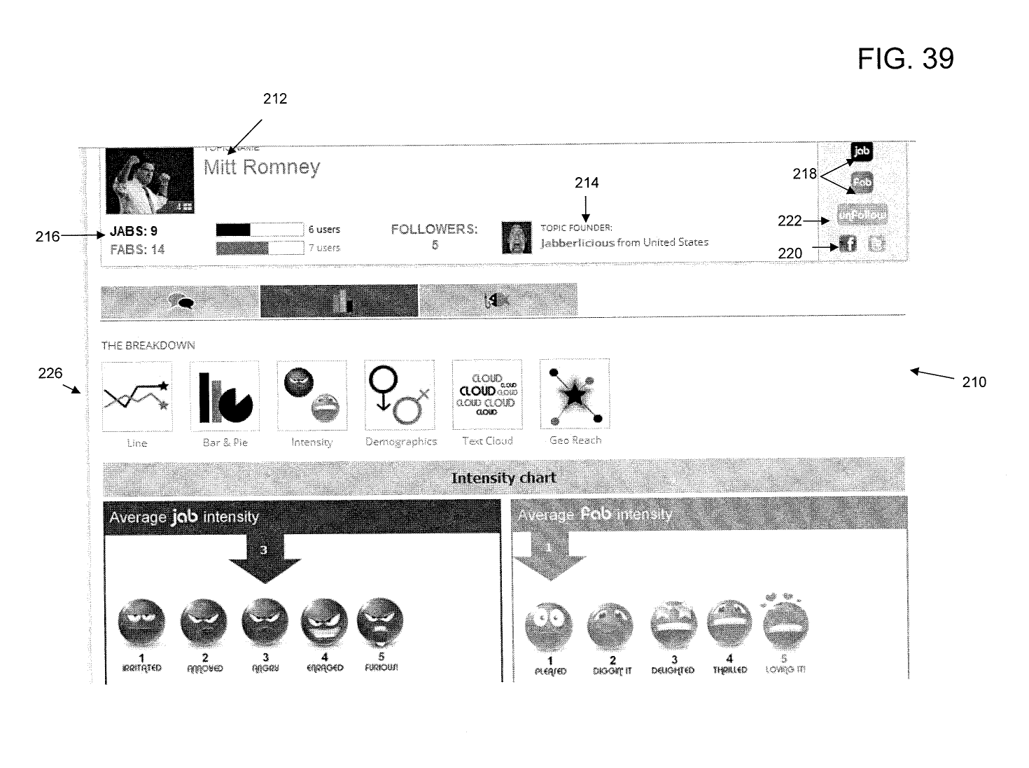

As shown in FIGS. 38-40, for example, topic pages 200 are associated with an additional feature of one embodiment of the system of the present invention. As shown in FIG. 38 for example, each tag can be provided with its own page with summary information at the top such as at 202 and then multiple tabs, such as the Latest Buzz 204 and statistical analyses 206. There can also be a tab for businesses to add a storefront or linked marketing content, described hereafter. The atomic unit is the topic that is stored in the topic registry. As shown in FIG. 39, each topic can be represented via a topic page 210, that can provide: (i) the topic name 212; (ii) topic founder or creator name, picture, etc. 214; (iii) a link to edit the topic metadata, if you are the creator or founder of the topic, for example; (iv) the current count of jabs or fabs the topic has received 216; (v) the ability to jab or fab the topic 218; (vi) the ability to share the topic via Facebook™, Twitter™ or any other social network that allows open posting from third party sites 220; (vii) a way to follow or un-follow the topic, so that it can be added or removed to a collection or list of topics that a given user is following 222; (viii) an area where all of the comments received (“The Buzz”) are stored on the topic and the users who commented, their comments, web site links associated with the topic or comments, videos, pictures or images/photos (see element 204 in FIG. 38); (ix) the ability to report a comment or topic as abusive and have it reviewed for removal (see element 225 in FIG. 38); (x) an automatic removal process that is triggered when the topic name or the topic comments contain offensive imagery or text that has been reported as abusive several times; (xi) an area 226 where the basic sentiment analysis of what the Jabfab™ community is saying about the topic can be presented, including, but not limited to, line or bar graphs of the sentiments collected over time and by category, pie charts of same, a global map of all the topic locations or users locations when jabbed or fabbed; (xii) a section 228 (in FIG. 40) where the user's unique physical QR code, barcodes and similar codes are presented as discussed elsewhere herein, which can be made accessible through a click on tab 230 in FIG. 40; (xiii) a section 232 where additional information offers, deals, interaction with the topic subject can occur in the form of chat/messaging, and other additional information that can be presented about this topic; (xix) the ability to automatically remove or disable topics or comments that are deemed to be offensive, or not meet terms of use rules/policies (e.g. copyrighted, materials, pornography, etc.) associated with the present invention.

In one embodiment of the present invention, the sentiment network includes a social listening aspect (also referred to as “Jabfab™ Listen” aspect). It will be appreciated that there can be several levels of Jabfab™ Listen associated with the present invention: “Listen 100”; “Listen 500”; “Listen 1 k”; “Listen 5 k”; and “Listen VIP”, for example. Depending upon rules employed with the system of the present invention, every user or a subset of users (e.g., users who sign up for an account) can be provided with a dashboard such as that described above and shown in the relevant figures, for example. In one embodiment of the present invention, a business rule can be employed such that, without first converting to a Jabfab™ Listen account, a user who has signed up for a user account can be provided with a small number of free tags/topics that they can follow, although the user will not necessarily be entitled to any advance downloads and other promotions. If a user wants to receive additional benefits of the system of the present invention, including additional tags to follow, then the user can upgrade his or her account to a social listening subscription. This upgrade can be purchased, for example, with traditional currency or exchanged for accrued Kudos points which are described below. The user can input the billing frequency and the term of subscription when signing up, for example.

As noted above, through the present invention, businesses (also referred to as a “tracking user”) can monitor how customers feel about their products, services, competitors and the world around them. Unlike traditional social media, the present invention provides structured sentiment feedback that can be used to grow profits and customer loyalty. Obtaining a social listening account using the present invention enables the user to, for example, download the raw data feed of sentiments from topic postings indicating the type of post, demographic data, location, time/date, and so forth.

Consistent with this ability, the system of the present invention can provide for a user to set an alert, exception and/or notification message that is triggered by the sharing of a sentiment. This functionality can be operable through the Sentiment Monitoring Strategy Component of FIG. 1 described elsewhere herein, for example, and can enable a number of use cases. For example, a service provider can set an alert on a topic that pertains to their business. If any user jabs or fabs that topic, then the service provider can be made aware by electronic messaging, and the settings allow for notifications to be set as instant, hourly, daily, weekly, monthly. When sharing alerts that are instant, the user who is following the topic and has set the alert can get a single instant message or e-mail, for example. When following over a period of time, the system can roll up the sentiment posts for that given topic into a usable table/spreadsheet or flat file of all of the comments and/or posts made against the topic that has been set for alert.

Any number of embodiments of the present invention can further include the ability to initiate a tracking user activity. For example, a tracking user can provide commercial offers such as recommendations, deals, incentives and other value added services based upon a personalized tracking of the user's negative or positive sentiments already expressed and at least one tracking variable. Commercial offers can be in a real-world and/or electronic format. Tracking variables can include, but are not limited to, geo-location of a tracking user, geo-location of a contributing user, contributing user status, a social influence score of the contributing user (defined in more detail below), demographic information of a contributing user, an image received from a contributing user, etc. Every sentiment is tracked when shared/expressed through the service and stored. The sentiments are matched up to and aligned with other related topics. For example, a user may have jabbed the iPad™ on several occasions, and so the system can search for and present offers, content, information and other things of interest to the user because they jabbed the iPad™. Alternatively, a user may have fabbed the iPad™ on several occasions, and so the system can search for and present offers, content, information and other things of interest to the user because they fabbed the iPad™. For this example, the present invention can include advertisements for competing products (e.g., Samsung Galaxy™ tab or Amazon Kindle Fire™) or present interesting information, such as articles or other sentiment topics presented by other users that are interesting based upon the sentiment expressed. In another example, a contributing user can jab a restaurant and attach a photo of an unappetizing meal. The tracking user (here the restaurant) can take action based on the negative sentiment feedback and image received. The contributing user can adjust the settings for this feature, decline to use it and decide how it will be presented to them via the service offerings associated with the present invention—e.g. emails, alerts, push notifications, content on the website associated with the present invention, etc. In one embodiment of the present invention, the commercial offer is stored and automatically presented to a contributing user upon receiving a negative and/or positive sentiment associated with the selected one or more topics. In one embodiment of the present invention, the presentation to the user can include a mapping of partner content and offers to the user's jab and fab expressions, based upon an interest map developed in association with third party partners, for example.

It will be appreciated that tracking user activities can comprise a variety of actions depending upon the desires of the tracking user and the willingness to participate by the potential sentiment contributor, who may become a recipient of some action instituted by the tracking user. Users can further request tracking user responses based upon specific user needs. For instance, a user can seek a recommendation for a local dining location or local children's play area using the system of the present invention, and a tracking user activity can comprise providing a recommendation for a suitable location destination or commercial provider. A tracking user activity can further comprise displaying a value-based offer to the user, such as a coupon, group purchasing deal or other financial incentive. Such tracking user activities can be pre-stored by a tracking user, prior to the system of the present invention receiving any sentiment content and/or requests from users. Further, pre-stored tracking user activities can be set to activate and/or initiate upon the receipt of specific structured sentiments. For example, if a restaurant acts as a tracking user and wishes to offer free dessert to anyone expressing a negative sentiment with high intensity, the restaurant can establish rules in the system of the present invention to automatically generate a free dessert offer and deliver it to the user who expresses such a sentiment. Alternatively, tracking user activities can be generated in real-time by tracking users. Tracking user variables can influence whether a tracking user takes any action. For example, a tracking user variable can be a user's geo-location, a user's social influence score, the existence or receipt of non-textual content (e.g., a still image, video image/series), or content associated with the tracking user (e.g., the tracking user's Internet web site address, the tracking user's physical address). By way of extending the above example, if a restaurant tracks that the system of the present invention has received a negative sentiment content from a user, it may not elect to deliver a free dessert offer unless the user has a social influence score above a certain level (pre-defined or not).

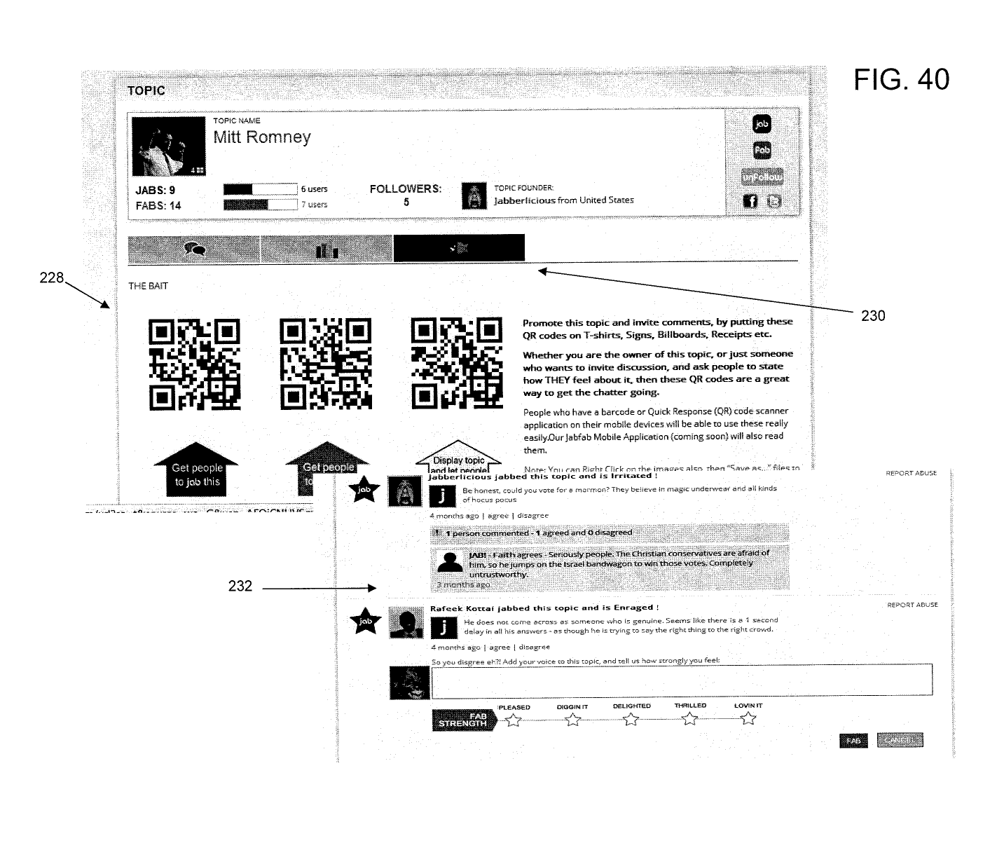

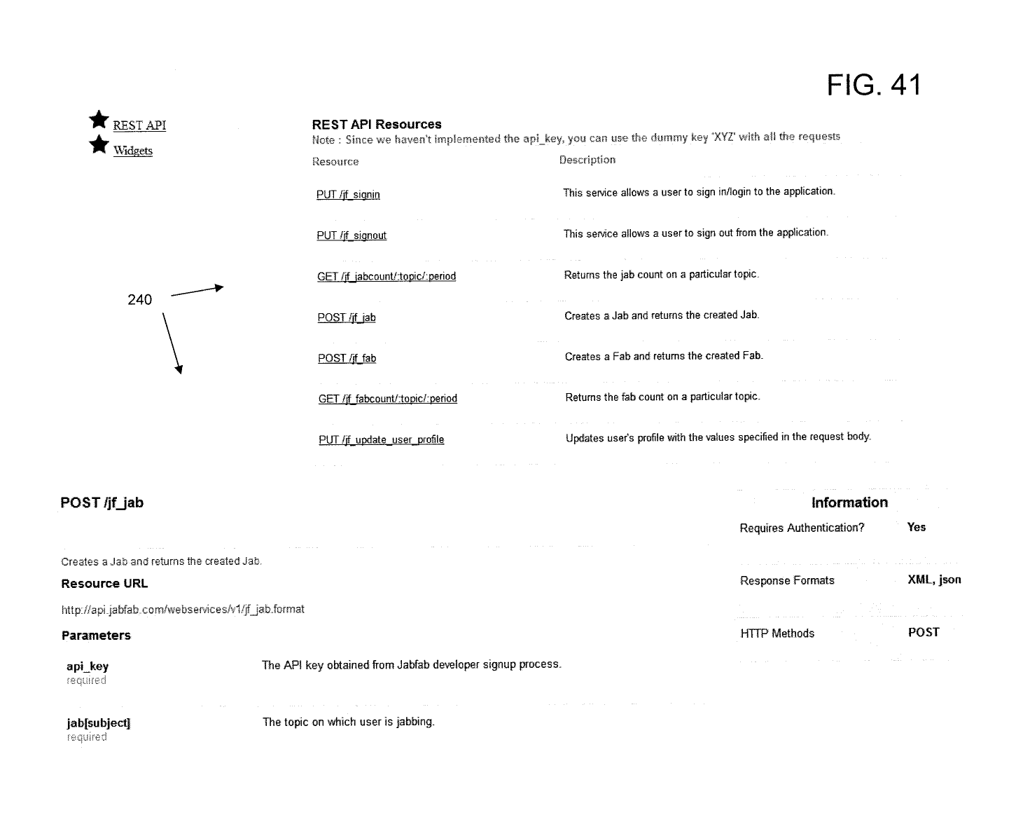

The system of the present invention can include one or more application programming interfaces (APIs) for delivering services associated with the present invention to third parties, mobile applications, and application developers. For example, a developer grade API allows the exchange of topics and sentiments about the topics via external systems and devices. The API receives sentiment posts and comments from third party sites, mobile devices, etc. In addition, the API, when called by third party devices or applications, returns sentiment counts, topic names, results, and so forth consistent with the present disclosure. Interface 240 as illustrated in FIG. 41, for example, shows an exemplary interface for invoking APIs in accordance with one embodiment of the present invention.

Location based assignment of topics for sentiment collection can be provided in any number of embodiments of the present invention. The system of the present invention is capable of geo-locating a user who creates a new sentiment topic and/or geo-locating a user who shares sentiment data with an existing sentiment topic, using methods as described elsewhere herein. The geo-location associated with a contributing user can also be stored. When sentiment topics are captured via the system of the present invention, the system can assign location-based metadata to them, either from a mobile device that has GPS and can assign longitude and latitude metadata, or based upon the IP address of the user's computer on the network, and approximated location. Not only can the topics have associated location metadata, but every comment made as users express sentiments about these topics is capable of carrying location data, so that the valuable aggregation of location, topic name, context, comments and user demographic and profile information can be combined.

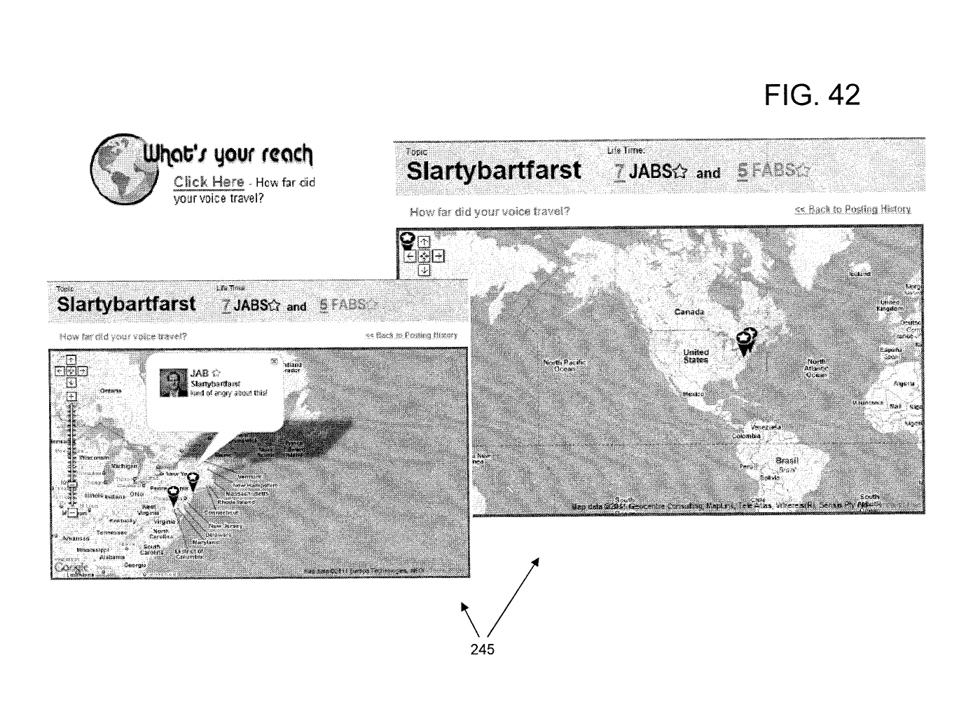

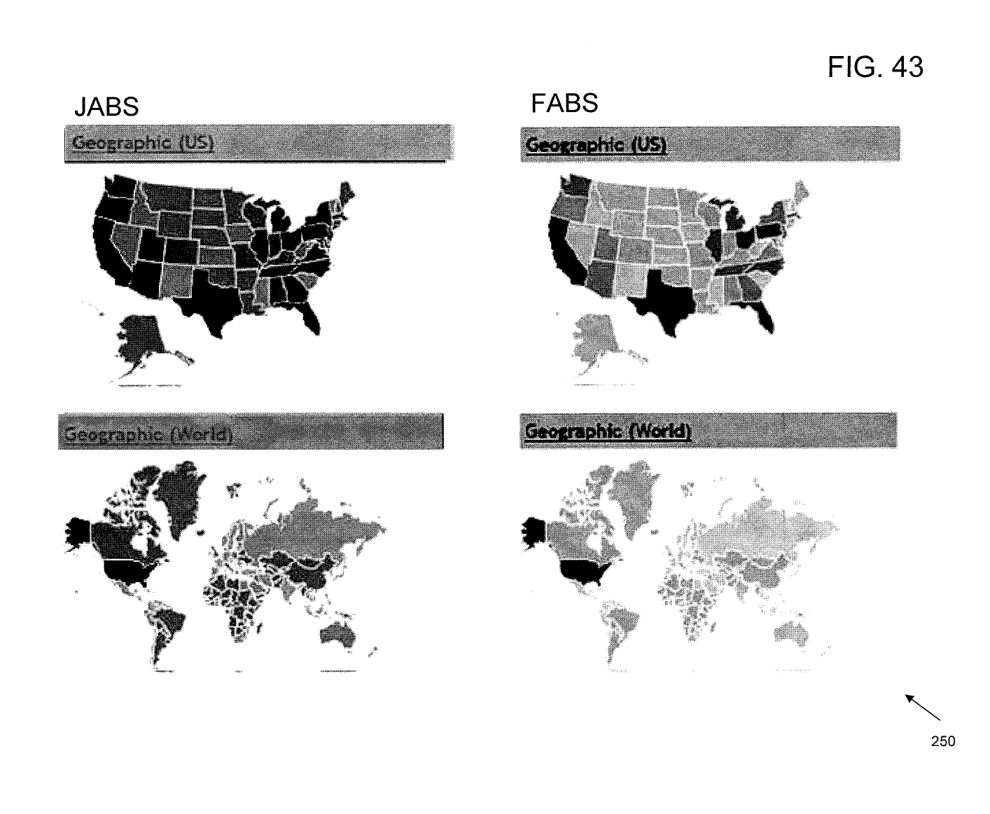

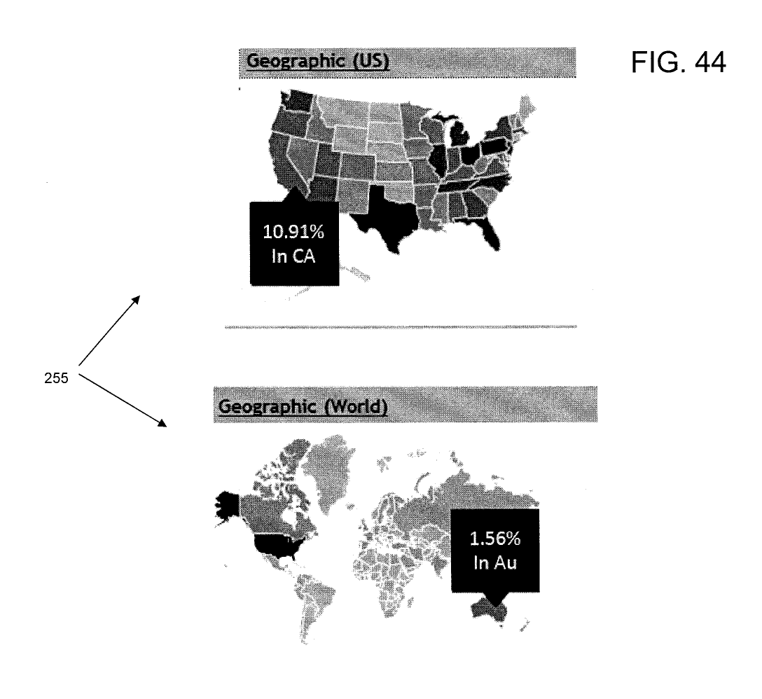

In one embodiment, the present invention can be enhanced with geographical data analysis, such as by connecting to any of the freely available online map services such as Google™ Maps or OpenStreetMap™, for example. As shown by interfaces 245 in FIG. 42, the present invention can use a detailed map to plot sentiment posts with drop pins and then allow users to interact with the pins to access sentiment information by user and geographic location. Users can then see how far the sentiments attached to one or more of their tagged items have “traveled,” or “echoed,” or even how different geographic locations feel about a certain tag. As shown in FIGS. 43-44, additional macro software programs associated with the system of the present invention can create images of maps (250 in FIGS. 43 and 255 in FIG. 44) where the color of shade of the geographic region (e.g., state, country) gets darker with the number of jabs or fabs, or create color coded “heat maps”, for example. Furthermore, the maps can optionally show only jabs, only fabs, or both jabs and fabs combined. By “mousing over” or similarly interfacing with the map, for example, a user can see more detailed information about the percentage of total jabs/fabs coming from that state or geographic location.

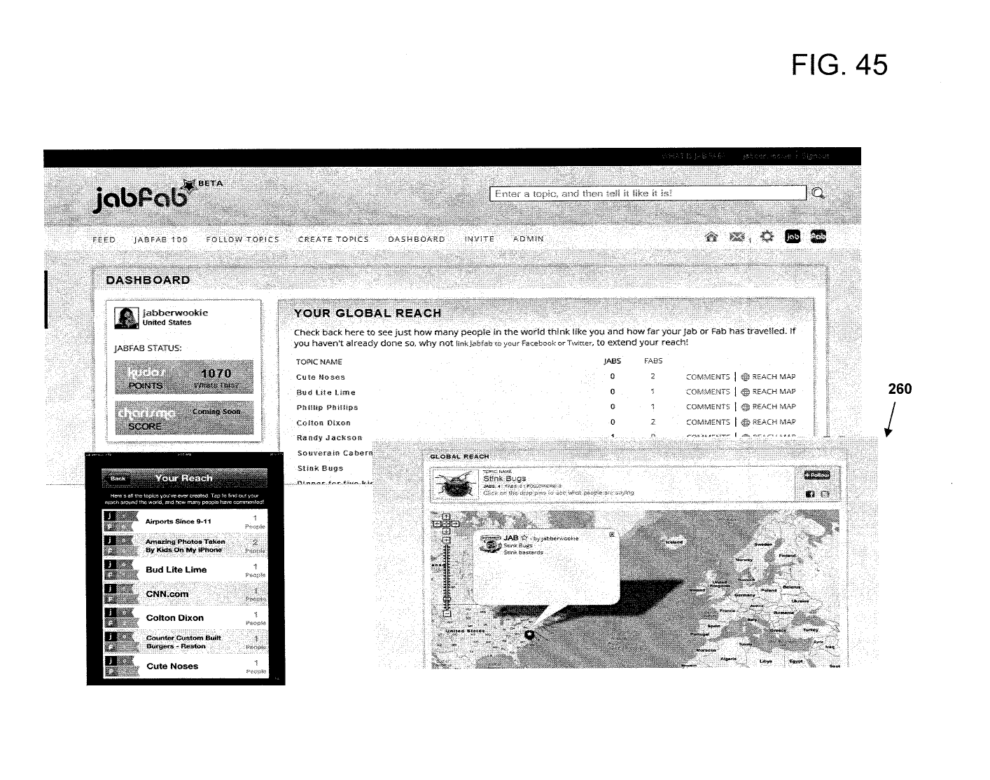

As shown in FIG. 45, for example, the system of the present invention is capable of generating a location-based map of the “social reach” of every individual user. This can be referred to as a reach map 260. The Reach Map and listings can show the topics and comments made by the user, their global geographic reach, who else has commented and is linked to the sentiment topic they started, or participated in dialog about. The user can browse a geographical map of their reach and be able to move around the map, and can further view all of the comments that have been spawned from their own sentiments expressed via the system of the present invention.

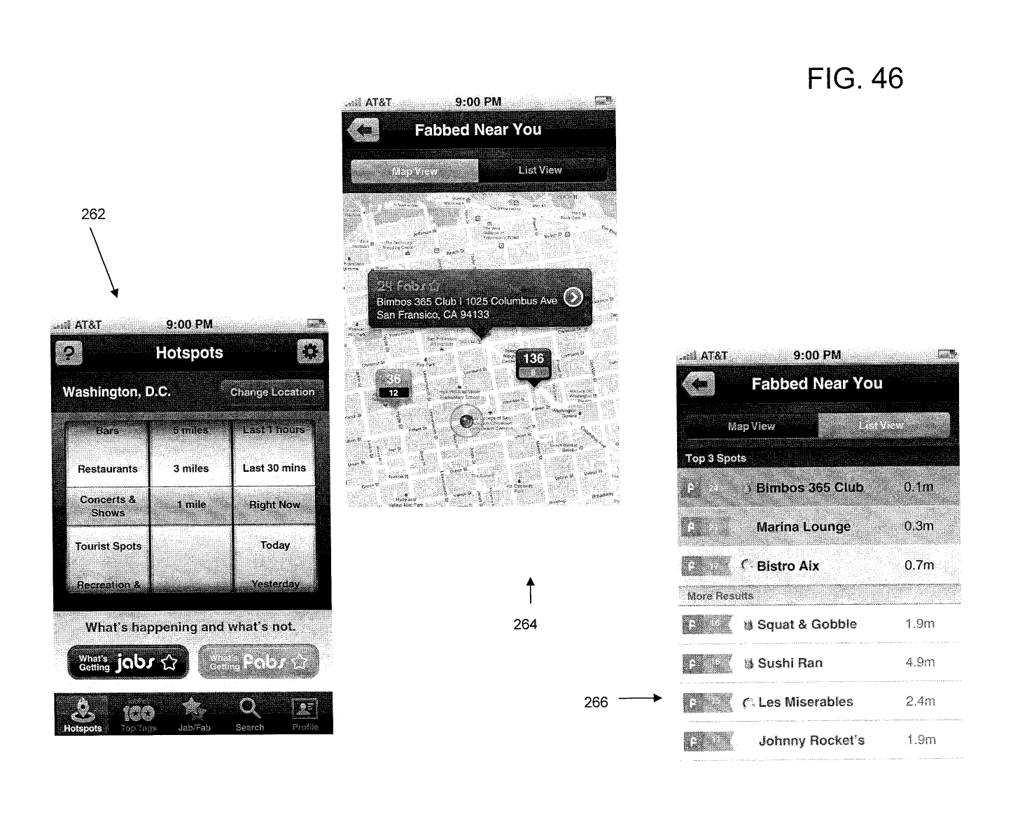

In any number of embodiments, the system of the present invention can provide for a “hotspots” location-based sentiment discovery service 262 and assignment of location based data to sentiment topics and comments 264, 266 features, as illustrated in FIG. 46, for example. This feature can enable a user to find out the most jabbed or fabbed topics and comments made near them, by category of topic, by proximity, and over a specific time frame. The sentiment-influenced response can be based upon the geo-location of the requesting user, for example. In another embodiment, the sentiment-influenced response can be further based upon a social influence score of the contributing user. For example, a user may be in a restaurant or bar in the center of New York and may elect to look for the Bars, Clubs & Nightlife with the most Fabs in a one-mile radius around them, in the last hour. The parameters (also referred to as “tracking variables”) can include all categories associated with the present invention (“Jabfab™ categories”), location proximity (e.g., from “Unlimited” range to medium range (e.g., a fifty mile radius) to close range (e.g., a one mile radius)), and a time proximity (e.g., Right Now, Today, This week, This Month and All Time), for example. This is an example of one aspect of a location based sentiment discovery tool associated with the present invention, which can return and display information such as a map 264 or listing 266, for example, of the topics and user comments made around the given parameters, in addition to the count of Jabs (or Fabs) and a list view that enables the user to see proximity in terms of distance and the sorted order view of the most jabbed or fabbed things near the user. In one embodiment, the system of the present invention is capable of providing a contributing user with a recommendation of a commercial or travel destination, for example, based upon aggregated sentiment content associated with a topic selected by the contributing user and at least one tracking variable. It will be appreciated that a travel destination recommendation need not involve long distance travel, but can be travel to a movie, nightclub, restaurant, private gathering and similar locations, for example.

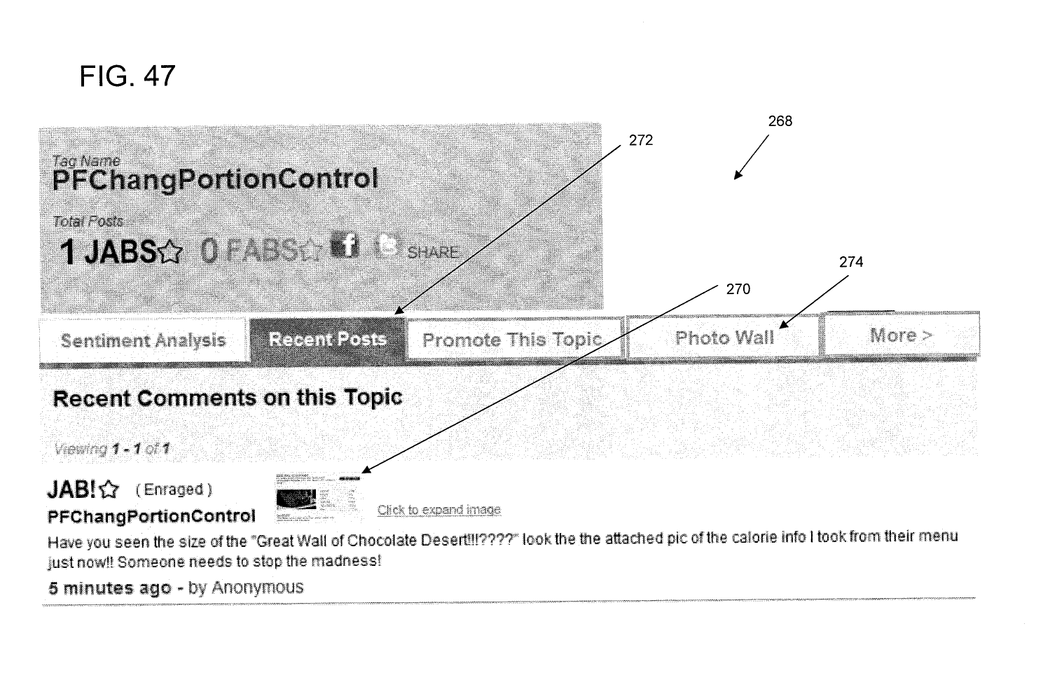

Another embodiment of the present invention enables photo sharing within posts on a website associated with the present invention. For example, a user can Jab a certain hotel's bathroom size and take a picture of the room and then post the picture on a web site associated with the present invention. A user can also express sentiment about the portion size at a restaurant and take a picture of his/her plate and then post the picture, such as shown in exemplary interface 268 in FIG. 47. The present invention can permit a user to upload image content in all known file types, including .jpeg, .jpg, .bmp, and .png file types, for example, along with video and voice multimedia options.

Security implementation can also be provided according to the present invention, with suitable terms of services and suitable technology to filter out or enable users to report any abuse. The system of the present invention also has the capability of flagging executable files that have been renamed as a picture file and preemptively blocking this threat. In one embodiment, a security team can scan pictures before allowing them to post to a website associated with the present invention.

Once a photograph has been successfully uploaded onto a page, a thumbnail 270 of the photograph can be displayed underneath the associated text as shown in FIG. 47. The thumbnail is clickable and launches the picture in full size. By only including thumbnail pictures next to the comments, the present invention thereby allows users to only view the comments associated with a tag when under the “Recent Posts” tab 272 as shown in FIG. 47. Additionally, a photo wall can be provided for a tag topic, as indicated at 274, so that users can quickly browse photographs associated with the topic. By providing two different tabs for the tag topic, users can view only the comments, or only the photos associated with a tag if they desire. If no photos are shared, the page can be blank and the top can say, for example, “No Images for This Topic Yet.”

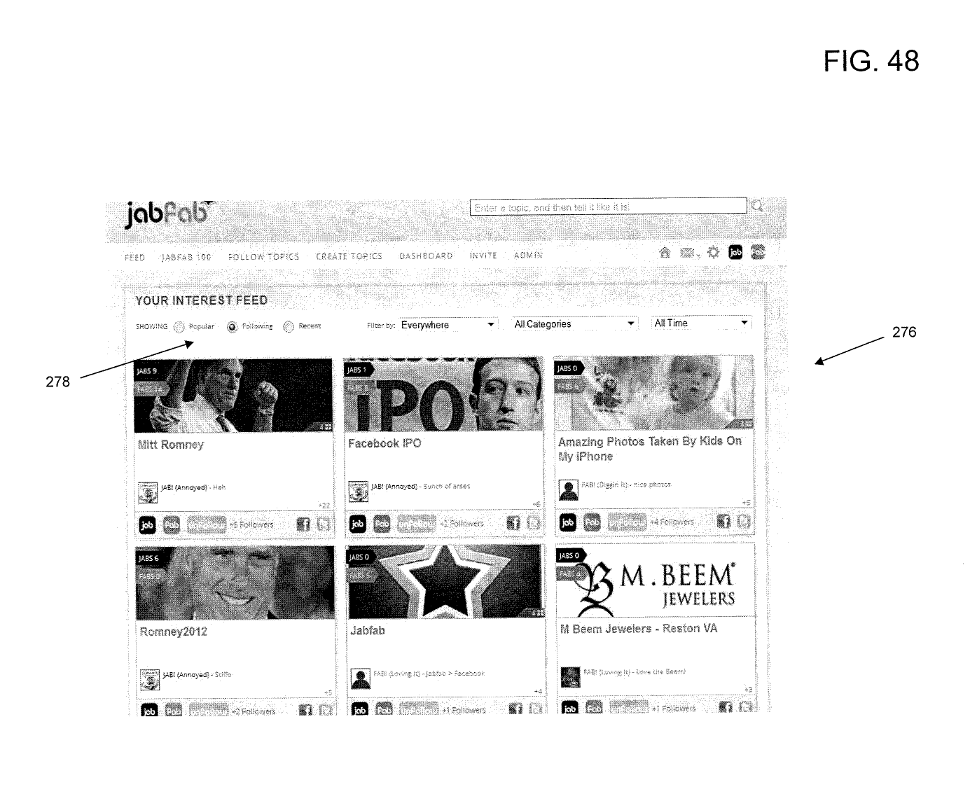

As illustrated in FIG. 48, for example, the system can include a feed/stream/river 276 of topics and a sorting mechanism for displaying and manipulating sentiments into Recent, Popular, and Followed topics. The application service of the present invention can provide, using the Sentiment Creation and Sharing Component, for example, for a user to see a stream or feed of topic information, that includes the topic photograph (if present), the statistics of how jabbed or fabbed the topic is, the count of jabs versus fabs, the ability to follow the topic, the ability to jab or fab the topic, and the ability to observe the most recent comment made about the topic, as illustrated in FIG. 48. The feed can also be made sortable by time frame (today, this week, this month, this year, all time) and by location (near me, everywhere, within 1 mile radius, up to 50 mile and unlimited radius). By way of further example, topic feeds can be viewed by users in terms of RECENT (most recent topic additions or topics with most recent comments affiliated), POPULAR topics (those with the most count of fabs ad jabs and most followed also—simple algorithm), and FOLLOWED (enabling a user to browse a multimedia feed of topics that they are following and click on the photos and be taken to the topic page where the complete sentiment analysis of the topics is presented), as indicated at 278.

In one embodiment, the tag pages found in the sentiment network are further enriched with content from related partners and open content. The present invention can further keep a related database that aligns the tag registry with Twitter™ hashtags, Google™ locations or Yelp™ locations, for example. One aspect of the present invention offers a daily featured sentiment or daily “How do you feel about . . . Topic XYZ” question posed by a user. For example, a number of topics can be provided on a daily basis for incorporation of sentiment content, and many can be associated with prizes based upon participation and possibly random or planned selection of participants. For example, the 100^{th} or 1000^{th} person to voice an opinion can win a prize. However, in one embodiment of the present invention, in order to qualify for prizes, a user must have an active user account. In one embodiment of the present invention, such featured sentiments are generated by actual users, not necessarily by companies or brands. A user can also submit a request to have a tag displayed on the “Jabfab™” home page (i.e., the primary web site page associated with the present invention) as the featured sentiment in one embodiment of the present invention. It will be appreciated that, while this feature can be provided by the present invention as a daily event, it can also be an hourly event or based upon any other time frame. In another embodiment, sponsors who want to get the public's opinion on a particular subject can generate the featured sentiments. When the sponsors participate, the sponsors can provide prizes for one or more of the users who weigh in on the tag. A countdown clock can be posted that can count down an hour or other established time limit before the sponsored topic goes live, for example.

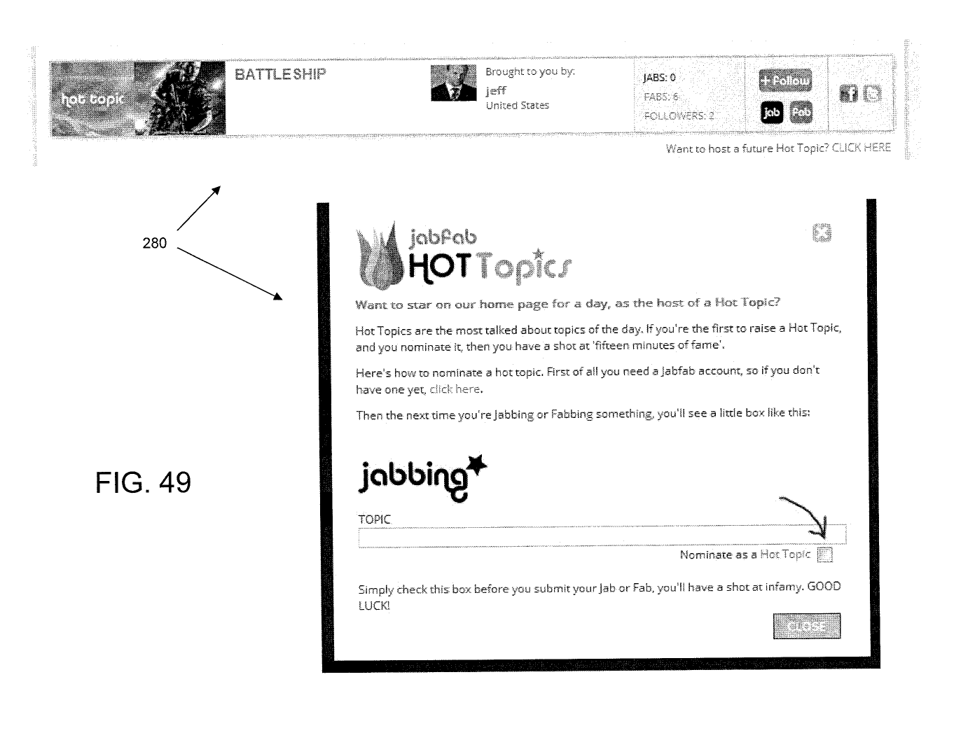

As illustrated in FIG. 49 by interfaces 280, for example, the system of the present invention can provide a “Hot Topic” feature. This feature enables users to nominate a topic as a “Hot Topic” via text entry into an accessible text box, and if there is a picture selected (due to it being a popular request, for example), displaying that picture on the site/service along with the user information of the user who nominated the Hot Topic.

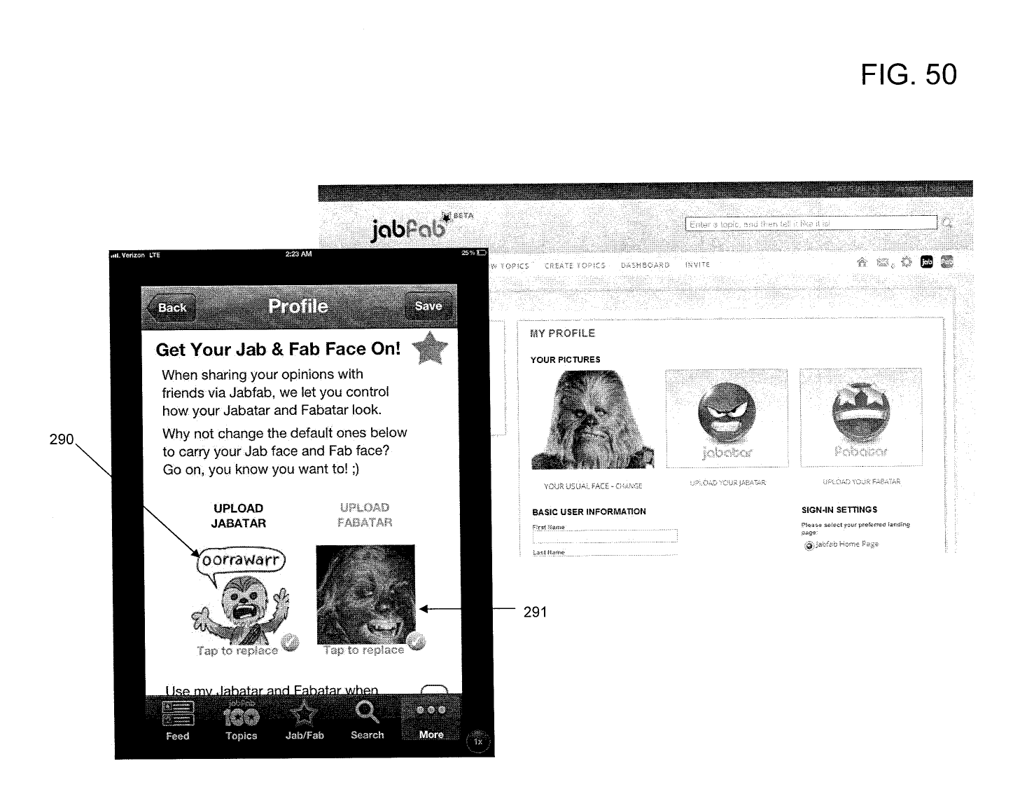

As shown in FIG. 50, any number of embodiments of the present invention can include customized avatars or profile pictures for positive and/or negative sentiments. For example, in one embodiment of the present invention, the system of the present invention provides the user with the opportunity and ability to create one or more additional profile images (e.g., pictures, photos) assigned to a user account, so that the user can convey their sentiments using a visual avatar (i.e., without using words). In one embodiment, this ability can be provided as part of the Sentiment Creation and Sharing Component of FIG. 1. In essence, a user can have a “Jab Face” or “Fab Face” indicating how unhappy or happy, positive or negative they feel. These avatars, “Jabatar” 290 and “Fabatar” 291 as exemplified in FIG. 50, are stored in the user's profile and the user can decide how and when to use them. For example, the avatars can be used within the closed loop service associated with the present invention (e.g., the “Jabfab™” web site), or when sharing sentiment topic posts via third party social networks such as on Facebook™ Wall.

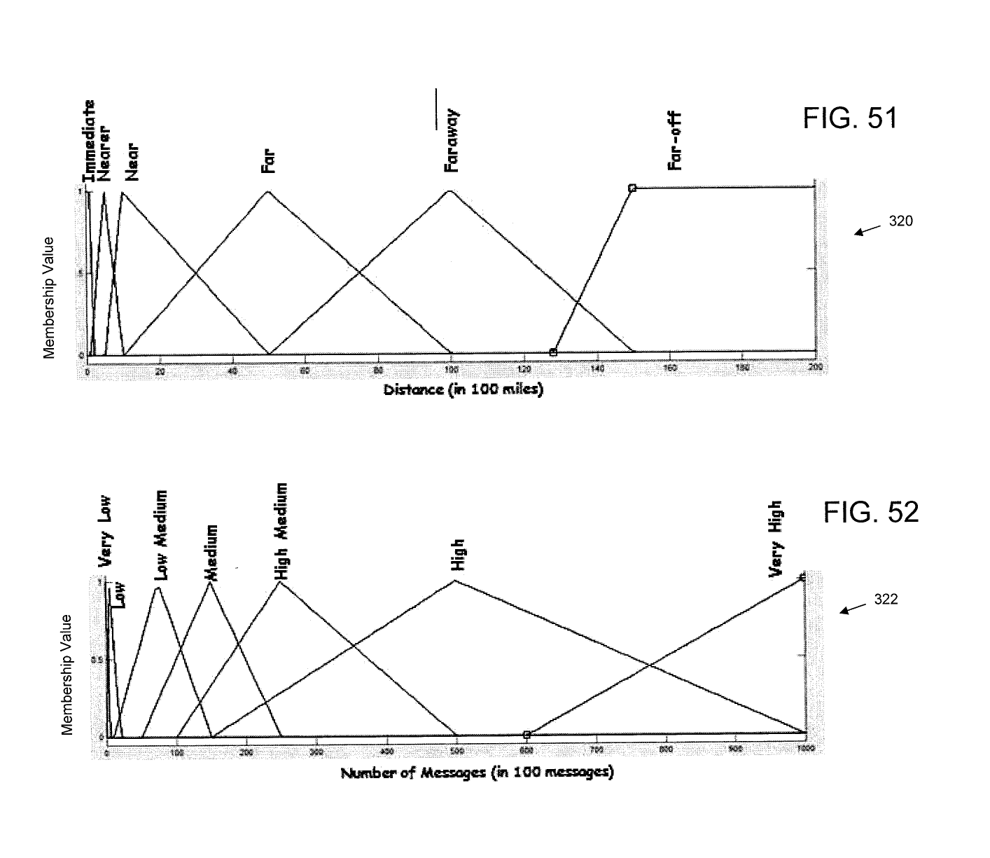

In one embodiment, the system of the present invention can further include programming as part of the Loyalty Component in FIG. 1, for example, for collecting information and deriving a social influence or “charisma” score for an individual user. The charisma score comprises a social influence algorithm and scoring feature associated with the present invention. The charisma score of the present invention can be considered in one respect as a mechanism for assigning a social influence score to an individual user. Unlike traditional methods of social influence scoring, one embodiment of the charisma score system of the present invention operates via a “closed loop” by taking input from several data points available only within the network of the present invention. The present invention is able to more accurately track the behavior of a user, the posts they make regarding sentiment topics, the people who respond, the distance travelled between the social graph points of all of the parties involved in a topic discussion, the speed/velocity of comment attraction, how many people agreed versus disagreed with the user on a comment or across a time period, and the demographic information shared, for example. By aggregating and subjecting this information to the algorithmic processes described and shown herein, the present invention can provide an accurate depiction of a user's ability to influence others through sentiment expression, social feedback and social interests. Mechanisms associated with the Loyalty Component and/or the Sentiment Analysis and Data Exhaust Capture Component, for example, also exist in association with the present invention to reduce fraud or integrity of the score, by limiting the user's ability to fake or falsely build their charisma score. For example, point policing and limits on number of jabs and fabs within a given time period are examples of mechanisms used, and these mechanisms can be implemented via software programming that monitors and tracks the given variable (e.g., points, number of jabs/fabs over time, etc.). In one embodiment of the present invention, a score range such as zero to 100 can be employed, such that a given user can be assigned a score based upon a living and continuously updated database that is dynamic and can increase, decrease or stay the same based on a user's influence over time. For example, a user interacting with the system of the present invention may receive a score of forty-five, and then have no further interaction with the system. However, because of the changing database and measures given to a user's overall charisma score, the user's score may increase or decrease without further user activity. Complex algorithms associated with the present invention, such as described below and in FIGS. 51-55, are employed to calculate scores based on user behavior and social influence over others within the closed loop community associated with the present invention (e.g., the “Jabfab™ Community”).

In one aspect, the present invention provides methods for deriving a charisma or social influence score. In one embodiment of the present invention, several measured factors are employed in calculating a charisma score. The crisp values associated with the measured factors can be fuzzified and fed to a fuzzy function associated with the present invention as inputs that assist in computing the charisma score. The charisma score can first be determined as a fuzzy value, and then converted to a crisp value after defuzzification. Defuzzification can be performed by the present invention according to various known methods, and in one embodiment of the present invention, defuzzification is accomplished by a center of gravity method or a center of gravity/weighted area method. It will be appreciated that a social influence score can be derived as system-wide, meaning it takes into consideration an entirety of a user's contributions and interaction with the system of the present invention, or the score can be derived in connection with a specific topic, a group of topics, a stack, a geographic location (pre-defined or generated in real-time), a specific time or date range.

The “spread” or total distance traveled by all of the topics originated by a user is one measured factor used in computing a charisma score in accordance with one embodiment of the present invention. For each topic, the spread is computed by calculating the distance between where the topic was created (e.g., latitude and longitude specification) and where each comment on the topic was created. The spread can be measured in miles, for example. If a user created three topics and the number of commenters on the first topic is one, the number of commenters on the second topic is three, and the number of commenters on the third topic is four, then the total spread would be the sum of eight numbers (i.e., one distance measurement for the first topic plus three distance measurements for the second topic plus four distance measurements for the third topic).

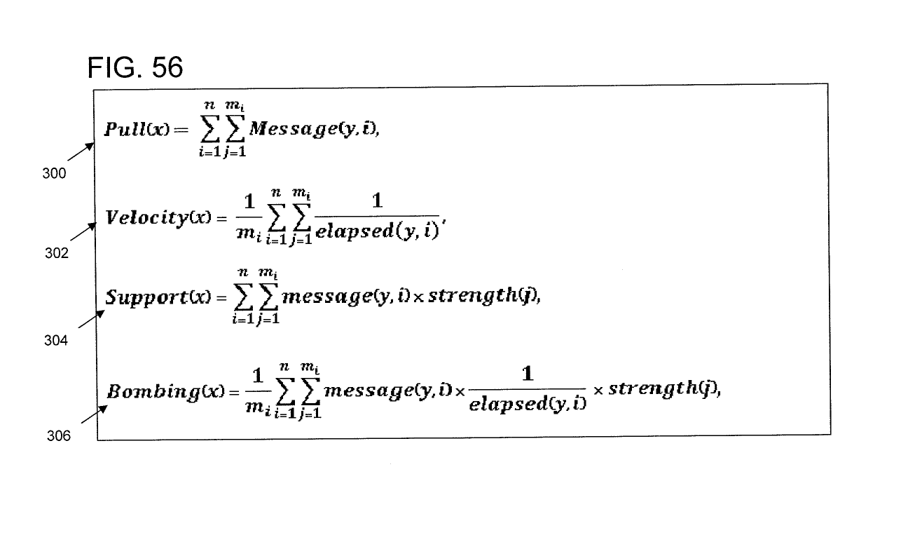

The “pull” or total number of comments received by a user's topics is another measured factor used in computing a charisma score in accordance with one embodiment of the present invention. In one embodiment of the present invention, the pull measurement can be represented by the formula shown at 300 in FIG. 56, where x is the user/topic creator, y≠x, n is the total number of topics created by user x, and mᵢ is number of comments on topic i. The Message(y,i) function returns a Boolean value of 1 or 0. If the identified user for this function is not user x, then the function returns a value of 1. If the identified user for this function is user x, then the function returns a value of 0. As such, this function does not count responses to other user comments from the topic originator, and thereby avoids artificially inflating the pull score simply because the topic originator continues to contribute to a discussion surrounding one or more topics. In one embodiment of the present invention, the pull measurement is calculated as an average pull number, such that the total number of comments across all generated topics for a user is divided by the total number of generated topics.

The “velocity” or time interval between the time that topic i is created by a user and the time that another user comments on the topic is another measured factor used in computing a charisma score in accordance with one embodiment of the present invention. In one embodiment of the present invention, the velocity measurement can be represented by the formula shown at 302 in FIG. 56, where x is the user/topic creator, y≠x, n is the total number of topics created by user x, and mᵢ is number of comments on topic i. The elapsed(y,i) function returns a time value in minutes, in one embodiment of the present invention.

The “momentum” factor is another measured factor used in computing a charisma score in accordance with one embodiment of the present invention. In one embodiment of the present invention, the momentum measurement can be represented simply as the pull of the user multiplied by the velocity of the user, as determined above.

The “support” factor is another measured factor used in computing a charisma score in accordance with one embodiment of the present invention, and can be considered as the weighted summation of the comments on a user's topics based on the strength over every topic created by user x. In one embodiment of the present invention, the support measurement can be represented by the formula shown at 304 in FIG. 56, where x is the user/topic creator, y≠x, n is the total number of topics created by user x, mᵢ is number of comments on topic i and strength(j) is the strength of comment j. The strength (j) function returns a signed integer value, in one embodiment of the present invention. For example, in the embodiment of the present invention where there are five subcategories for a jab comment and five subcategories for a fab comment, the strength function can return a weighted value of 1, 2, 3, 4 or 5 depending upon the subcategory selected for a fab comment, and can return a weighted value of −1, −2, −3, −4 or −5 depending upon the subcategory selected for a jab comment.

The “prolificacy” factor is another measured factor used in computing a charisma score in accordance with one embodiment of the present invention. In one embodiment of the present invention, the prolificacy measurement can be represented simply by the total number of topics created by the user.

The “endurance” factor is another measured factor used in computing a charisma score in accordance with one embodiment of the present invention, and can be considered as the amount of time any topic created by user x is followed by p number of active followers against q number of followers lost during the time. In this regard, a lost follower can be considered to be any follower who has not followed back for at least any amount of time equal to or greater than a pre-established length of time. In a separate embodiment of the present invention, the endurance factor can be considered as the sum of the ratio between the total followers and lost followers, taken over all the topics created by x. For example, assume User x creates two topics, “Google tablet” and “Indian football team to lift World Cup in ten years” and a lost follower is defined as one who does not post an active comment on a topic within twenty-four hours after having previously posted at least one comment on the topic. For the first topic, there are one hundred thirty total followers and forty lost followers, wherein the lost followers are those whose most recent comment on the topic was more than twenty-four hours before the current time. The ratio of total followers to lost followers is thus 3.25 for topic one. For the second topic, assume there are 624 total followers and only six lost followers. The ratio of total followers to lost followers is thus one hundred four for topic two. The combined sum of the ratios for topics one and two is thus 107.25, which is the endurance score in this embodiment of the present invention.

The “bombing” factor is another measured factor used in computing a charisma score in accordance with one embodiment of the present invention, and can be considered as the product of velocity and support across all topics created by user x. The higher the value for this parameter, the lower the charisma score, since “bombing” connotes that the user's topic is being “bombed” or predominantly and quickly jabbed, for example, by the community at large. In one embodiment of the present invention, the support measurement can be represented by the formula shown at 306 in FIG. 56, where x is the user/topic creator, y≠x, n is the total number of topics created by user x, mᵢ is number of comments on topic i and strength(j) is the strength of comment j. The bombing function returns a number in decimal form. For example, if user x creates a topic that receives 600 total comments (pull=600), with 540 “jabs” and an average comment strength of −3, with an average elapsed time for each comment of 300 minutes, and with momentum (total comments multiplied by velocity) measured as 2.0, the bombing factor can be computed as pull multiplied by the inverse of the average elapsed time multiplied by the average strength. In this example, the bombing factor would be 600×1/300×−3=−6.

The “reputation” factor is another measured factor used in computing a charisma score in accordance with one embodiment of the present invention, and can be considered as the ratio between total followers and lost followers where the “reputations” of the followers are considered as opposed to merely their count. In this regard, if a topic-creating user is actively followed by reputed users, then the topic-creating user will have his or her reputation increase accordingly.

The “pertinence” factor is another measured factor used in computing a charisma score in accordance with one embodiment of the present invention, and can be considered to be the predicted value associated with each member of the present invention based upon past records.

In one embodiment of the present invention, a user's pertinence factor is measured as the likelihood of a new topic from the user attracting comments within a pre-defined period of time. In one embodiment of the present invention, the prediction can be based on the reputation and average momentum and support the member enjoys at a given time.

As described above, the present invention can collect information based on the use of the present invention, and can also calculate various statistics and/or performance measurements to help users see how influential they are and to keep them emotionally involved with the system of the present invention. Various combinations of the available statistics can be used to determine an evolving influence score that can reach a maximum of 100 out of 100, for example. In one embodiment of the present invention, the score is an aggregation of several parameters that can be measured and assigned automatically. Each individual statistic or measurement can represent a specified contribution towards the total score. For example, in one embodiment of the present invention, the spread value for a user is calculated and evaluated against a thirty point range, with zero points being the minimum for this factor and thirty points being the maximum. Similarly, the pull and velocity factors are calculated and evaluated against a thirty point range, and the support factor is calculated and evaluated against a ten point range. In this way, a maximum charisma score of one hundred is available and all users will have a charisma score that ranges between zero and one hundred. Further, each user's charisma score can be computed on a continuous and ongoing basis.

As a specific example of the above embodiment of the present invention, in calculating the spread, the distance is calculated from the IP address of the original topic creator and the IP address of each user who comments on the topic. If the user is using a mobile communications device (MCD), the present invention can use their GIS location data, but default to the IP address data as a “home” location if the GIS data is not available or provided. E.g. if a Topic created and posted by original user has one jab and two fabs, there are a total of three postings. The present invention does not discriminate between positive and negative sentiments, but simply calculates distance for this factor. For example, assume posting one involves an IP address that is 350 miles from the topic creator user's IP address, posting two is 6,350 miles and posting three is one hundred miles. The total distance is thus 6,800 miles.

As described above, this measurement must be calculated against the average across all postings, and against all the unique tag topics created by this user. So, if this was the only topic ever created by the user, and it has three comments, then the average distance travelled per comment=6,800/3 which equals 2,267 miles (rounded up to nearest whole number). This average is then compared against a band of scores associated with average mileage per comment. For example, Table 1 illustrates a range of scores as shown below.

TABLE 1

| Average Distance (miles) | Total Points |
|---|---|
| 0 to 100 | 5 |
| 101-500 | 10 |
| 501-1000 | 15 |
| 1001-5000 | 20 |
| 5001-15,000 | 25 |
| 15,001+ | 30 |

As an example of calculating the pull score, assume a user creates five unique topics, and that topic one receives 100,000 comments, topic two receives thirty-four comments, topic three receives 190 comments, topic four receives fifty-five comments and topic five receives one million comments. Regardless of the positive or negative sentiment, the average number of comments is calculated as 220,056 for this user (rounded up to the nearest integer). This average is then compared against a band of scores associated with average pull. For example, Table 2 illustrates a range of scores as shown below.

TABLE 2

| Average No. Comments | Total Points |
|---|---|
| 0 to 10 | 0 |
| 11-100 | 5 |
| 101-500 | 10 |
| 501-1000 | 15 |
| 1001-5000 | 20 |
| 5001-10,000 | 25 |
| 10,001+ | 30 |

The third measurement (velocity) can be computed by taking a time date stamp of the user's first posting of the topic, which is not necessarily when the topic is created, but when the topic is first used in a jab or fab, and calculating the elapsed time before the total number of comments (jab or fab) hits 1000. Then, the average velocity of each of the user's comments is used to calculate an average time to reach 1000 comments. This average is then compared against a band of scores associated with average pull. For example, Table 3 illustrates a range of scores as shown below.

TABLE 3

| Average Time (hours) | Total Points |
|---|---|
| Never | 0 |
| 250+ | 0 |
| 100-250 | 5 |
| 60-100 | 10 |
| 48-60 | 15 |
| 24-48 | 20 |
| 12-24 | 25 |
| 0-12 | 30 |

Support is the fourth measurement used in the above embodiment of the present invention's charisma score calculation. In one embodiment, for each topic created by a user, the present invention calculates the ratio of favorable comments (e.g., fabs) to unfavorable comments (e.g., jabs), and then averages the ratios across the entirety of topics created by the user to determine a score for this measurement. As noted above, the support factor can be measured according to a ten point scale in one embodiment of the present invention.

Assuming a user has created three unique topics in their life, and that Topic 1 received 100 comments−seventy-five favorable/agreeing comments (fabs) and twenty-five unfavorable/disagreeing comments (jabs). Topic 2 received 10,000 jabs and 90,000 fabs and Topic 3 received 900,000 jabs and 100,000 fabs. In this example, the user would have 75% agreement for Topic 1, 90% agreement for Topic 2 and 10% agreement for Topic 3. The average of these percentages is 58% (rounded to the nearest integer). Since the averages will fall between 0 and 100% agreement, the present invention can simply convert the 58% in this example to a 5.8 score for purposes of the support factor contribution to the overall charisma score. It will be appreciated that the 5.8 score can be rounded up or down depending upon the desired approach, as long as the final charisma score for any user does not exceed one hundred or any other maximum score established for the present invention.

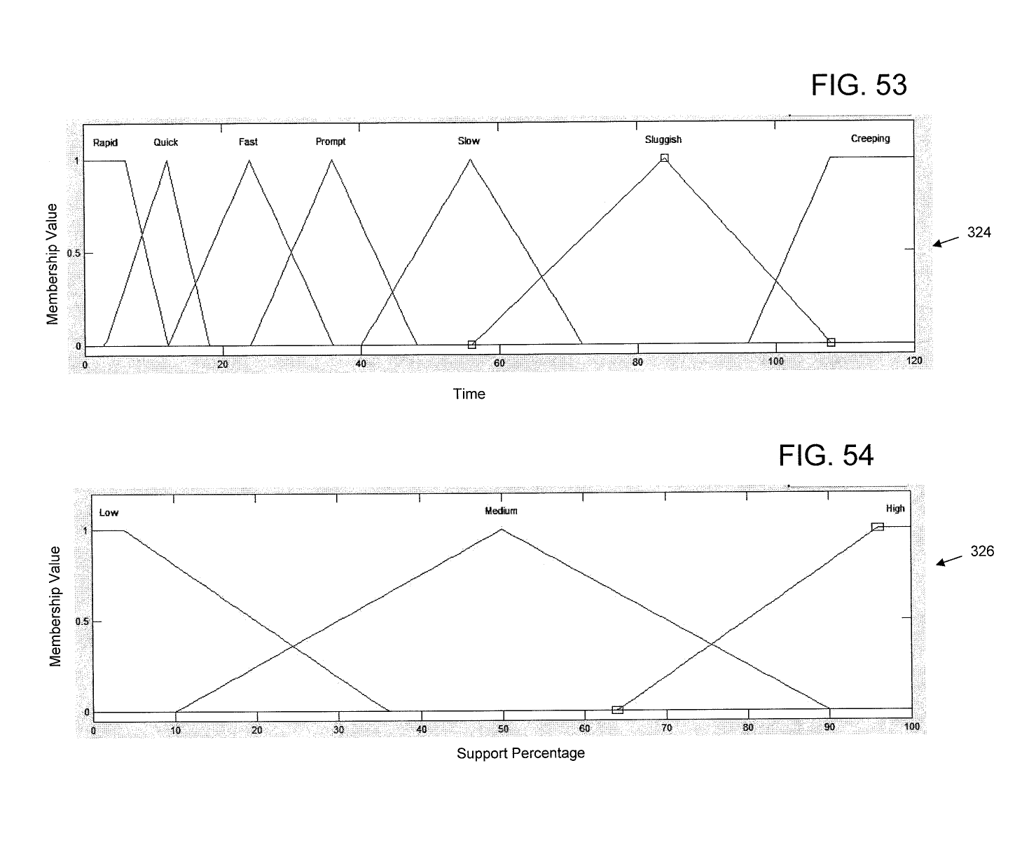

In one embodiment of the present invention, the charisma score can be determined by a set of fuzzy rules. In this embodiment, values can be obtained for the variables as described above, and these values can be converted into fuzzy values based upon variable-specific membership functions. As can be seen in FIGS. 51-54, the membership functions establish a range of memberships for different fuzzy values for the spread, pull, velocity and support parameters. For example, in FIG. 51, the spread membership function 320 shows that a raw distance value for the spread variable of 10,000 miles would have a fuzzy value of “faraway”. In the pull membership function 322 of FIG. 52, a pull value of 25,000 messages would yield a fuzzy pull value of “High Medium.” In the velocity membership function 324 of FIG. 53, a time of 20 hours to reach 1,000 users would yield a fuzzy velocity value of “Fast” and in the support membership function 326 of FIG. 54, a support value of fifty percent would yield a fuzzy support value of “Medium.” By evaluating the fuzzy values of the parameters under consideration, the present invention can determine a charisma score for a user according to rules associated with a rule set.

The following rules are examples of rules that can be used by the system of the present invention. These rules are exemplary and not exhaustive, and it will be appreciated that the rules can be changed and updated as needed. A sample rule given as follows: If Spread is Near and Momentum is High and Support is Medium, then Charisma is High. This rule says that a quick and rich propagation of the topic with a good support from the respondents, though echoed only locally, leads to a high charisma score. With the following rule, it can be seen that the farther geographic reach for a given user, the higher the charisma score: If Spread is Medium and Momentum is High and Support is Medium, then Charisma is Very High.

Other example rules: (1) If Momentum is High and Endurance is High, then Charisma is Very High. This rule defines that fast, rich and sustaining topics result in a very high charisma score. (2) If Reputation is High and Bombing is Low, then Pertinence is Very High. This rule implies that a topic initiator who is able to retain most of the followers—aggregated over all the topics initiated by the person so far—and whose topics are generally found acceptable (coherent with the general sentiments), is entitled to acquire a very high value of pertinence. (3) If Pertinence is High and Prolificacy is Medium High, then Charisma is Very High. Chained to the previous rule above, this rule indicates that a high level of pertinence added with a prolific (Jabfab topic) authorship leads to a very high charisma score.

It will be appreciated that the present invention can incorporate individual rules such as the above example rules for every permutation of statistics and fuzzy measurements, or can incorporate interpretations and/or membership functions that effectively combine multiple individual rules into a single rule. For example, the second-to-last example rule above says “If Reputation is High and Bombing is Low, then Pertinence is Very High.” One embodiment of the invention can operate so as to interpret “If Reputation is High” as meaning “If Reputation is Greater than or Equal to High”, in a linguistically measured sense. As such, the present invention would not necessarily need to incorporate two separate rules (one for “Reputation is High” and one for “Reputation is Very High”) in combination with the “Bombing is Low” condition exemplified in the second-to-last rule above. As a further example, if the measured value of Reputation gets mapped to a region in the defined membership function for High that carries the membership value, for example, between 0.7 and 1.0, and if the membership function is a “bell shaped” function, then the mapped values would be expected to be somewhere in the mid region of the function graph (e.g., where the curve peaks).

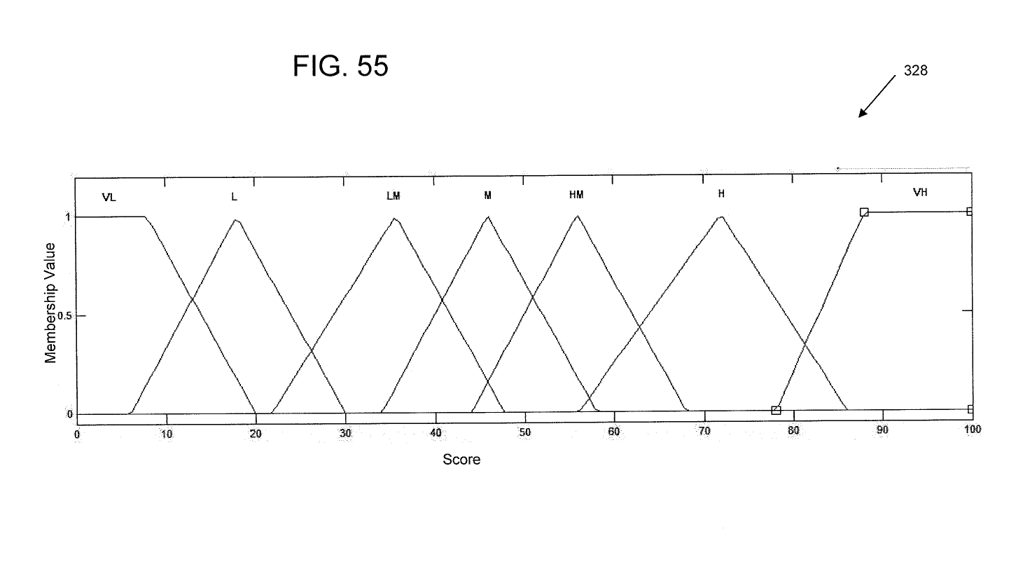

The charisma score function can be plotted as shown in the membership function 328 of FIG. 55. As shown therein, a user's score has a membership based upon the rule set employed for any given embodiment of the invention. If, for example, the user's charisma score is determined to be High, then the actual numerical score depends upon the membership function and the method of defuzzification employed. In one embodiment of the present invention, defuzzification can be accomplished through a center of gravity or weighted center of gravity approach. Once the user has a numerical charisma score, he or she can view this score through the system of the present invention, such as on a website using a browser, for example. In one embodiment of the present invention, charisma scores are continually updated to accommodate for the fluid nature of topic creation and comment creation by many simultaneous users.

In an embodiment of the system of the present invention, a user's social influence or charisma score can be used to define individuals for specific tasks. The system of the present invention can “crowdsource” by aggregating sentiment content from at least two contributing users in connection with one or more topics; calculating social influence ratings for the at least two contributing users; receiving a request from a requester for a crowdsourcing task; and based upon the social influence ratings, assigning the crowdsourcing task to at least one of the at least two contributing users. For example, the crowdsourcing task can be a competition, whereby users participate in the determination of a winner such as best hamburger, best clothing store, best sports blog, etc. As a further example, the crowdsourcing task can be a survey, such as what factors influence participating users when buying shoes, or whether participating users might be confused as to the source of a product when evaluating different trademarks, for example. The step of calculating social influence ratings can include calculating social influence ratings pertaining to a specific topic or group of topics. Social influence ratings can also be calculated for a specific time, date or geographic location. The method for crowdsourcing can further include the step of re-calculating the social influence ratings on a periodic basis. In an embodiment, the step of receiving a request for a crowdsourcing task can be limited to a specific topic or group of topics. In another embodiment, the step of receiving a request includes receiving a designation of at least one contributing user to be included in the assignment of the crowdsourcing task, and including the further step of assigning the crowdsourcing task to the designated at least one contributing user. This allows the requester to partially control who is assigned or not assigned to a task. A requester can also designate a specific contributing user who is not to be included in the assignment of the crowdsourcing task, such that the designated user is restricted from being assigned to the crowdsourcing task, regardless of whether the system of the present invention would have assigned the crowdsourcing task to the specific user had the specific user not been a designated restricted user.

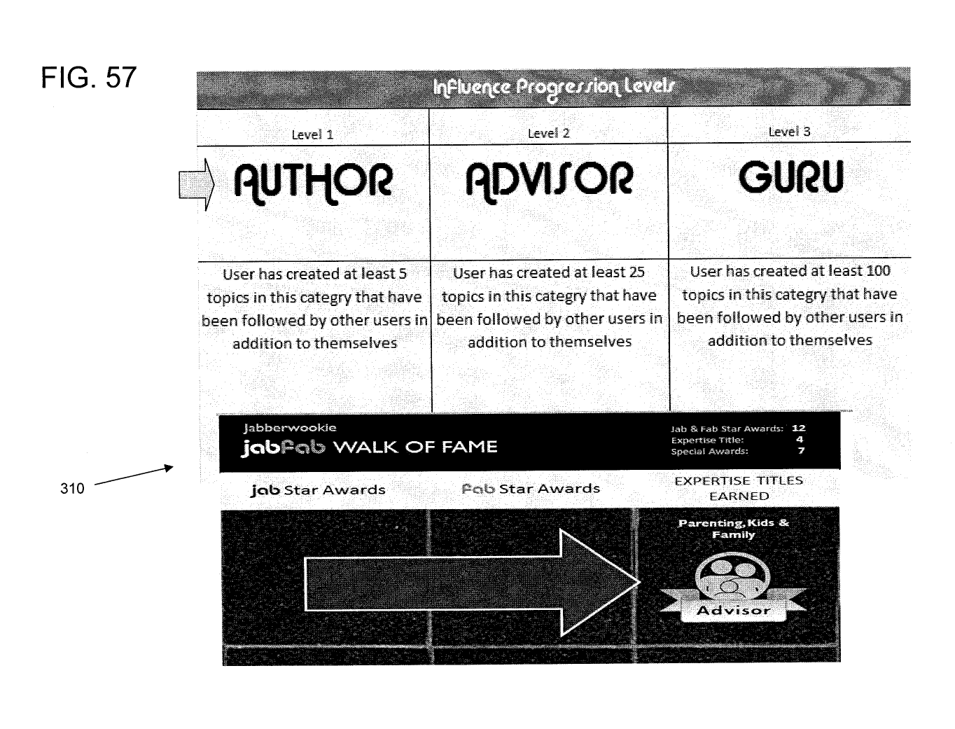

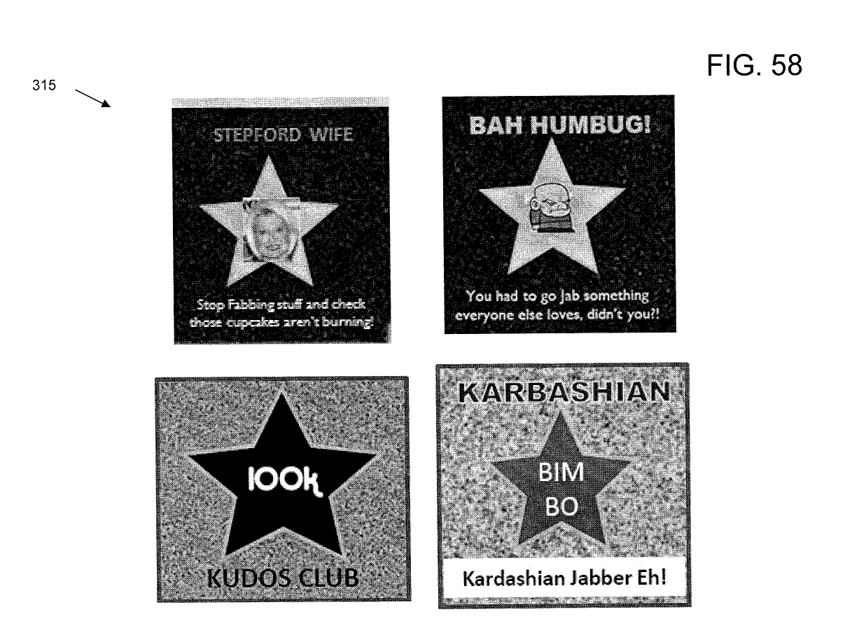

Any number of embodiments of the system of the present invention can further include a sentiment scoring methodology and presentation for achievements and influence recognition. Such a system can be called or associated with a Jabfab™ Walk of Fame or Wall of Fame, as illustrated at 310 in FIG. 57, for example. As illustrated in FIGS. 57-60, for example, the present invention provides a method to create consistent and repeated engagement of system users through the use of an awards and achievement system, and this can be provided using the Loyalty Component of the present invention. For example, the user can earn or unveil titles, stars (315 in FIG. 58) or other rankings or indicia by performing certain sentiment feedback tasks or self-expression. For example, if a user jabs or fabs certain topics, he/she can earn a star or other award after a given period, pattern or topic type. A combination of jabbing and fabbing certain topics can also result in an award. Awards can also be sponsored by a third party marketing affiliate and earned according to a mutually beneficial marketing arrangement, benefitting the user. Some examples of awards that can be unveiled include, but are not limited to: (i) the Occupy star, achieved by jabbing certain topics, such as “Wall St Greed” and “Money in Politics”; or (ii) the Kardashian Star 233, earned for fabbing all of the topics that discuss the celebrity Kim Kardashian; or (iii) the Bah Humbug Star 234, earned for people who jab more than they fab, or disagree more than they agree, for example. The gamification of the sentiment expression service of the present invention engages the user and increases the frequency and repeated use of the system of the present invention, enhancing its overall appeal as a marketing system to businesses.

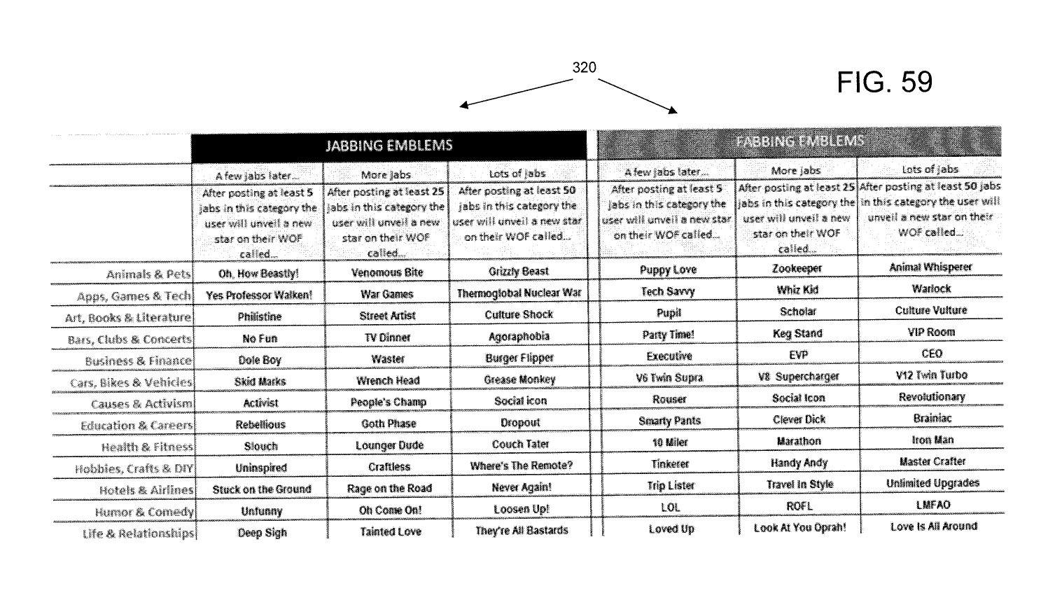

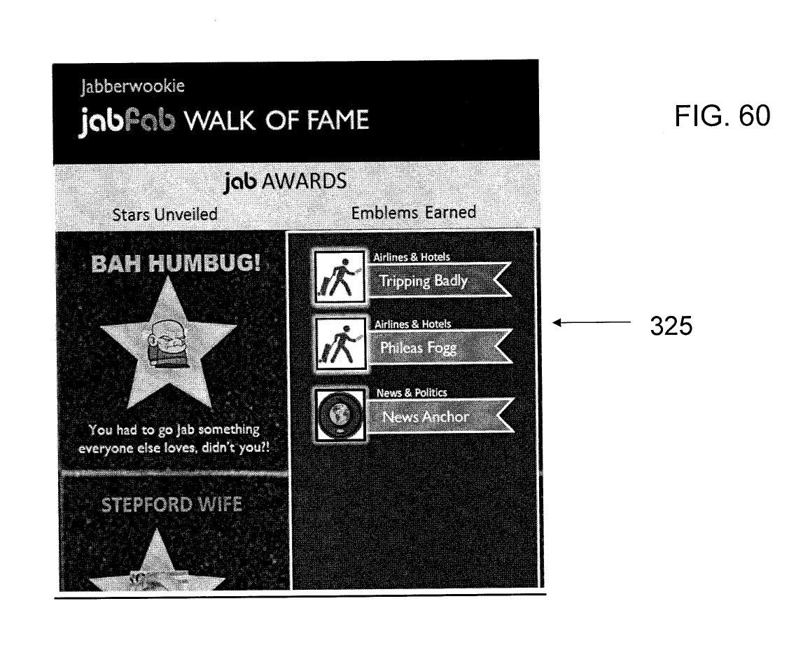

Similarly, the Loyalty Component of the present invention can provide for awards such as ribbons or emblems (e.g., 320 in FIGS. 59 and 325 in FIG. 60) to be earned by users who have been known to jab or fab topics that fall under certain categories. These computer-generated icons can represent a social influence rating for a contributing user, wherein the social influence rating is derived or calculated from a series of statistical measurements associated with sentiment content. A computer can apply a respective scale to each of the series of statistical measurements and then determine a non-numerical evaluation of each measurement according to its respective scale. Each respective scale can be represented by a fuzzy logic membership function. In an embodiment, the non-numerical evaluation can be determined by a fuzzy logic membership function and one or more fuzzy rules. In another embodiment, the non-numerical evaluation can be converted to a numerical score through defuzzification. The user (e.g., over time) can garner a reputation and build a “track record” in jabbing or fabbing particular topics more than others (i.e., the user has chosen specialized topic areas through past sentiment expression). The application of the present invention recognizes this history through the collection of information such as jabs and fabs, and tracks the areas of expertise or influence the user has in a particular topic category of sentiment. As such, the user can then become more and more known for prolifically posting topic sentiments about these categories. In this case, the series of statistical measurements can be based on the sentiment content from the contributing user and are not based on external content. Also, the user can be awarded status, or progress through a maturity cycle of a topic category (e.g., advisor, authority and expert) by calculating how many topics they have created within a given category and the influence they carry due to the number of people who are following the topics they have created. As such, this can elevate the user's status and stature for recognition by others using the system of the present invention. In one embodiment, various titles such as category ‘captain’ can be assigned or earned. The system of the present invention can further include resulting status, awards and achievements displayed in the user's profile as a list or as a graphic depiction similar to the Hollywood walk of fame—as stars on a walk, for example.

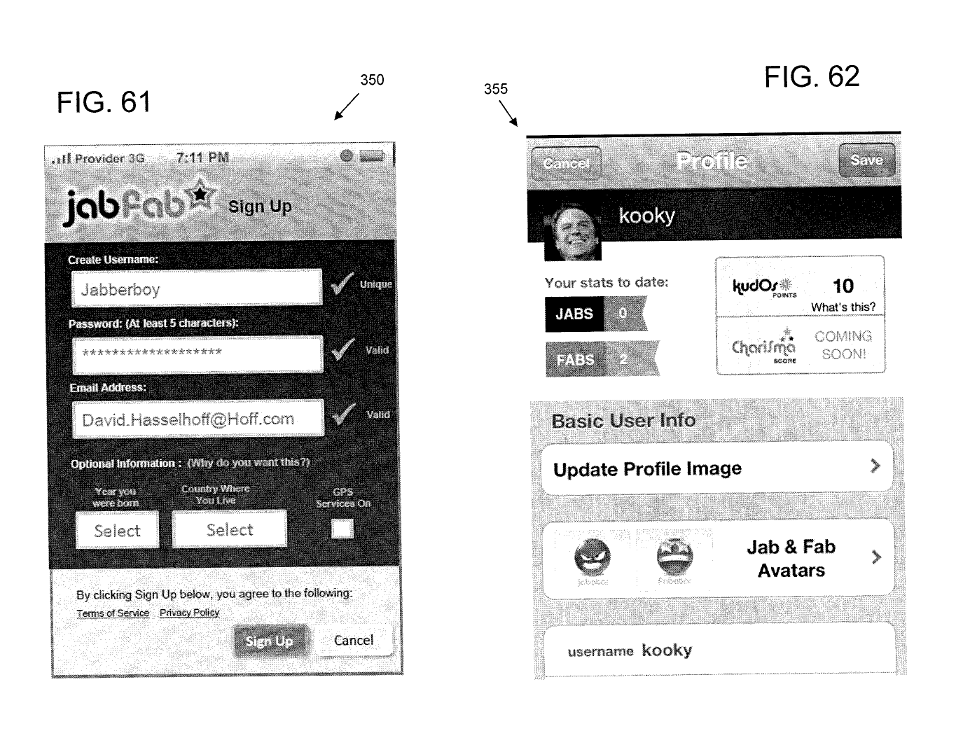

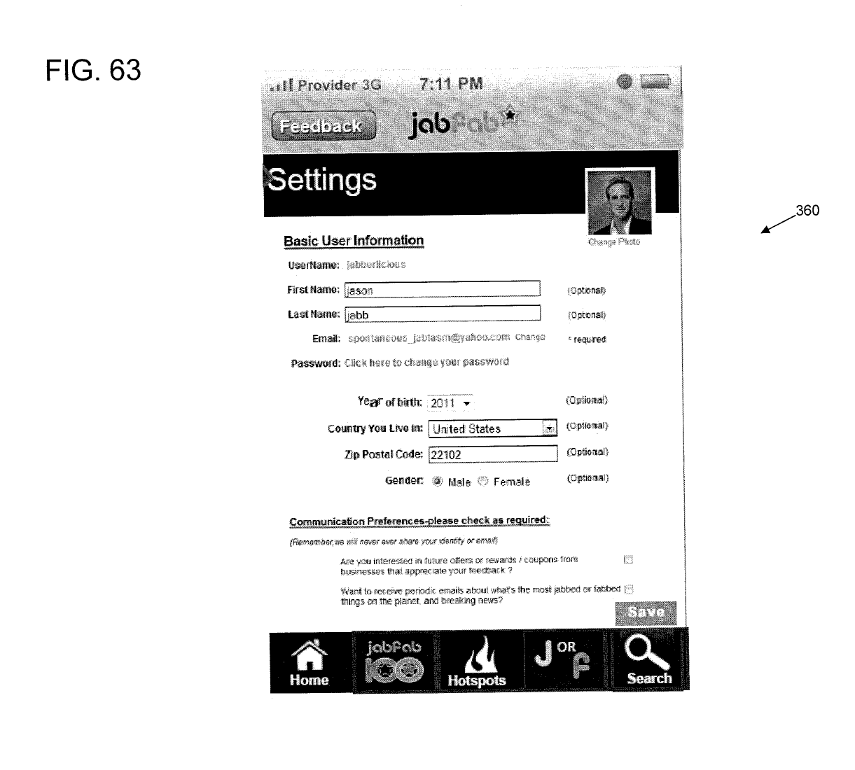

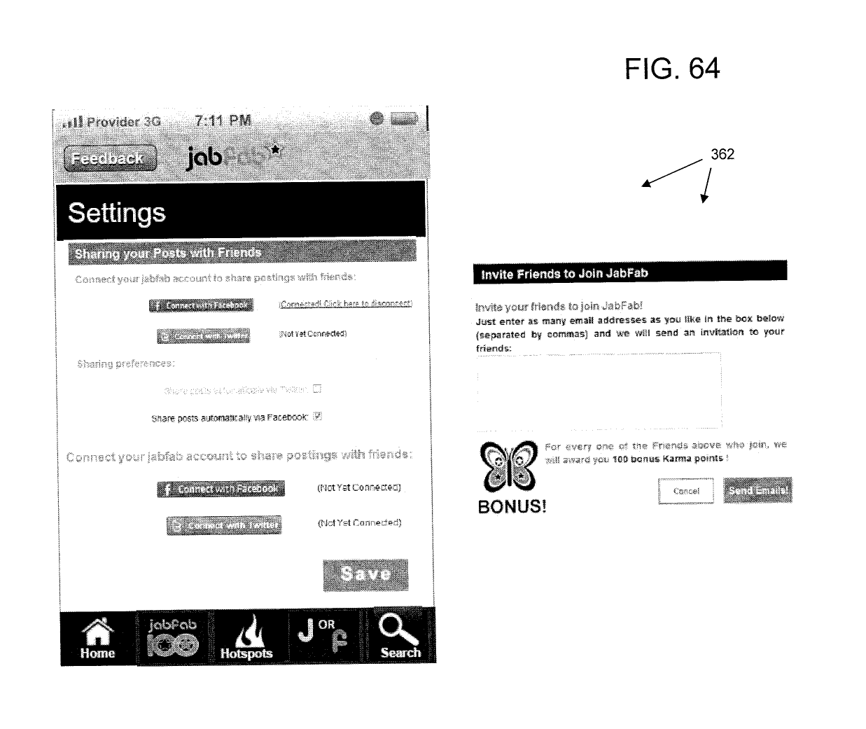

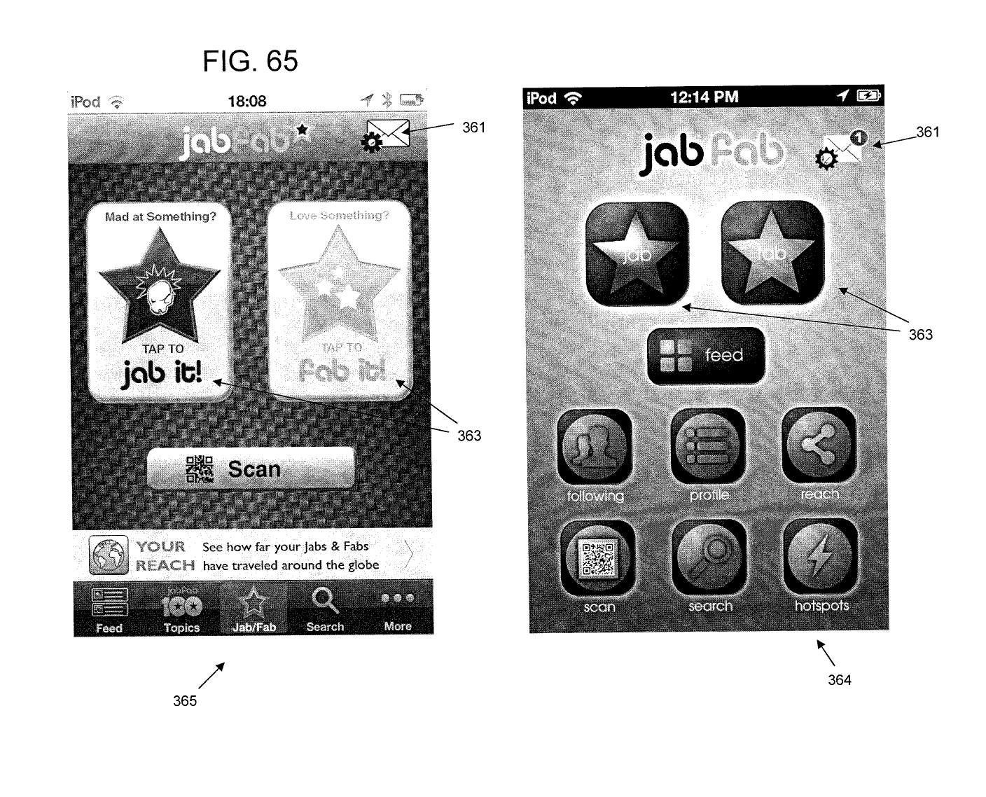

The present invention is accessible through traditional desktop or laptop computer, as well as all types of mobile communication devices (MCDs). Various features in accordance with the present invention can be made accessible from a user's MCD as shown in the MCD user interface depictions (e.g., FIGS. 61-77). A user can sign into his or her user account, or create a new account if the user does not already have one, using exemplary interface 350 in FIG. 61. Once a user has entered his or her account, he/she can view a summary of the user's sentiments to date on the home page screen 355, as seen in FIG. 62. The present invention can also provide a running balance of the user's available loyalty points (e.g., Karma or Kudos points) on the home page. In one embodiment, there is a “Settings” or “Profile” link available on the application home page, which can permit the user to access an interface such as that shown at 360 in FIG. 63. Through such an interface, a user can change his or her basic user information, link his or her account associated with the present invention (“Jabfab™ account”) to Facebook™ or Twitter™ accounts, and/or use his or her MCD to invite additional friends to Jabfab™ thereby earning bonus loyalty points. The interface 362 of FIG. 64 illustrates an interface that can be provided by the present invention in order to permit a user to share posts with friends and invite friends to participate. Versions of the home page of the mobile application, as illustrated in FIG. 65 by interfaces 364 and 365, can also be provided with a messages and notifications function 361, jab and fab icons 363, and other icons representing functions described elsewhere herein.

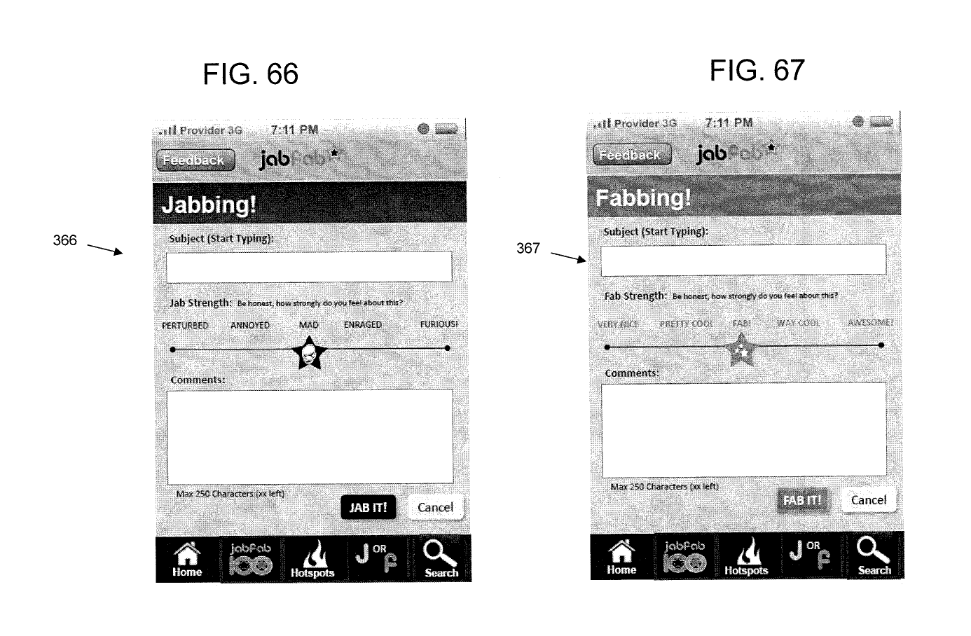

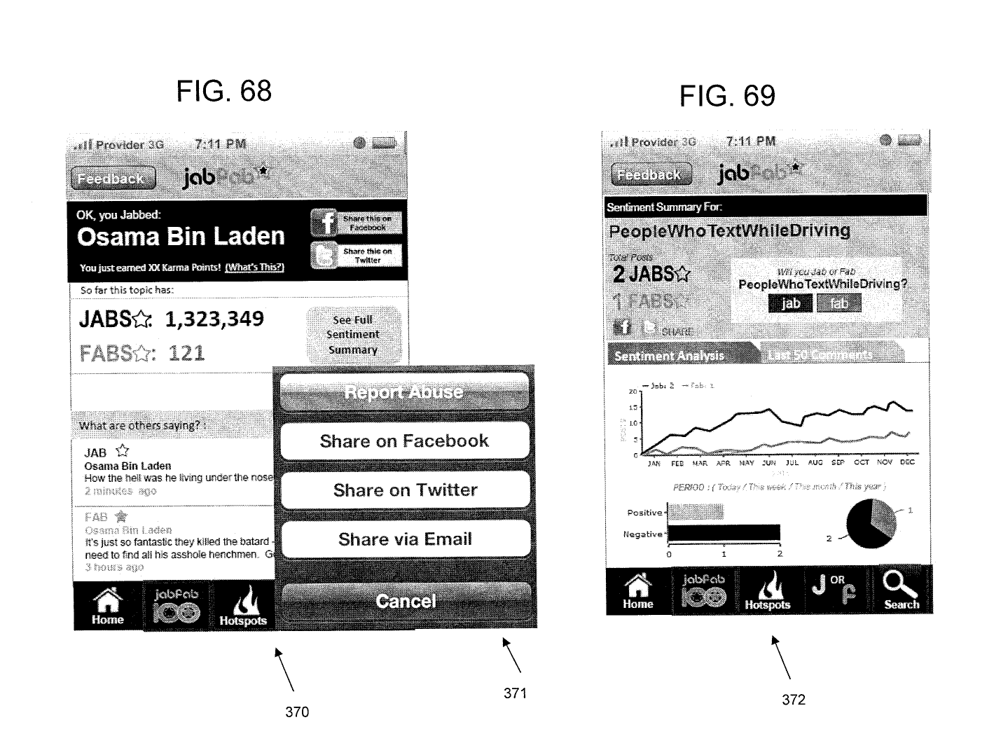

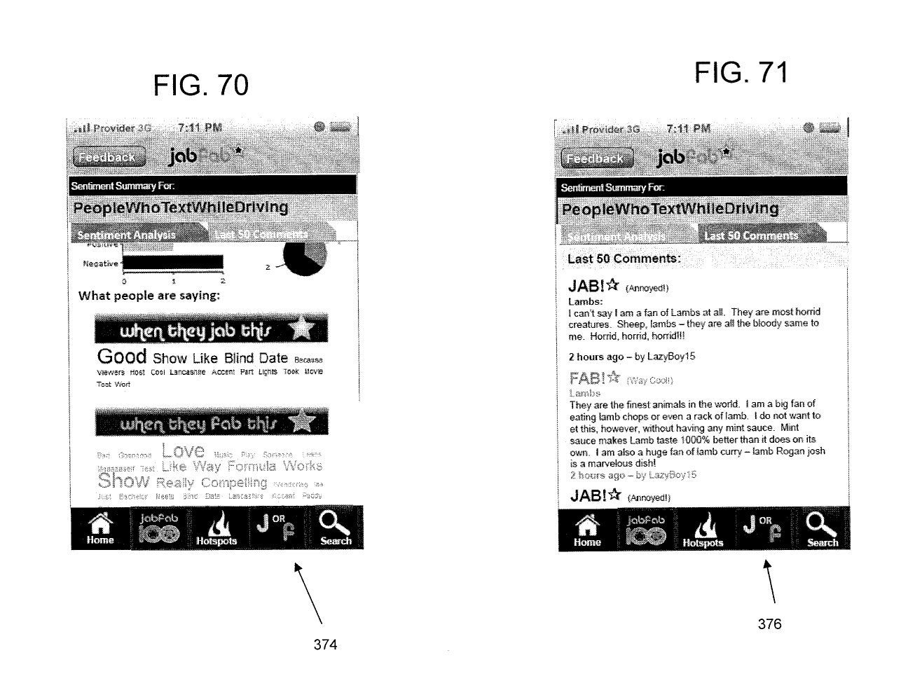

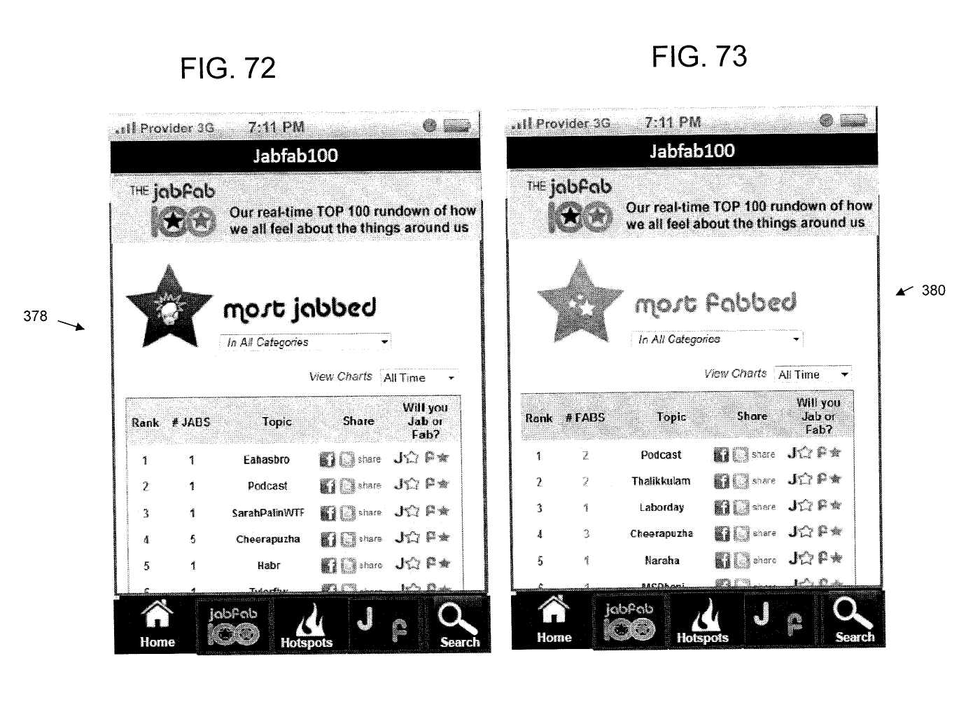

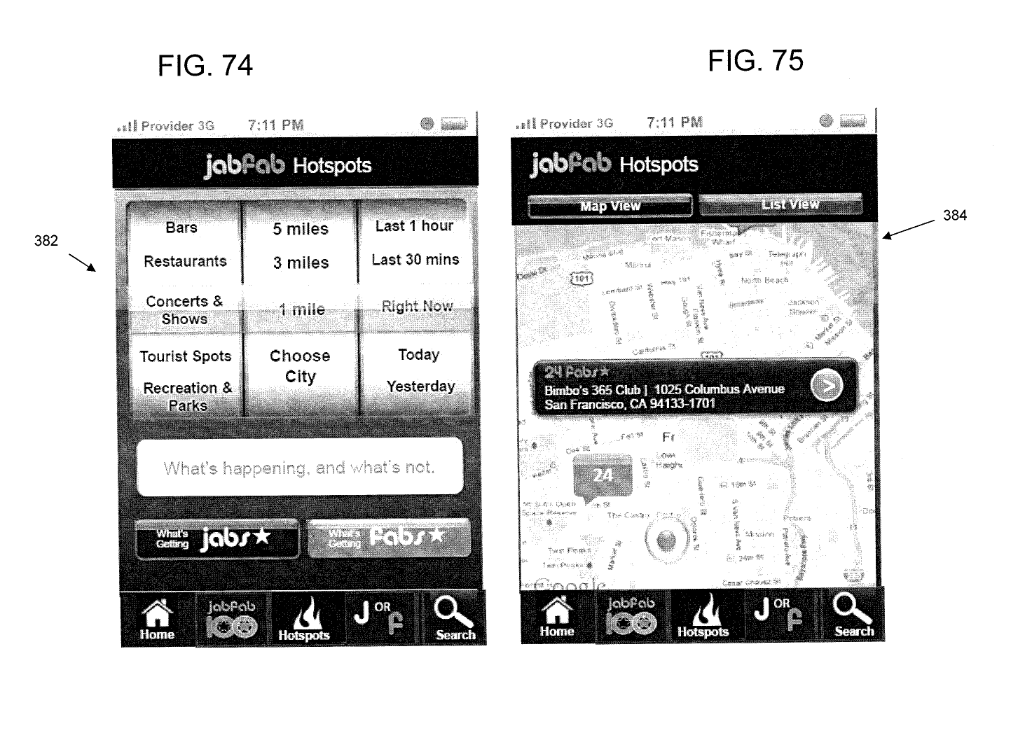

In addition, the user can select topics to follow using the MCD. As seen in FIGS. 66-67, the user can create a new topic to jab (interface 366 of FIG. 66) on the MCD or a new topic to fab (interface 368 of FIG. 67). As shown by interface 370 of FIG. 68, a user can also jab/fab an existing topic from the MCD, and/or provide additional comments for the tag topic. The sliding intensity scale or similar scale for a jab/fab as discussed above is also available on the MCD. Once a user has jabbed/fabbed a topic, the user can view recent posts on the topic and a summary of the total number of jabs/fabs for the tag. Links can be provided to share posts with friends via Facebook™ or Twitter™, for example, as shown by overlaid interface 371 of FIG. 68. A link can also be provided on the MCD page to see the full sentiment analysis data, as shown by interface 372 in FIG. 69. As shown by interface 374 in FIG. 70, once the link is followed to see the full sentiment analysis data, the user can view graphs displaying more detailed sentiment analysis as well as the most common words and/or phrases associated with the tag. It will be appreciated that bar graphs, line graphs, pie graphs, other graphs and non-graphical statistical representations can be provided in accordance with various embodiments of the present invention. As shown by interface 376 in FIG. 71, the present invention can also provide a tab that displays the most recent (e.g., the last fifty) comments associated with the tag. The most jabbed and most fabbed topics can further be displayed on the MCD using the system of the present invention, as illustrated by interfaces 378 and 380, respectively, in FIGS. 72 and 73. In one embodiment of the present invention, a link to this information is provided at the bottom of the MCD screen when the mobile software application associated with the present invention is open and running. There can also be a link at the bottom of the MCD screen to “Hotspots”, for example. In addition, hotspot notifications and searching can be provided, such as by using exemplary interface 382 in FIG. 74, which allows a user to pick a category, geographical range, and time frame of when something was jabbed/fabbed in order to access real-time hotspots according to Jabfab™ data. This can operate with mapping applications such as Google™ maps or OpenStreetMap™, for example, to show the user locations of a hotspot topic. For example, if a user were looking for restaurants in a 1-mile radius that had been fabbed about in the last week, the user could then select one of the returned hotspots and click on it to access a geographic location for the restaurant. Clicking on the returned hotspots takes the user to the tag page for that tag topic and, from this page, the user can access sentiment data analysis as well as the geographic location of the hotspot. The same could be applied for real-time information and decision making. For example, the user may ask “Which bar or nightclub or concert near me is getting the most Fabs tonight?” or “Which TV show is getting the most Jabs right now?” Further, maps displaying geographic information related to the sentiment data can be provided from the MCD, as shown by exemplary interface 384 in FIG. 75.

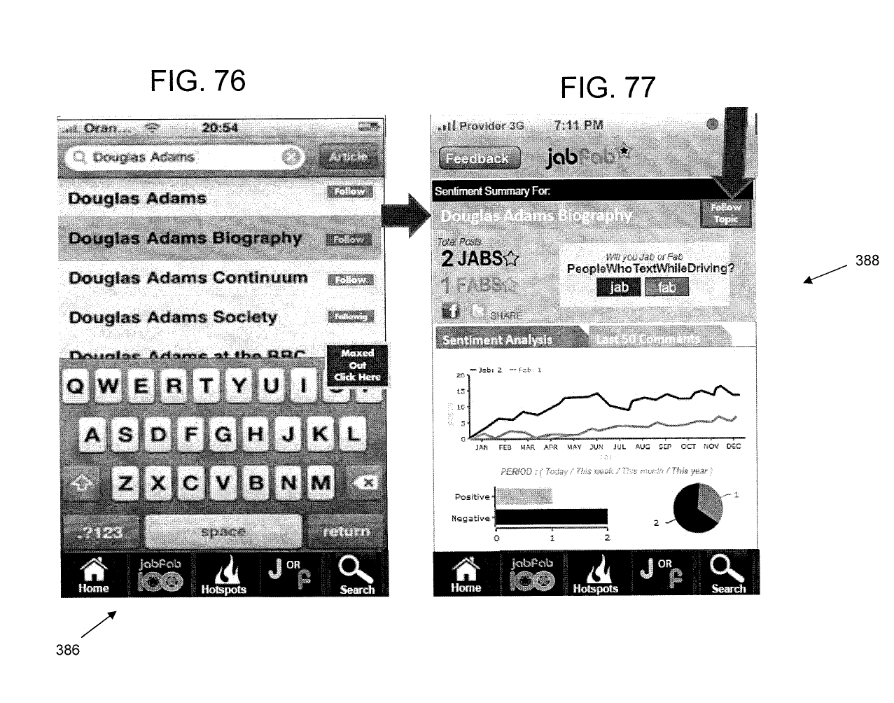

As illustrated in FIG. 76, for example, the system of the present invention can also provide the user with the ability to find, share and follow sentiment topics via a MCD, using an interface such as that shown at 386. Once a user is following a topic, sentiment summary data is available to the user. The user is also able to access more detailed summary data on a followed tag, as illustrated at 388 in FIG. 77.

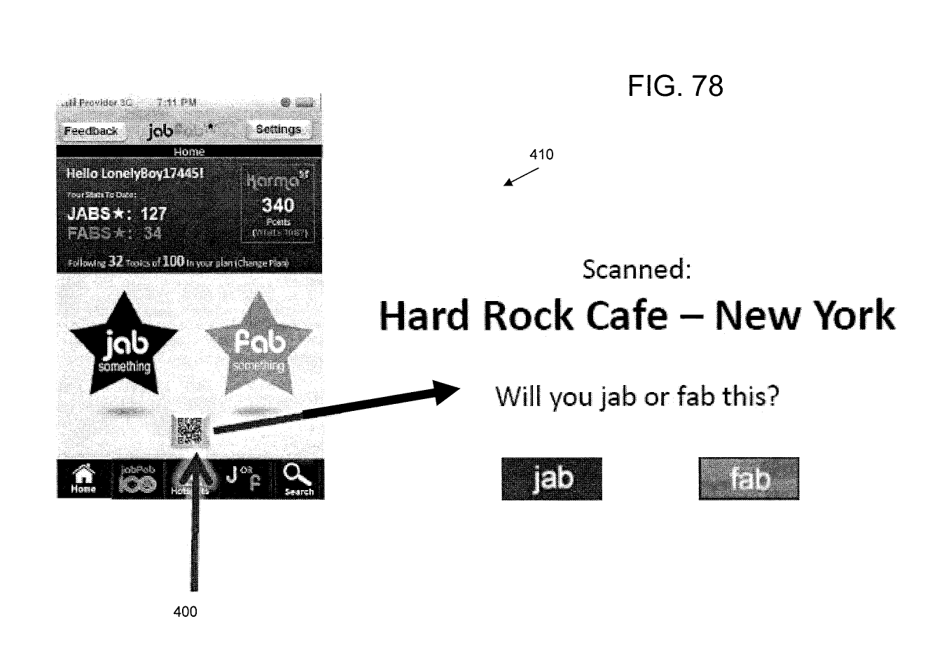

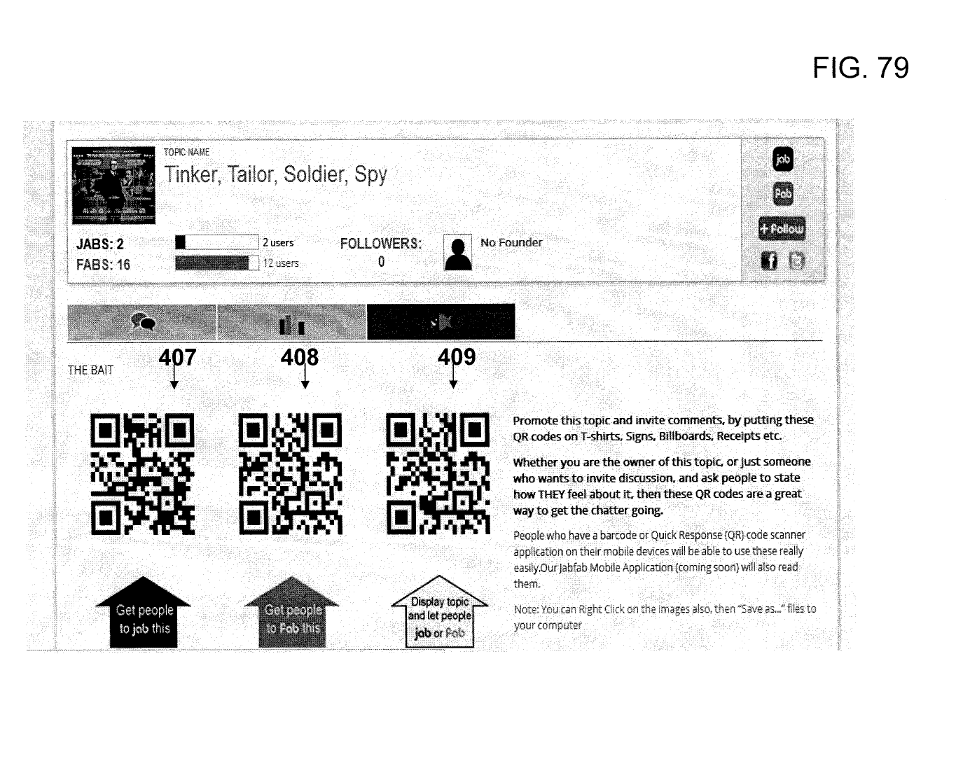

As illustrated in FIG. 78, for example, the system of the present invention can incorporate a physical code scan mechanism for soliciting feedback on social topics. The mechanism enables a user to scan a physical code 400 which can then be transmitted to the registry of sentiment topics. The result of this operation can return a topic of interest to a user, so that they can express their sentiments about it—positive or negative. An example of this system in operation can be implemented on the website associated with the present invention as follows: (i) a business such as a restaurant or hotel can create topics in the topic registry that they would like to solicit social feedback against or an activist organization may create a topic that they would like to bring into the public eye and solicit sentiments around; (ii) when the topic is created, the system automatically assigns it a unique identifier (ID) and locator. In addition, the system can be employed to automatically generate, for example, three Quick Response (QR) codes for the topic. The QR codes can be physically printed out and, when scanned by a mobile device or electronic reader, can automatically take the user to an application (e.g., website, MCD application) associated with the system of the present invention and to the specific topic in question; (iii) when the user scans the QR codes, they drive at least three different behaviors: 1) the present invention can search and retrieve the specified topic and present the user with a choice to only jab the topic (i.e. express negative sentiment toward it, e.g., as indicated at 407 in FIG. 79) 2) the present invention can search and retrieve the specified topic and present the user with a choice to only fab the topic (i.e. express positive sentiment toward it, e.g., as indicated at 408 in FIG. 79) 3) the present invention can search and retrieve the specified topic and present the user with the topic page, all of its information and sentiments data collected thus far, and then give the user a choice to jab or fab the topic (i.e. decide for themselves if they are expressing negative or positive sentiment, e.g., as indicated at 409 in FIG. 79). The resulting system enables businesses, brands, or regular people to bring the sentiment system empowered by the present invention into the physical world and solicit social feedback without the need to initiative the sentiment expression manually or find the topic themselves. It will be appreciated that, while QR codes are described herein, the present invention can employ other forms of information transfer that are known or developed to accomplish the same intended result. It will further be appreciated that a QR code need not necessarily be directly related to the item on which it is secured or placed. For example, a QR code can be placed on a storefront window (e.g., The Gap™) and can permit sentiment expression related to the store on whose storefront it appears, or alternatively can permit sentiment expression related to something that is available for sale within the store (e.g., specific brand name jeans). In the example interface 410 of FIG. 78, the present invention shows a QR code 400 that has been scanned and is providing the user with the option to either jab or fab the Hard Rock Café™ in New York.

Using the system of the present invention, businesses can also promote a topic using, for example, a Microsoft™ tag in high capacity color barcode (HCCB) format and/or variations thereof, such as near-field communication (NFC) tags, RFID tags and other similar technologies whether requiring contact with the MCD or not. The present invention can operate so as to brand the tag in a way that makes it clearer that the barcode relates to the present invention and underlying website. In another embodiment, the business or brand can put their own content around the barcode or on the linked tag page. Furthermore, there can be an additional tab, “Promote This” for example, on the tag page for a tag topic. As soon as a tag is created, its promotional content can be created. For example, the barcode can be downloaded and incorporated in the business customer service and market research media (e.g., on a receipt, on the bar, on the door and reception, on staff or service t-shirts, etc.).

As described above, the present invention permits a listener to access an inbox of real-time jabs and fabs, which can be invaluable to service-oriented businesses like hotels, spas, restaurants, etc. The present invention can further be integrated into customer service operations. For example, if a customer is not satisfied with the service he/she received and the customer jabs the business's service, the business can receive a real-time notification of the jab and consider ways in which to ameliorate the situation. In one embodiment of the present invention, automated or real-time response options (also referred to as a “tracking user activity”) can be presented to a tracking user, such as the recipient of a jab, permitting the tracking user to invoke one of several remedial options. For example, the recipient can be given the option of: (1) sending a gift certificate to the customer; (2) sending a gift, such as chocolates or flowers, to the customer; and/or (3) providing a discount on future products or services. Such communications can be accomplished electronically via e-mail or other communication directed to the user involved based upon contact information established using the system of the present invention. To ensure the safety and security of its users, the system of the present invention can also verify the identity of a business or a person before allowing direct interaction between the users.

As described above, the system can also include a method for sharing expressed sentiments via social networks. Users can share the sentiments they have expressed in the registry of topics and comments associated with the present invention. Users can share outside the system of the present invention by pushing their sentiment topic, comments and relative sentiment strength to applications such as Facebook™ and Twitter™ and emailing to others. This can extend later to all relevant social networks and social interest sites, including, but not limited to, Digg™, StumblUpon™, Delicious™, Pinterest™, Reddit™, Tumblr™, etc. The system of the present invention allows the user to deliver their expressed sentiment and topic to the third party social network via an interface or API, for example. As a result, a posting can be made to the social network in question, and a set of links, photos and text can be posted to the social network so that the friends of the user can see them in the third party social network, then be able to link back to the system of the present invention and weigh in on the topic and comments themselves. For example, Jane may decide to post a topic on a website associated with the system of the present invention called “The Situation in Syria” and may elect to jab this with strength of Furious. She then posts this to Facebook™. On Facebook™, the wall posting can contain any photos she has added and say something like: “Jane just Jabbed the Situation in Syria and is Furious. How do you feel about this? Click here to weigh in and lend your voice to the conversation.”

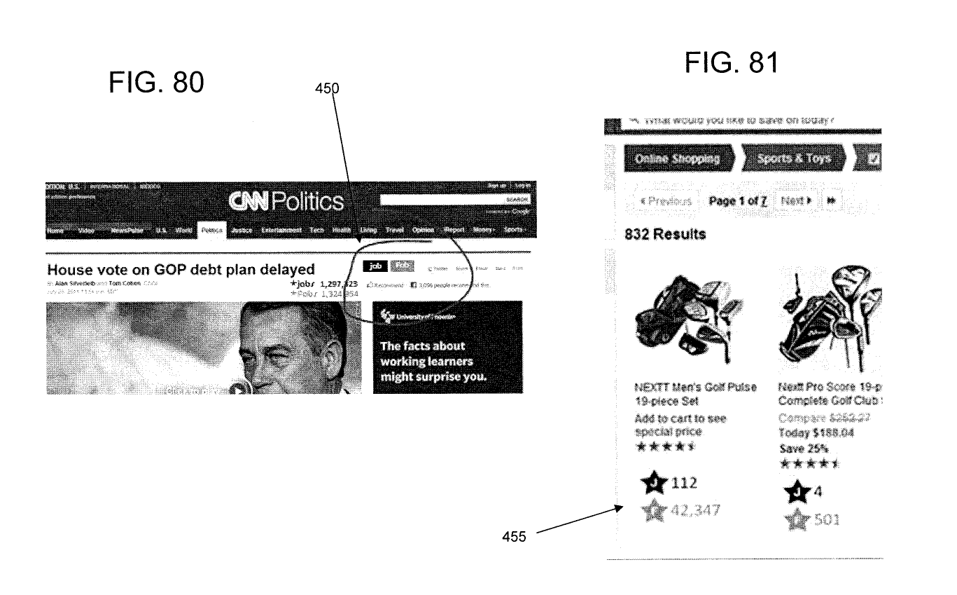

In one embodiment, the system of the present invention can provide, as part of the External Services component, widgets, buttons, and/or toolbars specifically designed for capturing positive and negative sentiments about objects and then displaying results and consensus. In one aspect, these elements can be deemed part of a technology kit (also referred to as a “widget kit”) provided by the system of the present invention so that users can embed jabbing and fabbing into their own websites (or other websites, with permission, for example). Such elements can comprise programming code associated with the present invention and associated graphics that are linked directly to the system of the present invention and the tag topic registry. The technology kit of the present invention can provide for remote jabbing or fabbing of a topic by placing the required code on a third party application or website. Similar uses of this toolkit technology include the “Like” or “Recommend” buttons provided by Facebook™ to third party developers to enable remote interfaces into the Facebook™ social network. The technology kit of the present invention can provide the ability for a consumer to actively apply negative or positive sentiment to an object that appears in a third party application or website. The technology kit can also provide, for example, a display of the current score and/or a summary of the negative and/or positive sentiment that has been applied to this same object either from the same third party application/website, or from the application/website(s) associated with the system of the present invention. For example, user input icons (e.g., buttons) associated with the present invention can be included on a celebrity website, such as American Idol™, and the button can be used to allow users to jab or fab the top 10 contestants. The results can also be displayed on the website to show the user the general sentiment about this object/notion. The results and actions can be transported back to the system of the present invention via the API and stored in the central registry and results. As a further example, a user surfing CNN.com may decide to jab a celebrity or politician from the site, or see how many jabs/fabs that celebrity has from within the media site, as illustrated by interface 450 of FIG. 80 and interface 455 of FIG. 81. This data can be fed from a central server associated with the present invention, for example. As another example, a user visiting Overstock.com considering a new product purchase may find a widget that shows how many jabs/fabs an item has received.

The system of the present invention can further provide a profanity filter for monitoring, advising and replacing text used in sharing sentiments and feedback. This feature provides the ability to sense, via text filtering and a dynamic table of known profane words and terms, that a user has included profanity within his or her topic name or comments. As a result, the system of the present invention can then, at the option of the user, mask the profanity with asterisks or some other measure. This can help manage online reputations for users.

It will be apparent to one skilled in the art that any computer system that includes suitable programming means for operating in accordance with the disclosed methods also falls well within the scope of the present invention. Suitable programming means include any means for directing a computer system to execute the steps of the system and method of the invention, including for example, systems comprised of processing units and arithmetic-logic circuits coupled to computer memory, which systems have the capability of storing in computer memory, which computer memory includes electronic circuits configured to store data and program instructions, with programmed steps of the method of the invention for execution by a processing unit. Aspects of the present invention may be embodied in a computer program product, such as a diskette or other recording medium, for use with any suitable data processing system. The present invention can further run on a variety of platforms, including Microsoft Windows™ Linux™, Sun Solaris™, HP/UX™, IBM AIX™ and Java compliant platforms, for example. Appropriate hardware, software and programming for carrying out computer instructions between the different elements and components of the present invention are provided.

The present disclosure describes numerous embodiments of the present invention, and these embodiments are presented for illustrative purposes only. These embodiments are described in sufficient detail to enable those skilled in the art to practice the invention, and it will be appreciated that other embodiments may be employed and that structural, logical, software, electrical and other changes may be made without departing from the scope or spirit of the present invention. Accordingly, those skilled in the art will recognize that the present invention may be practiced with various modifications and alterations. Although particular features of the present invention can be described with reference to one or more particular embodiments or figures that form a part of the present disclosure, and in which are shown, by way of illustration, specific embodiments of the invention, it will be appreciated that such features are not limited to usage in the one or more particular embodiments or figures with reference to which they are described. The present disclosure is thus neither a literal description of all embodiments of the invention nor a listing of features of the invention that must be present in all embodiments.

1. A method for crowdsourcing, comprising:
causing at least one processor to execute a plurality of instructions stored in at least one memory device to receive sentiment content from at least two contributing users in connection with one or more topics;
causing the at least one processor to execute a plurality of instructions stored in the at least one memory device to calculate social influence ratings for the at least two contributing users;
causing the at least one processor to execute a plurality of instructions stored in the at least one memory device to receive a request from a requester for a crowdsourcing task; and
causing the at least one processor to execute a plurality of instructions stored in the at least one memory device to, based upon the social influence ratings, assign the crowdsourcing task to at least one of the at least two contributing users.

2. The method of claim 1, wherein the crowdsourcing task is a competition.

3. The method of claim 1, wherein the crowdsourcing task is a survey.

4. The method of claim 1, wherein the step of calculating social influence ratings includes calculating social influence ratings pertaining to a specific topic or group of topics.

5. The method of claim 4, wherein the step of receiving a request includes receiving a request for a crowdsourcing task that is limited to a specific topic or group of topics.

6. The method of claim 1, wherein the step of calculating social influence ratings includes calculating social influence ratings pertaining to a specific geographic location.

7. The method of claim 1, wherein the step of calculating social influence ratings includes calculating social influence ratings pertaining to a specific time or date.

8. The method of claim 1 including the further step of re-calculating the social influence ratings on a periodic basis.

9. The method of claim 1 wherein the received sentiment content is structured according to a specific human emotion, gesture or feeling and a level of intensity of the specific human emotion, gesture or feeling.

10. The method of claim 1 wherein the received content is structured based upon presenting the at least one contributing user with at least two pre-defined options of specific human emotions, gestures or feelings.

11. The method of claim 1 wherein the step of receiving a request includes receiving a designation of at least one contributing user to be included in the assignment of the crowdsourcing task, and including the further step of assigning the crowdsourcing task to the designated at least one contributing user.

12. The method of claim 1 wherein the step of receiving a request includes receiving a designation of at least one contributing user not to be included in the assignment of the crowdsourcing task, and wherein the step of assigning the crowdsourcing task includes restricting the assignment of the crowdsourcing task from the designated at least one contributing user in the event that the crowdsourcing task would have been assigned to the designated at least one contributing user based upon the social influence ratings.

13. A system for crowdsourcing, comprising:
at least one data storage device operable to store computer-readable instructions;
at least one computer processor operable to execute the computer-readable instructions; and
a set of computer-readable instructions operable to:
receive sentiment content from at least two contributing users in connection with one or more topics;
calculate social influence ratings for the at least two contributing users;
receive a request from a requester for a crowdsourcing task; and
based upon the social influence ratings, assign the crowdsourcing task to at least one of the at least two contributing users.

14. A method for crowdsourcing a contest, comprising:
causing at least one processor to execute a plurality of instructions stored in at least one memory device to initiate a contest requiring sentiment content in order to evaluate the winner; and
causing the at least one processor to execute a plurality of instructions stored in the at least one memory device to receive sentiment content from at least one contributing user pertaining to the contest, wherein the received content is structured according to a specific human emotion, gesture or feeling and a level of intensity of the specific human emotion, gesture or feeling.

15. The method of claim 14 including causing the at least one processor to execute a plurality of instructions stored in the at least one memory device to further display received sentiment content pertaining to the contest and calculate a winner.
